(19) United States
(12) Patent Application Publication
(10) Pub. No.: US 2006/0184488 A1
(43) Pub. Date: Aug. 17, 2006

(54) Method and system for trace aligned and trace non-aligned pattern statistical calculation in seismic analysis

(75) Inventor: Robert Wentland, Boulder, CO (US)

Correspondence Address: BAKER BOTTS, LLP, 910 LOUISIANA, HOUSTON, TX, 77002-4995, US

(73) Assignee: Chroma Energy, Inc.

(21) Appl. No.: 11/373,409

(22) Filed: Mar. 10, 2006

Related U.S. Application Data
(63) Continuation-in-part of application No. 10/308,933, filed on Dec. 3, 2002.
(63) Continuation-in-part of application No. 10/308,928, filed on Dec. 3, 2002.
(60) Provisional application No. 60/395,960, filed on Jul. 12, 2002.
(60) Provisional application No. 60/395,959, filed on Jul. 12, 2002.
(60) Provisional application No. 60/395,960, filed on Jul. 12, 2002.
(60) Provisional application No. 60/395,959, filed on Jul. 12, 2002.

(51) Int. Cl. G06K 9/62; G06N 5/00

(52) U.S. Cl. 706/45

(57) ABSTRACT

An apparatus and method for analyzing known data, storing the known data in a pattern database (“PDB”) as a template is provided. Additional methods are provided for comparing new data against the templates in the PDB. The data is stored in such a way as to facilitate the visual recognition of desired patterns or indicia indicating the presence of a desired or undesired feature within the new data. Data may be analyzed as fragments, and the characteristics of various fragments, such as string length, may be calculated and compared to other indicia to indicate the presence or absence of a particular substance, such as a hydrocarbon. The length and/or character of each fragment are a product of the cutting criteria in both horizontal and vertical orientations. Modifying the cutting criteria can have a beneficial effect on the results of the analysis and/or in the amount of time necessary to achieve useful results. The apparatus and method is applicable to a variety of applications where large amounts of information are generated, and/or if the data exhibits fractal or chaotic attributes.

### RELATED APPLICATIONS

This application is a continuation-in-part of U.S. patent application Ser. No. 10/308,933, entitled “PATTERN RECOGNITION APPLIED TO OIL EXPLORATION AND PRODUCTION” which was filed by inventors Robert Wentland, Peter Whitehead, Fredric S. Young, Jawad Mokhtar, Bradley C. Wallet and Dennis Johnson on Dec. 3, 2002, and which is a conversion of U.S. Provisional Application Nos. 60/395,960 and 60/395,959 both of which were filed on Jul. 12, 2002 and all are hereby incorporated by reference herein for all purposes. This application is also a continuation-in-part of U.S. patent application Ser. No. 10/308,928, entitled “METHOD, SYSTEM AND APPARATUS FOR COLOR REPRESENTATION OF SEISMIC DATA AND ASSOCIATED MEASUREMENTS” which was filed by inventors Robert Wentland and Jawad Mokhtar on Dec. 3, 2002, and which is a conversion of U.S. Provisional Application Nos. 60/395,960 and 60/395,959 both of which were filed on Jul. 12, 2002, and all are hereby incorporated by reference herein for all purposes. This application is also related to U.S. patent application Ser. Nos. 11/147,643 entitled “METHOD AND SYSTEM FOR UTILIZING STRING-LENGTH RATIO IN SEISMIC ANALYSIS” by Ricky Lynn Workman, which was filed on Jun. 8, 2005 which is assigned to the same entity as the present application and is also incorporated herein by reference.

### FIELD OF THE INVENTION

The present invention relates generally to oil exploration and production. More particularly, the present invention relates to using pattern recognition in combination with geological, geophysical and engineering data processing, analysis and interpretation for hydrocarbon exploration, development, or reservoir management on digital computers.

### BACKGROUND OF THE INVENTION TECHNOLOGY

Many disciplines can benefit from pattern recognition. Disciplines where the benefit is greatest share characteristics and needs. Some common characteristics include large volumes of data, anomalous zones of interest that are mixed together with a large number of similar non-anomalous zones, timeframes too short to allow rigorous manual examination, and anomalies that manifest themselves in many ways, no two of which are exactly the same. Highly trained professionals working on tight time schedules usually do analysis of the data. Examples of these disciplines include, but are not limited to, hydrocarbon exploration and medical testing.

Exploring for hydrocarbon reservoirs is a very competitive process. Decisions affecting large amounts of capital investment are made in a time-constrained environment based on massive amounts of technical data. The process begins with physical measurements that indicate the configuration and selected properties of subsurface strata in an area of interest. A variety of mathematical manipulations of the data are performed by computer to form displays that are used by an interpreter, who interprets the data in view of facts and theories about the subsurface. The interpretations may lead to decisions for bidding on leases or drilling of wells.

A commonly used measurement for studying the subsurface of the earth under large geographical areas is seismic signals (acoustic waves) that are introduced into the subsurface and reflected back to measurement stations on or near the surface of the earth. Processing of seismic data has progressed hand-in-hand with the increased availability and capabilities of computer hardware. Calculations performed per mile of seismic data collected have increased many-fold in the past few years. Display hardware for observation by a human interpreter has become much more versatile.

When an interpreter makes decisions from the seismic and other data, it is used with some knowledge of geology of the area being investigated. The decisions involve identification, analysis, and evaluation of the geological components of an oilfield, which include the presence of a reservoir rock, presence of hydrocarbons, and the presence of a container or trap. The rationale for the decisions that were made was based on both the geologic information and the data. That rationale is not generally documented in detail for seismic data analysis due to the large amount of data and information being analyzed. Therefore, it is difficult to review the history of exploration decisions and repeat the decision process using conventional procedures. The relative importance attached to the many characteristics shown in the seismic data and known from the geology is a subjective value that does not become a part of the record of the exploration process.

It is recognized that seismic data can also be used to obtain detailed information regarding producing oil or gas reservoirs and to monitor changes in the reservoir caused by fluid movement. Description of neural network modeling for seismic pattern recognition or seismic facies analysis in an oil reservoir is described, for example, in “Seismic-Pattern Recognition Applied to an Ultra Deep-Water Oilfield,” Journal of Petroleum Technology August, 2001, page 41. Time-lapse seismic measurements for monitoring fluid movement in a reservoir are well known. The fluid displacement may be caused by natural influx of reservoir fluid, such as displacement of oil by water or gas, or may be caused by injection of water, steam, or other fluids. Pressure depletion of a reservoir may also cause changes in seismic wave propagation that can be detected. From these data, decisions on where to drill wells, production rates of different wells and other operational decisions may be made. The neural network technique usually assumes that all significant combinations of rock type are known before analysis is started so that they can be used as a training set. This assumption is usually acceptable when analyzing fully developed fields but breaks down when only a few or no wells have been drilled. Common implementations of the neural network technique usually assume selection of the location of the geology of interest is an input that is determined prior to the analysis and often selects it using an analysis gate of fixed thickness. As the geology of interest is not always well known, the geology of interest should be a product of the analysis, not an input. Moreover, geology of interest rarely has a fixed thickness. The thickness varies significantly as the depositional process varies from place to place, sometimes by an amount that is sufficient to significantly degrade the result of the neural network analysis. This form of analysis includes information extraction and information classification in a single step that has little or no user control.

What is needed is a way to perform unsupervised pattern analysis that does not require a learning set, does not require texture matching, does not classify attributes of a single spatial size, and does not require a-priori knowledge of the location of the geology of interest. Unsupervised pattern analysis requires feature, pattern, and texture extraction from seismic data where the features, patterns, and texture measurements are well chosen for optimal classification and can be interpreted in terms of oilfield components. Optimal means that they:
Do not require a learning set;
Is capable of finding matches to an example data set, if any;
Have variable spatial lengths of extracted attributes so that they track geology;
Have the minimum number of attributes to maximize computation simplicity;
Have an adequate number of attributes to separate out the rock types as uniquely as the seismic data allows;
Are interpretable and intuitive to geoscientists in that they measure the visual characteristics of the data that the geoscientists use when they visually classify the data;
Determine the locations of the different rock types as a product of the analysis;
Perform analysis of several spatial sizes of attributes; and
Perform classification based on several types of attributes including features, patterns, and textures in a structure recognizing the different levels of abstraction.

There is further a need in the art to have a process of creating features, patterns and textures, from data plus a data hierarchy recognizing the relative levels of abstraction along with a pattern database containing all of the information.

From a production standpoint, there is a need in the art to visually classify this information to analyze the interior of a hydrocarbon reservoir more effectively. Direct hydrocarbon indicators should be visually identifiable. Seismic stratigraphy should be performed in a way that includes visual classification of all the seismic stratigraphic information available in the data. In addition the knowledge inherent in the visual classification needs to be captured in a template, stored in a template library, and reused later in an automatic process.

While 3D seismic produces images of structures and features of the subsurface of the earth over very large geographical areas, it does not interpret those images. A trained geoscientist or specialist performs the interpretation. Unfortunately, reliance upon a relatively few qualified individuals increases the cost of the interpretation process and limits the number of interpretations that can be made within a given period. This makes current seismic interpretation techniques impractical for the analysis of the very large volumes of seismic data that are currently available. As a result of the large and growing amount of available data, there is a need in the art for a knowledge capture technique where the information in the 3D seismic data that the specialist looks at is captured by a pattern recognition process. Ideally, the pattern recognition process would be repeated for large amounts of data in a screening process, with the results displayed in an intuitive manner so that the specialist can quickly perform quality control on the results, and correct noise induced errors, if any.

There is further a need in the art for a way to auto-track textures, patterns, and features in order to isolate and measure rock bodies or objects of interest. Preferably, an object should be auto-tracked so that its location is determined both by the properties of its interface with surrounding objects and by the difference between the features, patterns, and textures in the objects interior when compared to those outside the object. This tracks the object directly rather than tracking the object solely based on the varying properties of the interface which, by itself, is unlikely to be as descriptive of the object. Interface tracking tracks the object indirectly, as would be accomplished with boundary representations. An example of automatically detecting objects based on their interior and interface characteristics would be in colorectal cancer screening where the target anomaly (a colorectal polyp) has both distinctive interface and interior characteristics.

Moreover, a data analysis specialist should not be required to rely on analysis of non-visual measures of object characteristics. The information describing the visual characteristics of seismic data should be stored in a way that allows the data specialist to interact with the information to infer and extract geological information and to make a record of the exploration process. Finally, a way should be provided to analyze geologic information with varying levels of abstraction.

The above-identified needs are shared across many disciplines yet the specific nature and the characteristics of the anomalies vary across disciplines and sometimes within a single problem. Thus, there is a need for a common method of analysis that is capable of being applied to a wide variety of data types and problems, yet capable of being adapted to the specific data and problem being solved in situations where required.

### SUMMARY OF THE INVENTION

The present invention solves many of the shortcomings of the prior art by providing an apparatus, system, and method for synthesizing known (raw) data into hyperdimensional templates, storing the templates of the known data in a pattern database (“PDB”). The subject data to be analyzed (the target data) is similarly synthesized, and the two sets of templates can be compared to detect desirable characteristics in the subject body. The comparison process is enhanced by the use of specially adapted visualization applications that enable the operator to select particular templates and sets of templates for comparison between known templates and target data. The visualization technique facilitates the visual recognition of desired patterns or indicia indicating the presence of a desired or undesired feature within the target data. The present invention is applicable to a variety of applications where large amounts of information are generated. These applications include many forms of geophysical and geological data analysis including but not limited to 3D seismic.

The processing technique of the present invention generates a result through a series of reduction steps employing a cutting phase, an attribute phase, and a statistics phase. These three phases can be conducted at least once or numerous times over a series of layers as the data is further reduced. Normally, there is an input data layer upon which a cut, an attribute and a statistics process are imposed to form a feature layer. From a feature layer, the same cut/attribute/statistics process is implemented to form other layers such as a pattern layer and a texture layer. These series of steps, each of which employ the cut/attribute/statistics processes form a hyper-dimensional template akin to a genetic sequence for the particular properties of the localized region within the input data. The input data for each cut/attribute/statistics phase may be taken from another layer (above and/or below) or it may be taken directly from the raw data, depending upon the problem being solved.

The analysis can be affected significantly by the character and manner of cutting fragments. Specifically, the cutting can be done in both a vertical as well as a horizontal manner. Moreover, the cutting can first be vertical and then horizontal, or horizontal first followed by vertical cutting. The cutting criteria, and the order and orientation of the cutting, can be varied and optimized for a given geologic condition.

### BRIEF DESCRIPTION OF THE DRAWINGS

Referring now to the drawings, the details of the preferred embodiments of the present disclosure are schematically illustrated.

FIG. 1a is a diagram of the pattern pyramid and associated levels of abstraction according to the teachings of the present disclosure.

FIG. 1b is a diagram of an example of a pattern pyramid for data with three spatial dimensions according to the teachings of the present disclosure.

FIG. 1c is a diagram of the pattern pyramid, an example of the components within each level, plus an example of a hyperdimensional fragment according to the teachings of the present disclosure.

FIG. 1d is a diagram of an example of feature level fragment cuts for a band-limited acoustical impedance trace according to the teachings of the present disclosure.

FIG. 1e is a diagram of an example of pattern level fragment cuts for a band-limited acoustical impedance trace according to the teachings of the present disclosure.

FIG. 2 is a block diagram of the apparatus of the present disclosure.

FIG. 3a is a flowchart illustrating an embodiment of a method of 3D seismic first pass lead identification.

FIG. 3b is a flowchart illustrating an embodiment of a method of building a pattern database for geophysical and geological data.

FIG. 4a is a flowchart illustrating an embodiment of a method of building a pattern database for 3D band-limited acoustical impedance.

FIG. 4b is a flowchart illustrating an embodiment of a method of preparing seismic for pattern analysis.

FIGS. 5a and 5b is a flowchart illustrating an embodiment of a method of constructing a pattern database for 3D band-limited acoustical impedance.

FIGS. 6a, 6b, 6c and 6d are flowcharts illustrating an embodiment of a method of fragment cutting and feature attribute and statistic computation.

FIGS. 7a, 7b and 7c are flowcharts illustrating an embodiment of a method of pattern attribute and statistic calculation.

FIG. 8 is a flowchart illustrating an embodiment of a method of data mining using a template.

FIG. 9 is a flowchart illustrating an embodiment of a method of quality control analysis of feature attributes.

FIG. 10 is a flowchart illustrating an embodiment of a method of quality control analysis of pattern attributes.

FIG. 11 is a flowchart illustrating an embodiment of a method of adding cutting, attribute, or statistic algorithms to the pattern database building application.

FIG. 12a is a plot of band-limited acoustical impedance as a function of time or distance.

FIG. 12b is a representative plot of broadband acoustical impedance as a function of time or distance, according to the present disclosure.

FIG. 12c is a mathematical expression for computing the RMS amplitude feature for a fragment, according to the present disclosure.

FIG. 12d is a mathematical expression for computing the shape feature for a fragment, according to the present disclosure.

FIG. 13a is a mathematical expression for computing the Horizontal Complexity feature statistic, according to the present disclosure.

FIG. 13b is the definition of a coordinate neighborhood for horizontal complexity and feature and feature function anisotropy feature statistics, according to the present disclosure.

FIG. 14a defines the values, M and φ, of feature and feature function anisotropy, according to the present disclosure.

FIG. 14b is an example of feature and feature function anisotropy, according to the present disclosure.

FIG. 14c is an example of no feature and feature function anisotropy, according to the present disclosure.

FIG. 14d is a mathematical expression for computing M and φ for feature and feature function anisotropy, according to the present disclosure.

FIG. 15a is a diagram of pattern space, according to the present disclosure.

FIG. 15b is a diagram showing example fragment lengths of 2 and 3, according to the present disclosure.

FIG. 15c is a diagram showing pattern space for a pattern computed using a fragment length of 3, according to the present disclosure.

FIG. 15d is a diagram showing a multi-feature pattern space, according to the present disclosure.

FIG. 16a is a diagram of a two-dimensional pattern space with pattern locations computed as M and α, according to the present disclosure.

FIG. 16b is mathematical expression for computing M and α, according to the present disclosure.

FIG. 16c is a diagram of a three-dimensional pattern space with pattern locations computed as M, α, β, according to the present disclosure, according to the present disclosure.

FIG. 16d is a mathematical expression for computing M, α, β, according to the present disclosure.

FIGS. 17a and 17b are diagrams illustrating two waveforms according to the present disclosure.

FIG. 18 is a diagram illustrating a single waveform that has been subdivided according to the present disclosure.

FIG. 19 is a block diagram illustrating the flattening of input data according to the present disclosure.

FIG. 20 is a block diagram illustrating horizontal cutting according to the present disclosure.

FIG. 21 is a flowchart illustrating a method according to the present disclosure.

The present invention may be susceptible to various modifications and alternative forms. Specific embodiments of the present invention are shown by way of example in the drawings and are described herein in detail. It should be understood, however, that the description set forth herein of specific embodiments is not intended to limit the present invention to the particular forms disclosed. Rather, all modifications, alternatives, and equivalents falling within the spirit and scope of the invention as defined by the appended claims are intended to be covered.

### DETAILED DESCRIPTION OF THE PREFERRED EMBODIMENTS

The present disclosure includes a system for and method of extracting, organizing, and classifying features, patterns, and textures from a data set. The data and the information extracted therefrom, is organized as a pattern hierarchy and stored in a pattern database. The present disclosure also provides a system for the segmentation and the analysis of geological objects, for example, by identifying, extracting, and dissecting the best estimate of hydrocarbon filled reservoir rocks from band-limited acoustical impedance (“RAI”) data computed from 3D seismic data or, if available, broadband acoustical impedance (“AI”) computed from 3D seismic data, stacking velocities, well logs, and user supplied subsurface structural models. In addition, the present disclosure includes a system for capturing the knowledge of the geoscientists operating the present disclosure in templates and reusing the templates for automated mining of large volumes of data for additional geological objects.

Pattern Recognition of Geoscience and Geological Data

The first step of the pattern recognition method of the present disclosure is feature extraction. Feature extraction comes in many forms, and tends to be specific to the type of problem encountered. For example, in seismic data analysis, geological features are extracted. Most traditional methods of feature extraction for seismic data involve mathematical algorithms that focus on the measurements of the sound rather than on the visual appearance of the displayed data. Most geophysicists, however, think of geology in a visual way, which makes analysis and interpretation of traditionally extracted seismic signal features difficult. Many other examples and uses for the feature extraction and imaging technique of the present disclosure will be apparent upon examination of this specification.

In general, a mathematical representation of features describes the local state of a system. The features are then represented as a vector in an abstract vector space or tangent space called the feature state space. The axes of the state space are the degrees of freedom of the system, in this case the features of the image. To minimize the amount of information required to represent the state of the image it is preferred that the features, axes of the state space, be linearly independent. The features have the capacity to “span the signal,” or to describe all seismic attributes such that, for example, a geophysicist could accurately re-create the underlying geology.

Using seismic data as an example, geological features are extracted for performing pattern recognition on a seismic data set. Feature descriptors of seismic data tend to be one-dimensional, measuring only one aspect of the image, such as measuring only properties of the signal at specific locations in the signal. These feature descriptors taken singly do not yield enough information to adequately track geology. The relationship these measurements have with their local neighbors contains information about depositional sequences that is also very important geological information. Thus, the relationship features have with their neighbors and the total data set also needed to be analyzed.

The present disclosure utilizes a hierarchical data structure called a pattern pyramid that is stored in a pattern database (“PDB”). The pattern database employs a process that is based on DNA-like pseudo sequencing to process data and places the information into a pattern database. This database contains the data plus features and their relationship with the data and, in addition, information on how the features relate with their neighbors and the entire data set in the form of pattern, textures, and related statistics.

Intuitively the basic concept of the pattern pyramid is that complex systems can be created from simple small building blocks that are combined with a simple set of rules. The building blocks and rules exhibit polymorphism in that their specific nature varies depending on their location or situation, in this case the data being analyzed and the objective of the analysis. The basic building block used by the present disclosure is a fragment sequence built from a one-dimensional string of data samples. A pattern pyramid is built using fragment sequences (simple building blocks) and an abstraction process (simple rules). The specific definition of the building blocks, cutting criteria, exhibits polymorphism in that the algorithm varies depending on the data being analyzed and the goal of the analysis. Similarly, the abstraction process exhibits polymorphism in that the algorithm depends on the data being analyzed and the goal of the analysis.

A pattern database is built for known data, which functions as a reference center for estimating the locations in the target data that are potential hydrocarbon deposits. The estimation is accomplished by building a pattern database for the target data using the same computations as for the known data and comparing the pattern databases. The pattern pyramids have several levels of abstraction that may include features, patterns, and textures. The pattern pyramids are built using an abstraction process. The step of comparing the pattern databases is performed by defining a hyperdimensional fragment that associates the appropriate pattern information in the pattern database to the specific data samples from which they were computed. Classification of the target data into portions that match the known data and portions that do not match is accomplished by searching through the hyperdimensional fragments of the target data and comparing them to the hyperdimensional fragments for the known data (the classifier) to identify matches. Intuitively, this means that for the target data to match the known data at any location, not only do the data values need to agree but the data values must also be a part of local features, patterns, and textures that also agree adequately. Thus, the present disclosure not only performs pattern recognition, but also is capable of performing feature recognition, texture recognition, and data comparison all at the same time as required for solving the problem.

To allow for natural variation or noise in the data, exact matches do not have to be required. This is accomplished by defining a binding strength or an affinity that allows hyperdimensional fragments that are reasonably similar but not exactly the same to be classified as matched. The hyperdimensional fragment selected by the geoscientist operating the present disclosure captures the operators' knowledge of what is a desirable outcome, or in other words what a hydrocarbon filled reservoir looks like.

The hyperdimensional fragments and associated abstraction process parameters can be saved as a template into a template database. One or more templates can be checked out from the library and applied to large volumes of target data to identify targets. Targets that have been segmented out of the data set are stored as objects in a collection of objects called a scene. The objects, along with additional data the geoscientist adds to them, become a list of drilling opportunities.

Oil Exploration & Production Uses

This invention is capable of being used for geological, geophysical and engineering data processing, analysis and interpretation for hydrocarbon exploration, development, or reservoir management. It supports application for a variety of types of geophysical data. The present disclosure is flexible and extensible allowing adaptation to provide solutions to many geoscientific problems.

For example, the present disclosure is capable of being used to analyze 3D seismic target data set with the goal of identifying the drilling target locations that represent potential hydrocarbon bearing reservoir rock. An ideal path to reaching this goal is to directly locate and analyze the hydrocarbons in reservoirs. Experience has shown that geology is diverse and complex and geophysical tools (other than drilling) do not directly measure the existence of hydrocarbons. Thus, oil finders build a set of corroborating evidence to decrease risk and increase the probability of drilling success, where success is defined as locating profitable hydrocarbon accumulations. Accomplishing this involves using several forms of geological and geophysical analysis, the goal of which is to identify sufficient evidence of the three basic components of an oil field, which are a reservoir, a charge, and a trap. Identifying a reservoir involves collecting evidence of the existence of a rock having the property that it is capable of holding sufficient hydrocarbons (adequate porosity) and the property that allows the hydrocarbons to be removed from the earth (adequate permeability). Identifying a charge involves collecting evidence that a hydrocarbon is present in the reservoir rock (bright spots, fluid contacts, and others). Another way is to identify a source rock that is or was expelling hydrocarbons and a hydrocarbon migration path to the trap. Identifying a trap involves collecting evidence that the earth structure and/or stratigraphy forms a container in which hydrocarbons collect forming structural traps, stratigraphic traps, or a combination of the two. When the identification of a reservoir, charge, and trap are complete, the result is called a lead. After a full analysis of the reservoir, charge, and trap plus risk analysis, economic analysis, and drilling location selection, the lead becomes a prospect that is ready to be drilled. The probability of success is highest when there is strong evidence that a reservoir, charge, and trap all exist, that they exist in the same drillable location, and that they can be profitable exploited. Our objective is to construct a pattern recognition process and associated tools that identify a location with all of the constituent parts of a lead and to quantify them to convert a lead into a prospect.

When it is applied to 3D seismic, the present disclosure identifies a potential reservoir through feature analysis, identifies hydrocarbon indications through pattern and texture analysis, and identifies the presence of a depositional process that deposits reservoir rock though texture analysis. It is also capable of identifying the presence of a trap by determining the presence of stratigraphic sequences that create stratigraphic traps through texture analysis and determining the presence of structural trapping components through fault identification by edge identification. In addition, it is capable of identifying the presence of a charge by locating stratigraphic sequences capable of expelling hydrocarbons through feature, pattern, and texture analysis plus determining the presence of faults in the neighborhood through fault identification. The final step of associating and validating the three components of an oil field is usually accomplished by a geoscientist.

After a lead has been identified, the pattern database, along with appropriate visualization, could be used to perform reservoir dissection. This is a study of the internal characteristics of the reservoir to estimate the economics and convert the lead into a prospect.

After an oil field has been discovered, the present disclosure is capable of being used to improve reservoir characterization, which is the estimation of rock properties (rock type, porosity, permeability, etc.), and fluid properties (fluid type, fluid saturations, etc.). Rock types and properties are a function of the geologic process that deposited them. In addition to information about the rock's acoustical impedance, the local features, patterns and textures contain information about depositional processes. Thus, the rock type and property estimations can be improved by including the feature, pattern, and texture information while estimating them.

In addition to the above seismic analysis methods, the present disclosure could be used for portions of data processing. Examples include, but are not limited to, automatic stacking velocity picking, automatic migration velocity picking, noise identification, and noise muting.

The present disclosure is also capable of performing data set registration and comparison by successively aligning textures, patterns, and features. When applied to seismic, it includes registering shear data to compressional data, registering 4D seismic data, registering angle stacks for AVA analysis, and others.

3D Seismic First Pass Lead Identification

This example performs first pass lead identification through simultaneous identification of a potential reservoir through feature analysis, identification of hydrocarbon indications through pattern and texture analysis, and identification of the presence of a depositional process, that deposits reservoir rock, though texture analysis. One way to do this is to use a known data set, which represents a successful lead or example lead, and compare the target data to known data. For this example, the goal is to identify reservoirs that occur in all forms of traps. Thus, it is preferable to disassociate the structural aspects of the earth from the stratigraphic, rock property, and hydrocarbon indication aspects. During this analysis, the structural aspects are not used. After the potential lead is identified using this example, the existence of a trap and charge will be determined.

For 3D seismic lead identification, the overall process starts by building a pattern database with successive levels of abstraction (features, patterns, and textures) for the known data. After the pattern database building process has been applied to a set of known data, and the minimum set of attributes that characterize the known data has been identified, the pattern database is applied to a set of data to be analyzed (the “target data”). The data of each set are subjected to the same series of steps within the abstraction process.

Before or during the comparison, an affinity or binding strength is selected by the operator that determines how closely the known data has to match the target data to result in a target being identified. The binding strength helps to identify features, patterns, and textures in the target data that adequately match, but do not exactly match, the desired features, patterns, and textures in the known data.

Next the pattern database for the known data is compared to that of the target data. The comparison is performed by identifying a hyperdimensional fragment from the known data pattern database that adequately and reasonably uniquely characterizes the known data. This hyperdimensional fragment relates the data at the location where the hydrocarbons were found, or were expected to be found, to the set of features, patterns, and textures that were derived from it. The hyperdimensional fragment and associated abstraction process parameters can be combined into a template. Templates can be used immediately or stored in a template database on one or more mass storage devices, and then retrieved when needed.

When templates are applied to target data sets, the resulting targets are identified. These targets are stored as objects which represent leads. The leads objects are the locations in the target data sets which have a potential reservoir identified through feature analysis, potential hydrocarbon indications identified through pattern and texture analysis, and the potential presence of a depositional process that deposits reservoir rock identified though texture analysis. A collection of objects are stored in a scene. The scene represents the physical locations of the leads identified by the present disclosure in this example. Geological and other required properties of the leads can be stored with them.

Because the nature of the reservoirs, and possibly the hydrocarbons trapped in them, varies across each data set due to natural geological variations, it is often necessary to create more than one template to identify all of the leads any given area offers. A collection of templates can be created and stored in a template database. These may be sequentially applied to one or many target data sets in a process called data mining. When multiple templates are applied to the same target data set, the results are several scenes each containing lead objects. The scenes and their associated objects, one scene from each template, can be combined by performing Boolean operations on the scenes containing the objects creating one composite scene.

3D Seismic Pattern Pyramid

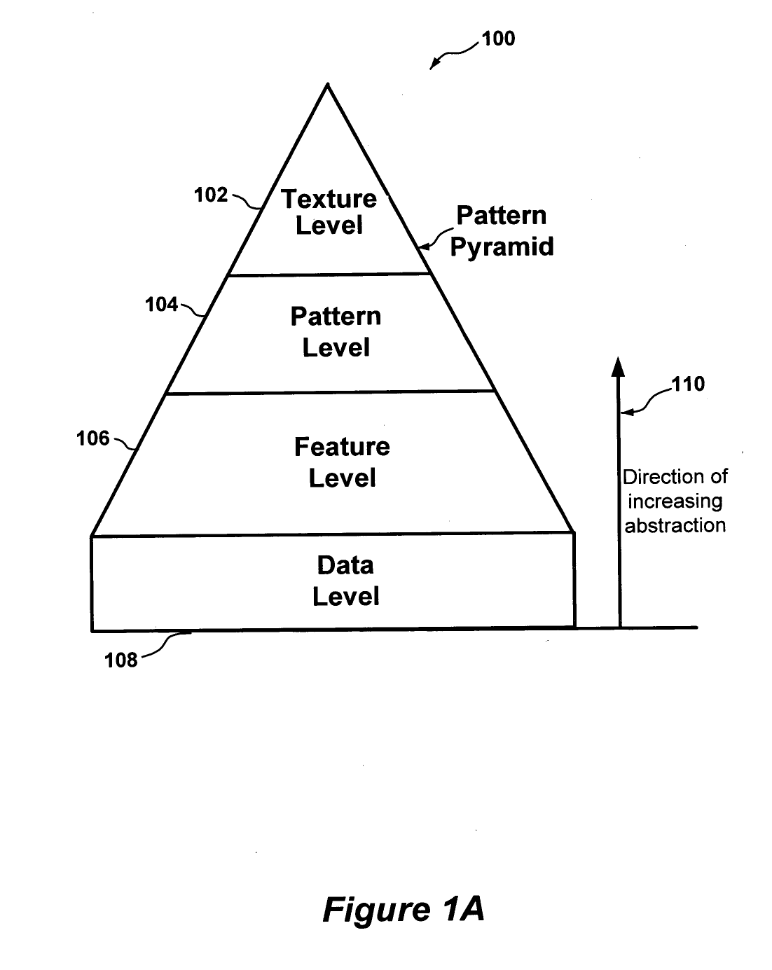

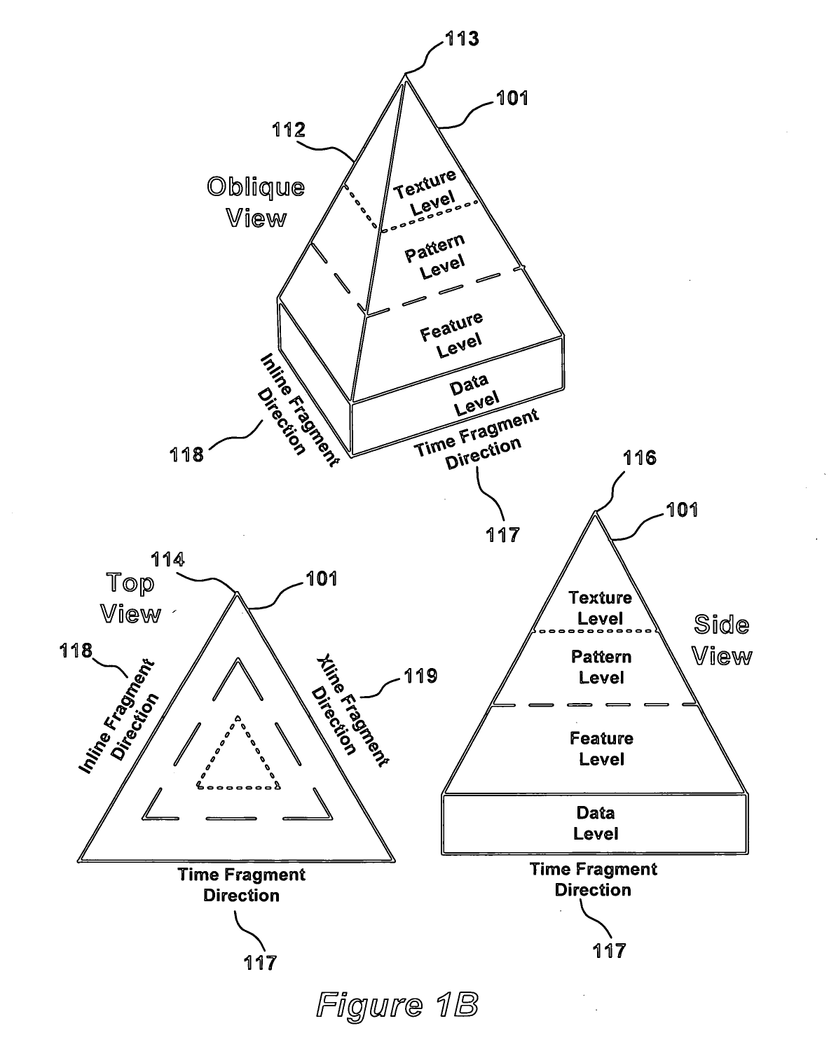

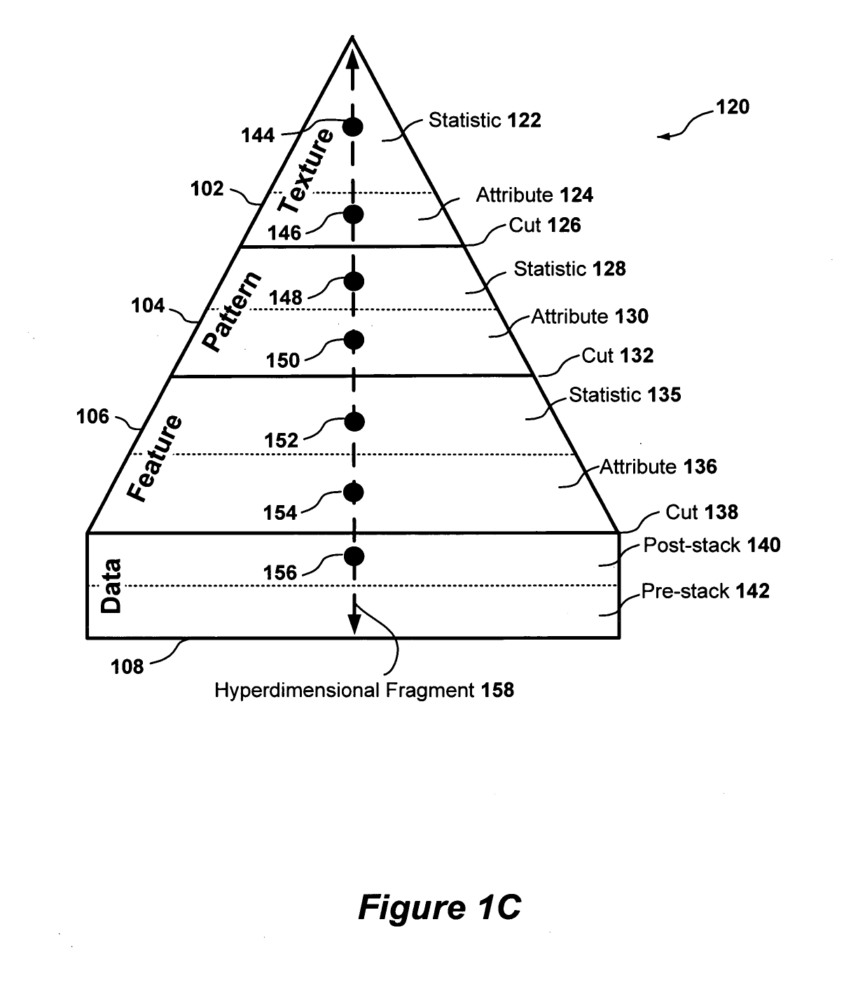

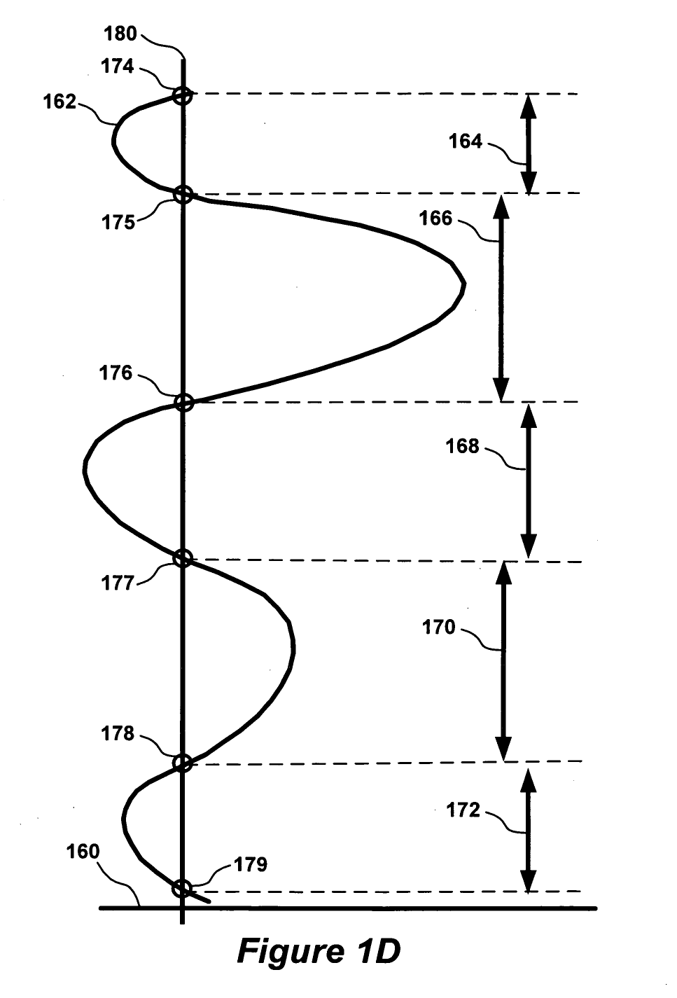

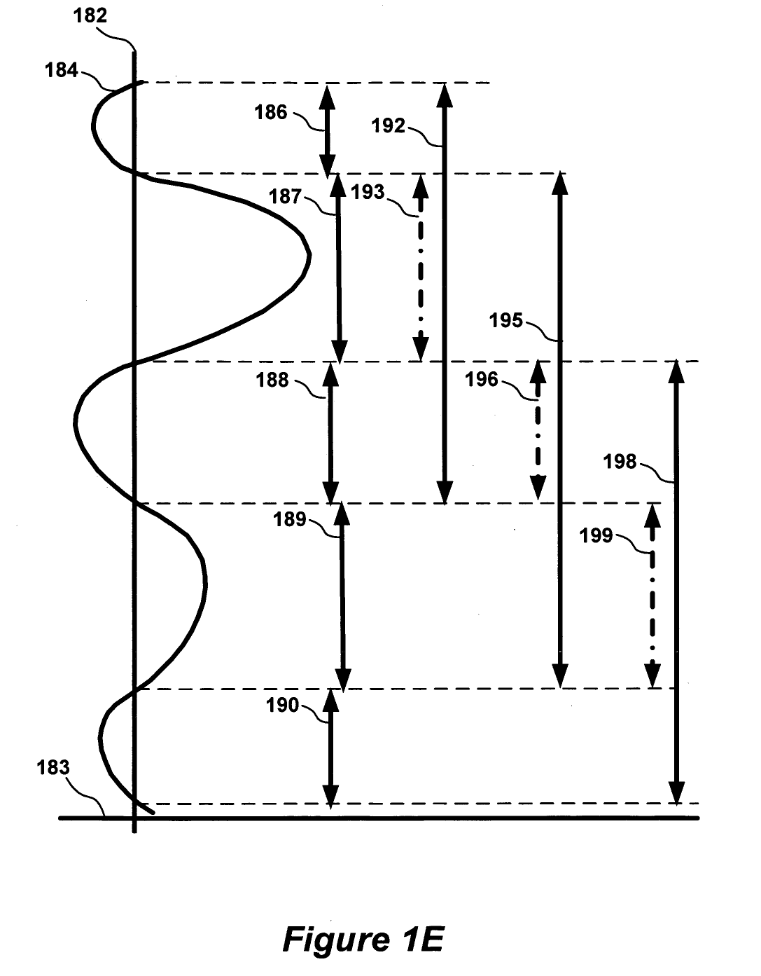

A 3D seismic data set exemplary embodiment of the layers of abstraction associated with the method of the present disclosure is illustrated in FIG. 1a. Each level of the pattern pyramid represents a level of abstraction. The input data lie at the bottom of the pyramid 100. The width at the base of each layer is generally indicative of the number of data samples or fragments involved within that stage of the method of the present disclosure. For each level of abstraction the smallest spatial unit that needs to be analyzed is a fragment. A fragment sequence is a one dimensional, ordered, spatially sequential, set of data values that cover multiple data samples and becomes larger with each higher level of abstraction. The total number of fragments for each level decreases as the level of abstraction increases leading to the pyramid-shaped illustration of FIG. 1a as shown by reference numeral 110.

In the exemplary embodiment, the pattern pyramid 100 contains three layers of abstraction above the data level 108 (see FIG. 1a). The abstraction process is first applied to the data level to generate the feature level 106. Thereafter, the abstraction process is applied (at least once) to the feature layer data to generate the pattern level 104. Next, the abstraction process is applied (at least once) to the pattern layer data to generate the texture level 102. While the exemplary embodiment illustrated in FIG. 1a has three layers of abstraction above the data level 108, only one layer is required. On the other hand, should the analysis call for it, any number of layers may be generated above the data level 108. How many layers are generated, or how they are generated is problem-specific.

The pattern pyramid shown in FIG. 1a corresponds to a single fragment orientation during analysis. Some data sets with more than one spatial dimension may require analysis in more than one fragment orientation to achieve the desired results. Seismic data has a strong preferred direction caused by the geology of the subsurface of the earth. Another example of data with a preferred direction is wood grain. For these types of data, the analysis can give very different results depending on the fragment orientation relative to the preferred direction of the data. Successful analysis of this data might require using fragments with more than one alignment. To accomplish the analysis, sides can be added to the pyramid as shown in FIG. 1b. Each side is associated with a fragment alignment direction. The example in FIG. 1b shows three views (oblique 113, top 114, and side 116) of a 3D pattern pyramid. The example shows a pattern pyramid for 3D seismic data that has 3 spatial dimensions consisting of the inline axes, xline axes, and time axes. Each direction has an associated side on the pattern pyramid, an inline side 118, an xline side 119, and a time side 117. Because geology does not always align itself with the coordinate system on which the data is collected, this orientation will result in a pattern recognition analysis where the largest effect is the structure of the earth. When analyzing the trap component of an oil field, this is very useful. If the goal is to not want to analyze geological structure and instead analyze the earth's stratigraphy, a different coordinate system is needed. To accomplish that goal, the fragments need to be aligned with the earth manifold, along dip, strike, and normal to the layers.

The pattern database building process identifies the minimum set of attributes (features, patterns, and textures) of one or several examples of known data so that, when the known data is compared to the target data, only the desired characteristics need to be considered. The results of each step are represented in the pattern pyramid 120 as shown in FIG. 1c and are stored in the pattern database. The process starts at the data layer which for seismic data can contain a lower layer of pre-stack seismic data 142 setting under a layer of post-stack seismic data 140. Above the data layer at the base, the pattern database contains several layers of abstraction that are built sequentially starting at features, proceeding through patterns, and finally ending with textures, the highest level of abstraction. There may be one or several layers of each type. Not all of the layers are required. The pattern database can be built only up to the pattern pyramid level required to solve the problem. The creation of each layer includes one or more steps of cutting, computing attributes, and computing statistics. Each layer has a cut 138, 133, and 136, computed attributes 136, 130, and 134, plus computed statistics 135, 138, and 133. The precise methods of cutting, computing attributes, and computing statistics changes from layer to layer, and can change within the layers. The specific computations in the abstraction process are designed to capture the minimum set of feature level attributes 136, feature level statistics 135, pattern level attributes 130, pattern level statistics 138, texture level attributes 134, and texture level statistics 133 required to solve the problem.

Geophysical & Geological Data

The data in the foundation of the pattern database can by any type of a variety of geophysical and geological data types. The data types include many forms of indirect and direct measurements. Direct measurements involve obtaining physical samples of the earth by mining or drilling. Indirect measurements include active and passive data gathering techniques. Passive techniques involve studying naturally occurring signals or phenomena in the earth such as magnetic field variations, gravitational field variations, electrical field variations, sound (such as naturally occurring micro-seismicity or earthquakes), and others. Active measurements involve introducing signals or fields into the earth and measuring the returns including magneto-telluric, seismic, and others. Active and passive measurements are acquired on the surface of the earth and in wells. These include, but are not limited to, seismic, electrical, magnetic, and optical data. It is capable of being applied to data sets with any number of spatial dimensions, usually one, two, or three dimensions. It also works on higher dimension data. Examples include, but are not limited to, 4D pre-stack seismic cubes containing offset data, 3D pre-stack cubes containing all of the offsets for a 3D seismic line, 4D seismic cubes containing multiple angle stacks, 4D seismic taken at different calendar dates, combinations of these, or others.

When applied to seismic data, the wave propagation types include, but are not limited to, compressional, shear, combinations and other types. The seismic can be in the form of pre-stack and post-stack data or both. It can be as acquired (raw) or processed. It can also include modified seismic data including, but not limited to, acoustical impedance computed by a seismic inversion. If the goal is to study AVO or AVA effects, reflection coefficient data of elastic impedance data may be used.

Each data sample has at least, but is not limited to, one data value. An example of a single data value at a sample includes, but is not limited to, the band-limited acoustic impedance information obtained from seismic data. An example of a sample with multiple data values includes, but is not limited to, multi-component seismic.

When the goal of the analysis is seismic interpretation of 3D seismic data, the properties of the geological layers need to be studied instead of the properties of their boundaries where reflections occur. The preferred, but not only way to accomplish this is by analyzing an acoustical impedance cube with the broadest possible bandwidth that can be reliably created by seismic inversion. The analysis can be band-limited acoustical impedance computed from reflection data. The analysis can also be broadband acoustical impedance computed from seismic data plus well log data, and/or seismic stacking velocities, and/or seismic migration velocities, and/or operator constructed models. For the lead identification example, the technique is applied to 3D seismic data that has been inverted creating a band-limited acoustical impedance 3D voxel cube.

PDB Abstraction—Cutting

The first step of the abstraction process, for each pattern pyramid level, is to cut fragments. Each fragment is a one-dimensional interval that has a physical length and physical location. It corresponds to an associated fragment sequence that is a sequence of data, attribute, or statistics values from a lower layer in the pattern pyramid.

In the most computationally efficient embodiment of the present disclosure, pre-defined or operator-supplied cutting criteria are applied to the data to generate the fragments. The specific cutting criteria that are applied for cutting can be a function of the problem, of the data being analyzed, or both. The cutting criteria can include, for example, fixed spatial length cuts, cuts derived from lower level pattern pyramid information, or cuts determined from a user supplied example.

Some forms of geophysical and geological data are amenable to using fixed-length fragments, and the present disclosure can easily accommodate fixed-length fragments. Fixed length fragments associate a fragment with a fixed number of data samples.

For band-limited acoustical impedance the most common cutting criteria are to use cuts derived from the information in any lower level of the pattern pyramid. For example, feature cutting criteria is a function of the data values. Pattern cutting criteria can be a function of the feature level cuts, feature level attributes, feature level statistics, or data values. In this case the cutting criteria remains constant for the level while the underlying data typically varies, with the results that fragment sequences are often variable in spatial length. Variable length fragments, that track geology, are preferred.

For some problems, cutting criteria need be selected interactively. Here the operator paints an example of data on one side of the cut and paints a second example of data on the other side of the cut. The application then performs a statistical analysis of all or some of the information in lower levels of the pattern pyramid to identify the information that classifies the two examples provided by the operator as different, then uses that classification to determine the cut. This is the computationally most inefficient method.

While the cutting criteria for a step of cutting typically remains constant, the specific criteria can vary from layer to layer in the pattern database. As higher levels of the pattern database are computed, the associated fragments created during the cutting process become larger.

Because geological unconformities occur in band-limited acoustical impedance zero crossings, it is necessary, when the present disclosure is used for seismic interpretation, to constrain the fragment cuts for all of the levels of the pattern database above the feature level to occur at the same spatial location as the fragment cuts for the feature level. The imposition of the constraint is accomplished by restricting the cutting criteria to be a function of the information one level below it. Other problems may not have need of the constraint.

It should be noted that the choice of the grid coordinate system, on which the data is sampled, typically has no relationship to the spatial distribution of the geology being studied and the associated data measurements. When the spatial dimensions of the data are higher than one, a fragment orientation needs to be selected. For geophysical data, the natural fragment orientation is to align it with geology. This is accomplished by computing a geology aligned coordinate system, which is an earth manifold, and using it to align the fragments and fragment sequences with geology. To simplify the implementation, the fragments can be aligned with the seismic traces recognizing that, as geological dip becomes large, the approximation quality decreases.

When the coordinate system on which the underlying data is sampled is not aligned with the geology, edge noise can occur during cutting, attribute calculations, and statistic calculations. For optimum performance, the edge noise should be eliminated or attenuated by using a continuous representation (local or global spline fit) of the data when performing computations. The best, but computationally most inefficient, solution is a manifold with continuous local coordinate charts.

PDB Abstraction—Attributes

In the second step of the abstraction process, the attributes at each fragment are computed and are stored at the attribute location for the appropriate level in the pattern database. The specific attribute computations can be the same or can vary from level to level. The attributes may be stored in a pattern database, as software objects (parameters or methods) stored in RAM, as objects stored in an object database, as objects or data stored in an appropriately mapped relational or object-relational database, or stored via some other storage technique or mechanism.

PDB Abstraction—Statistics

The third step of the process is the statistical analysis of the previously calculated attributes. The statistical analysis gives the probability of the attribute occurring in its local neighborhood (local statistic) and in the total data set (global statistic). Some statistics may represent estimates or properties (sometimes called features) of the attributes for the next level up in the pattern pyramid. An example is attribute complexity or local attribute anisotropy.

In practice, other types of information may be stored along with statistics in the present disclosure including correction parameters. An example of a correction value occurs when the data is provided in a Euclidean format. However, geological measurements are best expressed in a geology-aligned fashion. To align the analysis with geology, it needs to be aligned with the earth manifold. The corresponding earth manifold definition and/or local coordinate chart dip and azimuth values can be computed and saved within the database in the statistics level.

Additional properties, which are needed but are not captured by the attributes, may also be stored as statistics. These include properties of the earth manifold, measured on the local topology of the earth, such as local curvature. Hyperdimensional Fragment and Binding Strength

FIG. 1c illustrates how a particular point of space in the input data 140 and 142, represented by the point 156, has corresponding points 154 and 153 in the feature layer, 150 and 148 in the pattern layer, plus 146 and 144 in the texture layer. The ordered set of points 156, 154, 152, 150, 148, 146, and 144 forms a trajectory called a hyperdimensional fragment 158 of the data point 156 in question. The pattern pyramid has a set of hyperdimensional fragments that associate each data sample to the features, patterns, and textures to which it contributed. Because the type of abstraction analysis is problem specific, so too is the resultant hyperdimensional fragment.

When comparing the known data hyperdimensional fragment to the collection of target data hyperdimensional fragments, the amount of similarity required to consider them matched is determined by the binding strength or affinity. This invention implements the concept of a binding strength by setting a range of acceptable feature, pattern, and texture values at each pattern pyramid level that the hyperdimensional fragment passes through. The result is that exact matches are no longer required but similar matches are allowed.

When the above-described process is completed, the hyperdimensional fragment and associated threshold becomes a template that is used for object identification. Making a comparison between the known data and the target data is accomplished by applying the template to the target data. The comparison is accomplished by searching through all of the hyperdimensional fragments in the target data set and determining if the feature, pattern, and texture values though which they pass are the same within the binding strength as the values in the known data hyperdimensional fragment. Templates can be stored in a template database and retrieved for later use on any target data set.

Scenes and Objects

The result of applying a template to a target data set pattern database is a scene that contains null values where matches did not occur and a value representing matches where matches did occur. The next step is to identify all data connected points where matches occurred and assign them to an object. The identification is accomplished by stepping through all of the points that are marked as matched and performing an auto-track that assigns all connected points that are marked as matched to an object. This is repeated until all points that are marked as matched have been assigned to connected objects. The result is a scene containing connected objects that represent potential hydrocarbon deposits. These objects represent a simultaneous analysis of how well they represent a potential reservoir through feature analysis, represent hydrocarbon indications through pattern and texture analysis, and include the presence of a depositional process that deposits reservoir rock though texture analysis.

Objects can have associated properties. For example, a 3D manifold (also referred to as a shrink-wrap) can be placed on the boundary (outside edge) of an object forming an object space. Topological properties of the object surface, such as local curvature, can be measured and stored as an object property.

Next, the scene, the collection of objects, is then analyzed in a quality control step to determine if the system is correctly creating the desired objects. If the system creates the expected objects, but the objects are incomplete or obscured due to seismic noise, the binding strength is modified and the data mining is repeated. If the expected objects are not created or too many objects that are false positives are created, the amount of information in the PDB or associated parameters are modified, a new template is created and the data mining is repeated.

Finally the collection of objects, in the scene(s), is viewed to manually identify and remove any remaining false positives. The goal is to minimize the work in this step by a good choice of PDB construction.

Data Mining

Templates can be pre-computed from known data sets, stored in a template database, and used the pattern databases for one or many target data sets creating resultant scenes containing objects that satisfy the templates. This process is often referred to as data mining. The collection of objects becomes a lead inventory.

Feature Level Cutting Criteria, Attributes, and Statistics

For the 3D seismic first pass lead identification example, the data being analyzed is band-limited acoustical impedance. The objective is to identify hydrocarbon filled reservoir rocks. In order to identify the hydrocarbons, it is preferable to gather information about the band-limited acoustical impedance values, depositional process, and the presence of hydrocarbon indicators (bright spots, dim spots, flat spots, etc.) but exclude the geological structure so that we can find opportunities for all possible trap structures. For this example, the cutting criteria for features is cutting at each zero crossing of band-limited acoustical impedance as shown in FIG. 1d. The figure includes a portion of band limited acoustical impedance data that can be represented as a curve 162 on a coordinate system having an X-axis 160 representing the band limited acoustical impedance value (also called amplitude) and a Z-axis 180 representing the three way travel time of sound or subsurface depth. In this example, the cutting criteria creates a fragment cut wherever the band limited acoustical impedance has a zero crossing. In the example of FIG. 1d, the data 162 crosses the Y-axis 180 at six locations 174 to 179. The zero crossings 174 and 175 can be used to demarcate the interval 164 of a fragment of data, namely curve 162. Similarly, the zero crossings 175, 176, 177, 178, and 179 demarcate fragments 164, 166, 168, 170, and 172. When broadband acoustical impedance data is used, one method of cutting criteria is to find edges in the data that are places where the change in the broadband acoustical impedance values between two consecutive data samples exceeds a threshold.

The feature attributes for this example are chosen to form a visual feature set. This set describes the band-limited acoustical impedance using the same descriptions as used by seismic stratigraphers when communicating their work. This choice ensures that the features are interpretable or understood by geoscientists. Because the features are based on naturally occurring, geological visual properties, and because seismic stratigraphers have had considerable success using them, they are known classifiable. These interpretable features include the length of the fragment (also called thickness), the absolute value of the maximum acoustical impedance of the data within the fragment (also called max amp), the shape of the data values in the fragment, and the sign of the data values (+ or −). There are many ways to measure shape. One way to measure shape is to measure all of the statistical moments of the data in the fragment. This set of measurements represents all of the degrees of freedom of the problem. In practice, not all of the statistical moments are required to solve the problem. Often, only the first moment is used.

The statistics, for this example, consist of a global statistic. It is the probability of the given feature occurring in the entire data cube. Two local statistics are also computed. One is the data complexity in a local coordinate patch. Data complexity is the normalized sum of the data value variances. The second is local feature anisotropy. It computes the direction and magnitude of the feature variances in the local coordinate neighborhood. Both can be considered local texture estimates (also called texture features or texture statistics).

For seismic data the computationally most efficient method is to measure fragments for features aligned with seismic traces and is the way that seismic stratigraphers typically perform the task. Variations in structural dip may cause variations in the feature values that are not associated with rock or fluid variations. If the effects of these variations become too large, the fragments on which the features are measured must be aligned with the earth manifold. Since inline and xline fragments will carry primarily information about the earth's structure they are not used for this example. However, when the goal of the analysis is to identify structure similarity, inline and xline fragments should be used.

Pattern Level Cutting Criteria, Attributes, and Statistics

For the 3D seismic first pass lead identification example the pattern level cutting criteria is to cut the patterns so that the top and the bottom of the pattern fragments occurs at band-limited acoustical impedance zero crossings. The easiest way to accomplish this is by cutting the pattern level fragments from a combination of feature level fragments. FIG. 1e illustrates an example of pattern cutting for pattern location 192. The fragment 192 is defined as a combination of three feature level fragments 186, 187, and 188. This is often referred to as a pattern fragment length of three features and is an example of what is referred to as an odd feature length pattern fragment. By repeating the cutting process, the cutting criteria create the pattern fragment 195 for pattern location 196 using the feature level fragments 187, 188, and 189. Similarly, pattern fragment 198 for pattern location 199 comes from the feature level fragments 188, 189, and 190. Notice that the pattern fragments are larger than the feature fragments and overlap.

A shorter pattern fragment length can be computed by dropping one feature length off the top or one feature length off the bottom when performing the calculation. This is often referred to as a pattern fragment length of 3 feature lengths and is an example of what is referred to as an even feature length pattern fragment.

Longer pattern fragments can be constructed by extending either the odd or the even feature length pattern fragment described above. This is accomplished by adding one feature length to each end. Extending on both ends can be repeated as many times as required.

The pattern level attributes can be computed by performing a transformation of the feature attribute values associated with the pattern fragments into pattern space. After the transformation, each location in pattern space contains the population density of pattern fragments that transform into it. Peaks in the population density can be identified and the space can be broken into clusters by placing decision surfaces between the clusters or peaks. The regions between decision surfaces for each cluster are assigned pattern attribute values. The pattern attribute values can then be transformed back to physical space and assigned to the pattern intervals as pattern attributes. This is the most computationally intensive technique and is too costly to be used for production processing and data mining.

A second method of computing pattern attributes is performed by breaking the pattern space up into user-defined bins. To do this the binding strength needs to be selected at this point of the analysis. The bin size is determined from the binding strength. For each pattern location, the bin into which the feature attributes associated with the given pattern fragment transforms is easily computed and stored as the pattern attribute value at the pattern location. This association is, computationally, the most efficient method. However, the association method has the drawback that the binding strength must to be set at this point of the analysis rather than be selected dynamically or interactively later, when the known data and target data pattern databases are compared. If the binding strength is not known, it will be difficult to use this method. Sometimes, it is determined by trial end error where the user repeats the analysis with different binding strengths and chooses the one that gives the best results. This method is often refereed to as fixed bin clustering or quick clustering.

A third method is to compute the coordinates of the pattern space location into which the feature attributes associated with the pattern fragment transforms and storing the coordinates as the pattern attribute values at the pattern location. The coordinates can be expressed in spherical coordinates, Cartesian coordinates, or any useful projection. In this method, the pattern attributes have several values. The maximum number of values is equal to the number of feature fragments that are combined to create the pattern fragment. This is the computationally less efficient than the second method but much faster than the first method and can be used for data mining. It has the drawback that each pattern attribute has multiple associated values and thus uses a lot of space on disk and in RAM. It is possible to decrease the storage requirements by discarding of combining values. It has the benefit that the binding strength selection can be accomplished during pattern database comparison, which makes it the most flexible method.

Any or all of the above methods of computing pattern attributes can be included as one or several levels in the pattern level of the pattern pyramid. Other methods of unsupervised classification, usually clustering methods, can also be used. The specific choices depend on how well and how uniquely the algorithm isolates out (classifies) the targets of interest from the rest of the target data.

Statistics can include the same algorithms used at the feature level of the pattern pyramid but applied to the pattern attribute values.

For seismic data, the computationally most efficient method is to measure pattern fragments that are aligned with seismic traces. This is the way seismic stratigraphers typically perform the task. Variations in structural dip may cause variations in the feature attribute values that are not associated with rock or fluid variations. If the effects of these variations become too large, the fragments on which the feature attributes are measured must be aligned with the earth manifold. Since inline and xline fragments will carry primarily information about the earth's structure, they are not used for this example. When the goal of the analysis is to identify similar structures, the inline and xline fragments should be used. Fragment orientations that are aligned with the earth manifold or along local dip and strike will capture information about stratigraphic variations in the rocks and fluid variations related to the transition from hydrocarbon filled reservoir rock to brine filled reservoir rock. For the 3D seismic first pass lead identification example, it might be useful to use a 3D pattern pyramid and populate the strike and dip sides of the pattern pyramid with strike and dip oriented pattern attributes and statistics computed from feature attributes from the vertical level of the pattern pyramid. This is computationally intensive, thus it might be faster to estimate them by computing them in the inline and xline directions but limiting the calculation to local coordinate patches with a common feature sign.

Texture Level Cutting Criteria, Attributes, and Statistics

For the 3D seismic first pass lead identification example, the cutting criteria, attribute calculations, and statistics calculations are the same as for the pattern level with the following exceptions. First, the cutting criteria are computed as multiples of the pattern fragments rather than feature fragments. Second, the texture level attributes are stored at texture locations and are calculated from the pattern level attributes rather than the feature level attributes. The input to the transformation is texture fragments and the transformation is to texture space rather than pattern space. Third, the statistics only include the global statistics.

PDB Comparison, Objects, and Scenes

For the 3D seismic first pass lead identification example, the PDB comparison is performed by comparing hyperdimensional fragments. The binding strength is specified for each level of the pattern pyramid where it was not already specified during pattern database construction usually by using the quick clustering technique above. When this step is performed for the first time it is often performed interactively during visualization of a target data set and the related pattern database. When the optimal binding strength has been chosen, the template is applied to the target data set. This step is often referred to as applying a scene construction tool. After this is accomplished the spatially connected objects are computed using another tool that is also referred to as a scene tool.

Data Mining and Lead Inventory

For the 3D seismic first pass lead identification example, the template computed above is saved in the template database. The appropriate templates are checked out and applied to all of the data in the geographical region being analyzed. The resulting scenes and associated templates are combined using Boolean operations that are usually referred to as Boolean scene tools. The final product is a lead inventory that is associated with a scene containing a list of multiple leads (objects) and lead parameters. The lead parameters include lead names, locations, spatial sizes, global statistics, local statistics, and other useful information as required by the operator.

Implementation

The present disclosure is preferably implemented as a set of one or more software processes on a digital computer system. However, the present disclosure may also be implemented purely in hardware, or may be virtually any combination of hardware and software.

As an example, the present disclosure may be modeled on a digital computer with the aid of various software objects that encapsulate data in the form of properties, and computations as methods. Moreover, these various object may have one or more methods through which selected functionality is performed. Each of these objects has a class definition and is interconnected according to the following descriptions and referenced drawings.

The Apparatus of the Present Invention

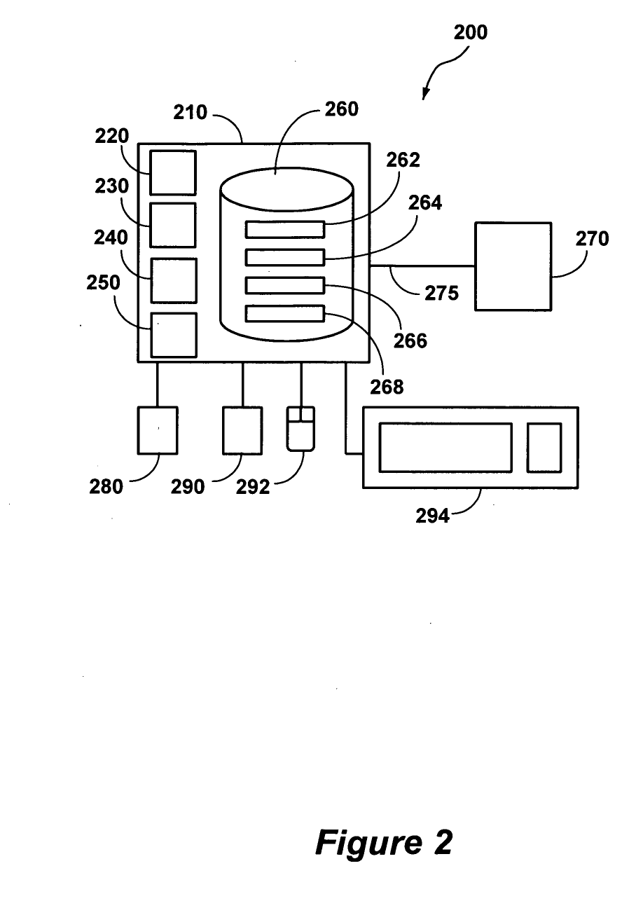

FIG. 2 illustrates an enhanced personal computer (“PC”) 200 used for extracting features from a signal. Enhanced PC 200 includes a main unit 210, a high-resolution display 270, a VGA cable 275, an optional CD-ROM drive 280, an optional 8 mm (or other type) tape drive 290, a mouse 292, and a keyboard 294. Main unit 210 further includes one or more CPUs 220, a high-speed memory 230, a network card 240, a high-speed graphics card 250, and an internal and/or external hard drive 260. The hard drive 260 can be replaced with any suitable mass storage device, such as a storage area network (“SAN”), RAM, tape, drum, bubble or any other mass storage media. Hard drive 260 stores, for example, a seismic and SEG-Y format database 262, a pattern database (“PDB”) 264 (also called a knowledge hierarchy), well data, culture data, other supporting adapt and documents, one or more applications 266, and a template library 268.

High-speed memory 230 is used to accelerate processing. High-speed graphics card 250 is preferably an ultrahigh-speed graphics card like the Intense 3D Wildcat (manufactured by 3DLabs of Huntsville, Ala.). High-resolution display 270 is the highest resolution display currently available in order to support the applications, which are intensely graphic in nature, and is electrically connected to main unit 210 by VGA cable 275. Also electrically connected to main unit 210 are: CD-ROM drive 280, 8 mm tape drive 290, mouse 292, and keyboard 294. Other peripheral devices may also be connected to the PC 200.

In operation, seismic data enters the enhanced PC 200 via, for example, the 8 mm tape drive 290, the CD-ROM drive 280 and/or the network card 240. This seismic data is stored in, for example, SEG-Y format in database 262 and is processed by CPU 220 using applications 266, with mouse 292, and keyboard 294 as input devices and high-speed memory 230 to facilitate processing. The processed seismic data is then stored in a PDB 264 format.

After pattern analysis, a PDB contains a collection of data volumes. The collection includes a 3D seismic data volume, multiple associated pattern, feature, texture volumes, and multiple scene volumes. The data values are stored so that they can be addressed as spatially vertical columns or horizontal slabs with the columns and slabs made up of subsets called bricks. A stack of bricks that extend from the top of the cube to the bottom is a column. A mosaic of bricks that extends horizontally across the volume is a slab. The brick size is chosen to optimize data access, for example, 64 by 64 samples in size. The samples are 8-bit integer, 32-bit floating point, or any other desired format. Each volume contains metadata including:
the volumes name;
physical dimensions in slice coordinates (index numbers), seismic survey coordinates, and world (map) coordinates;
labels for each spatial axes;

physical units for the world coordinates of each axes;
registration points associating the slice coordinates to the seismic survey coordinates;
registration points associating the seismic survey coordinates to the world coordinates;
default display properties appropriate to the type of data:
default color table;
default opacity table;
sample value label;
sample value scaling properties (additive minimum and maximum values of scaled sample values);
history including date and text entry including:
source from which the adapt was obtained;
operations which were performed on the data by the present disclosure;
description of the data; and
user provided notes;
minimum and maximum sample values, plus histogram of data values;
locking keys and other data management keys and pointers; and
other associated information.

The PDB collection, and associated metadata, can be stored as files on a file system, as information in a database, or as a combination of the two.

After modification, a seismic template is created for each geoscientist, and this template is stored in template library 268. During processing, the seismic data is viewed on the high-resolution display 270. After further processing, the seismic data is stored in template library 268, and output to 8 mm tape drive 290 or CD-ROM 280, or transmitted via the network card 240.

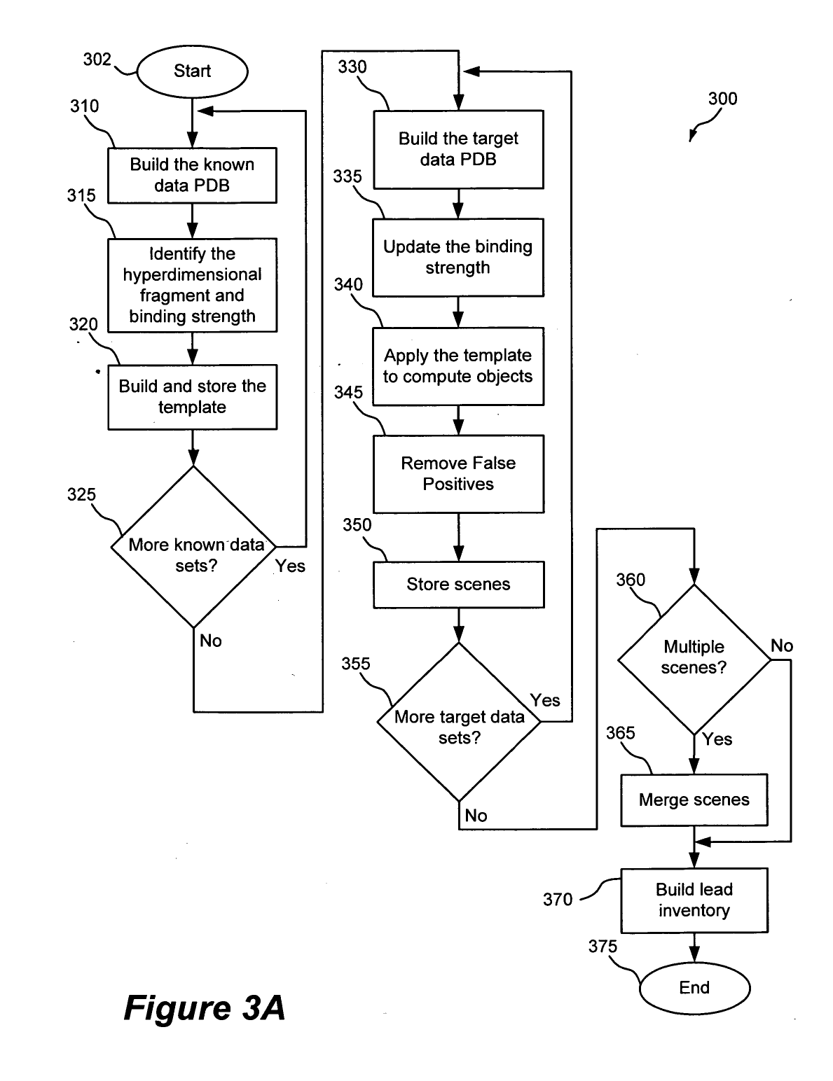

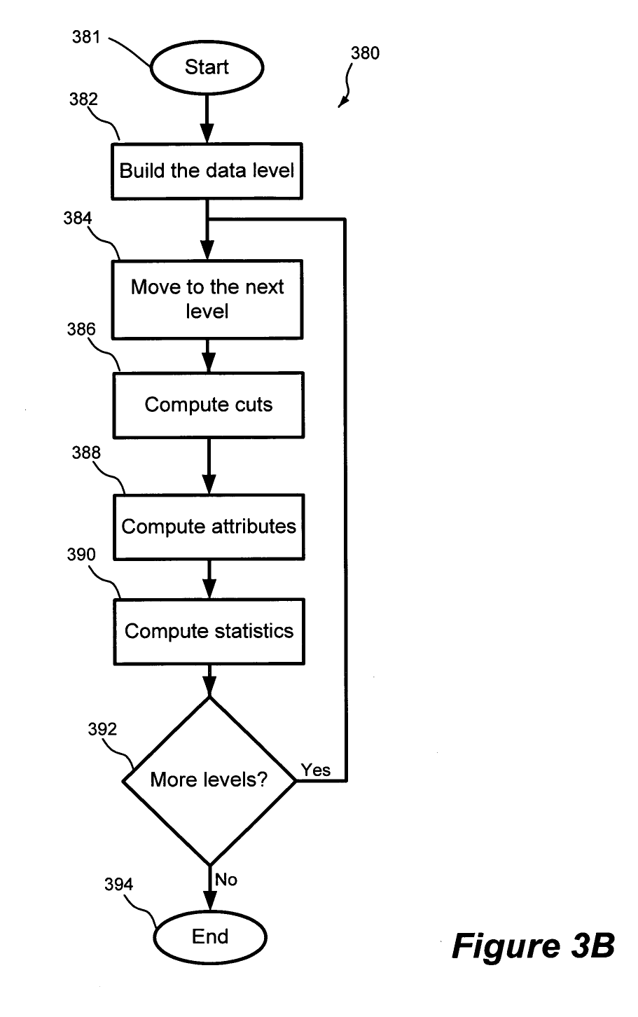

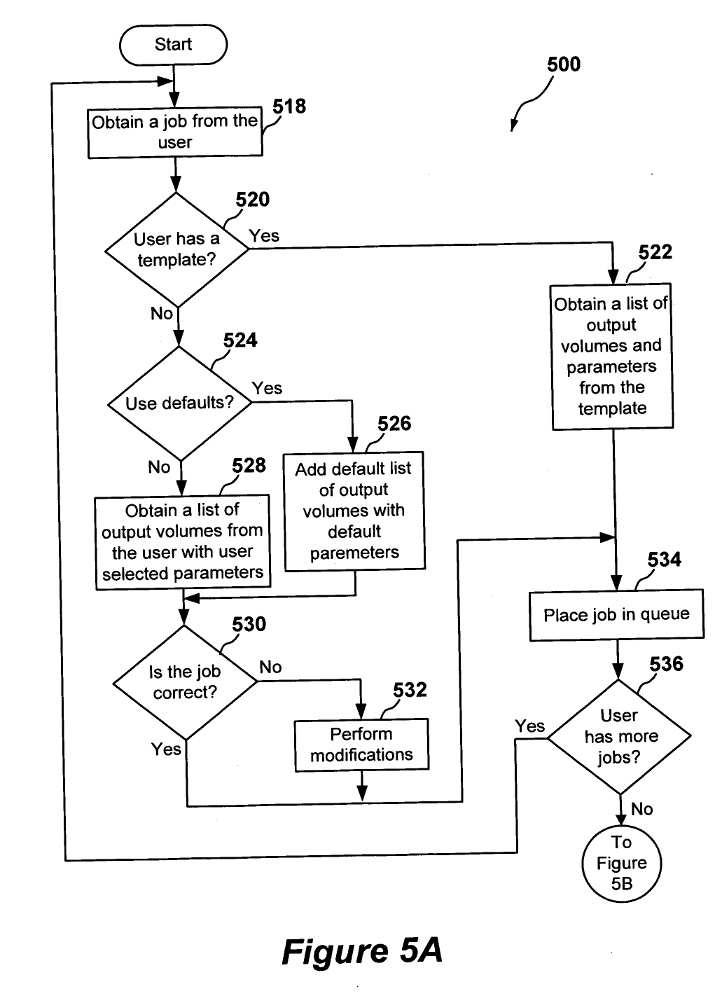

The methods illustrated in FIGS. 3 and 5 are executed using object-oriented programming, which allows reflection coefficient (“RFC”) data, acoustic impedance (“AI”), and other calculated feature extraction information to be stored either as parameters and methods or as results, according to the available memory and processing capability of the host system. If the full results of the seismic data analysis are stored in the PDB 264, the memory requirement is measured in terabytes, which is more memory capacity than many systems have. If the parameters and methods for generating the seismic analysis are stored instead, the system must have enormous processing capability and high-speed memory 230 in order to rapidly calculate the analyzed seismic data when the seismic object is executed.

Method of 3D Seismic First Pass Lead Identification

The present disclosure employs the above-identified apparatus for various purposes. The method of the present disclosure will now be illustrated via the 3D seismic first pass lead identification example method of the present disclosure is illustrated in FIG. 3a by method 300. The method starts generally at step 302. In step 310, the operator executes a batch program called Chroma Patterns to build a pattern database for the known data set. This step performs the method 380 shown in FIG. 3b. In step 315, the user visualizes the PDB built in step 310 in a suitable visualization application, usually Chroma Vision, although others such as VoxelGeo, GeoViz, EarthCube, etc. could be used. The known data set usually contains a target that is a zone of a drilled hydrocarbon filled reservoir or a zone of the geology of interest to the geoscientist. It also contains non-targets that are zones that are not of interest. The geoscientist studies the data, feature, pattern, and texture attribute and statistic values associated with the targets and non-targets to identify the values for attributes and statistics at each level of the pattern pyramid that classify the two as different. This can sometimes be accomplished quickly be probing the zones with the cursor and monitoring the readout of the values. A better method is to paint examples of the targets and non-targets and export a spreadsheet of value population histograms for them that are then read into a spreadsheet analysis and graphing program such as Microsoft Excel, which is manufactured by the Microsoft Corporation of Redmond, Wash. They can then be analyzed statistically by curve fitting and cross plotting to identify the attribute and statistic values for each pattern pyramid layer that has the highest probability of classifying the targets as different than the non-targets which become the hyperdimensional fragment. An analysis of the distribution or residuals can be used to determine the required binding strength. If the known data set is small enough, the hypothetical templates could be created and interactively applied and modified in a trial and error process to determine the best hyperdimensional fragment and binding strength. The end product is a hyperdimensional fragment containing the associated values for each level of the pattern pyramid and an associated binding strength that properly classifies the known data set. In step 320, the template is built using the hyperdimensional fragment identified in step 315 and the parameters used to build the PDB in step 310. The template is stored in a template database. In step 325, the operator determines if there are more known data sets. If the answer is yes method 300 proceeds to step 310. If it is no the method 300 proceeds to step 330. Because geology is complex any given area might contain more than one play concept. A play concept is a geological situation (reservoir, trap, and charge) that causes a hydrocarbon accumulation to occur. Thus, an analysis will require more than one known data example. To accommodate this, more than one template needs to be made, one for each play concept. In step 330, the operator executes a batch program called Chroma Patterns to build a pattern database for the target data set. This step performs the sub-method 380 shown in FIG. 3b. In step 335, the binding strength is selected using the same technique described in step 315 with the exception that the visualization is performed on the target data set and only the binding strength is determined (the hyperdimensional fragment remains unchanged). The goal is to eliminate false positives, if any, which appear when the template is applied to the target data. In step 340, the operator executes an application called Chroma Patterns (Cpat, available from Chroma Energy, of Houston Tex.) to apply the template to the target data set PDB. The result usually identifies voxels with properties like the target but the voxels have not been collected into connected bodies. This step is often performed in a different application such as Chroma Vision, which is also available from Chroma Energy of Houston, Tex. The result is a scene containing spatially connected objects that satisfy the template. In step 345, the operator visualizes the scene and the objects contained in them in a visualization application, as described in step 315, to determine if the collection of targets identified by step 340 contain false targets. False targets may include geology which has the same visual characteristics as hydrocarbon accumulations but are known to not contain hydrocarbons (coals, very clean brine filled sands and others). They may also contain targets that are too small to be commercially viable which are removed by setting a threshold based on size. In step 350, the scenes are stored, usually along with the pattern database. In step 355, the operator determines if there are more target data sets to be analyzed. If yes, this method returns to step 330. If no this method proceeds to step 360. In step 360, the operator determines if only one of more than one scene was created during the operation of this method. If only one scene was created, the method skips step 365 to step 370. If multiple scenes were created the method proceeds to step 365. In step 365, the present disclosure operator executes a computer application, usually scene tools in Chroma Vision, to merge the scenes together into a single scene. This combination is performed using repeated Boolean operations applied to the objects in the scenes to create a union of the objects creating a single merged scene. In step 370, the operator uses a computer application such as Chroma Vision to export a the spreadsheet list of objects and associated information such as their names, locations, sizes, and other information as required by the operator. Additional information is appended as required to make a lead inventory spreadsheet. The method 300 ends generally at step 375.

Method of Building a Pattern Data Base for Geophysical and Geological Data

An additional embodiment of the present disclosure is a system for and method of building a pattern database. This method will now be illustrated via a building a pattern database for geophysical and geological data example method that is illustrated in FIG. 3b by method 380, which begins generally at 381. In step 382, the present disclosure operator uses a computer application to read the data and write it to the appropriate location in a pattern database. The operator performs uses a computer application, to perform steps 384 through 390. The operator usually selects all of the required parameters the build a set of batch jobs that are then queued and run in batch mode without user intervention. For the first time, step 384 is performed, the Chroma Patterns application initializes the process to start at the first level of abstraction in the pattern pyramid. After the first time, the application increments to the next higher level of abstraction. In step 386, the Chroma Patterns application applies the operator selected cutting criteria for the current level of abstraction of the pattern pyramid. The specific algorithms and parameters are selected by the operator from a list of options and depend on the nature of the data and the goal of the analysis. A list of specific choices and the associated algorithms described are later. In step 388, the Chroma Patterns application applies the operator selected attribute computations for the current level of abstraction of the pattern pyramid. The specific algorithms and parameters are selected buy the operator from a list of options and depend on the nature of the data and the goal of the analysis. A list of specific list of choices and the associated algorithms described later. In step 390, the Chroma Patterns application applies the operator selected statistics computations for the current level of abstraction of the pattern pyramid. The specific algorithms and parameters are selected buy the operator from a list of options and depend on the nature of the data and the goal of the analysis. A list of specific list of choices and the associated algorithms described later. In step 392, the Chroma Patterns application checks the user-supplied parameters to determine if there are more levels of abstraction to be computed. If yes, the method returns to step 384. If no, the method proceeds to step 394 and the method 380 ends.

Method of Building a Pattern Data Base For 3D Band-Limited Acoustical Impedance

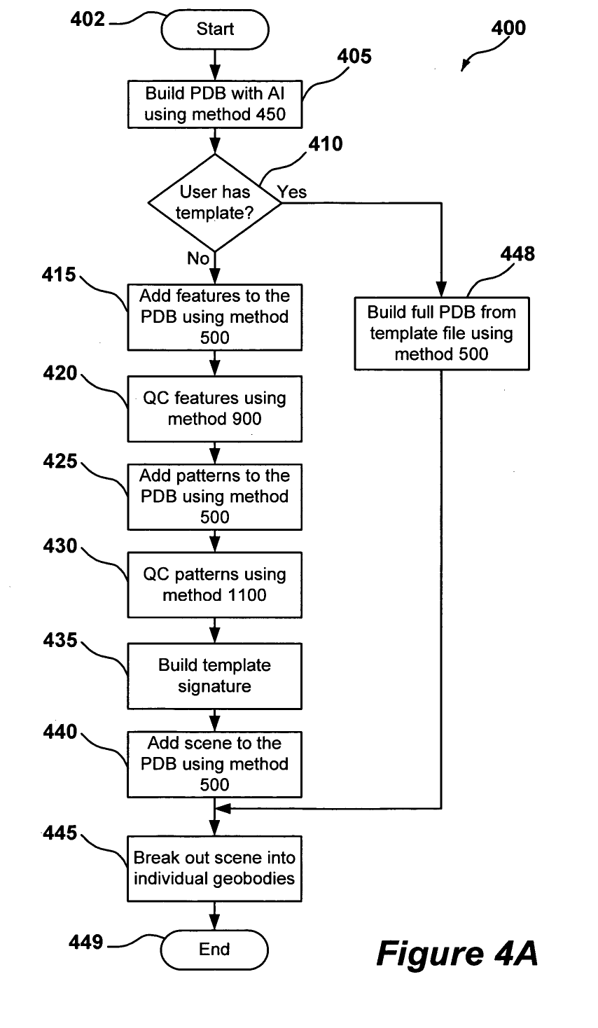

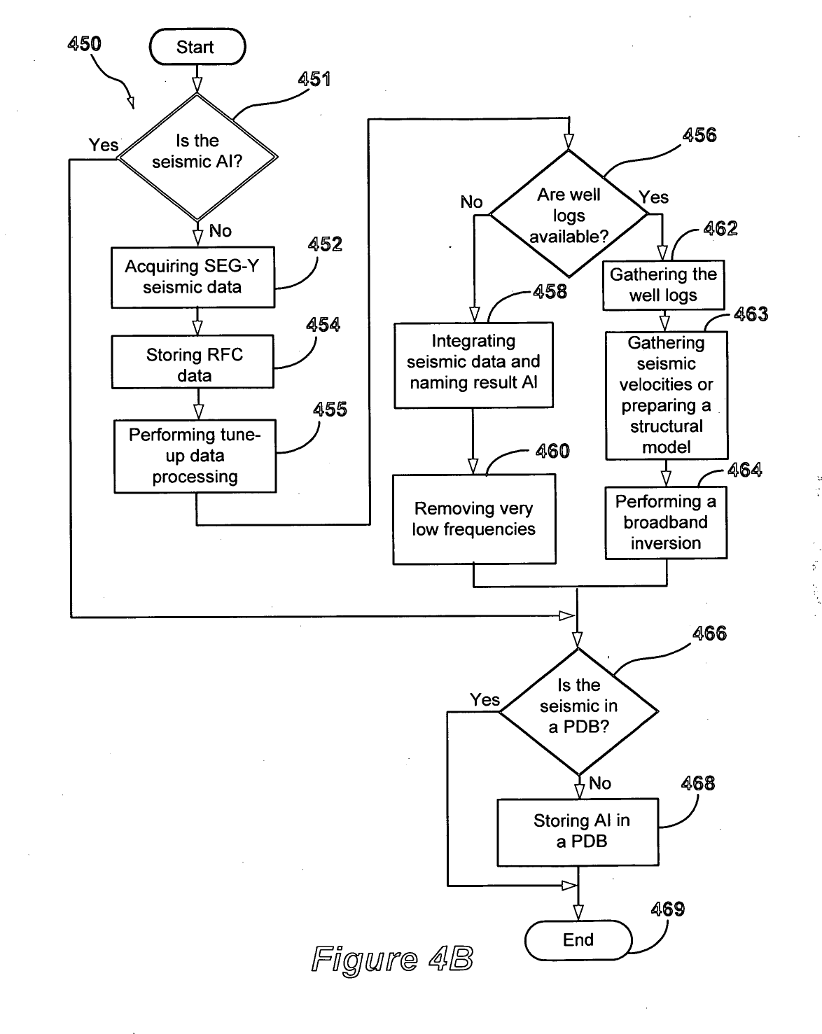

An additional embodiment of the present disclosure is a system for and method of building a pattern database. This method will now be illustrated via building a pattern database for 3D band-limited acoustical impedance example that is illustrated in FIG. 4a by method 400.

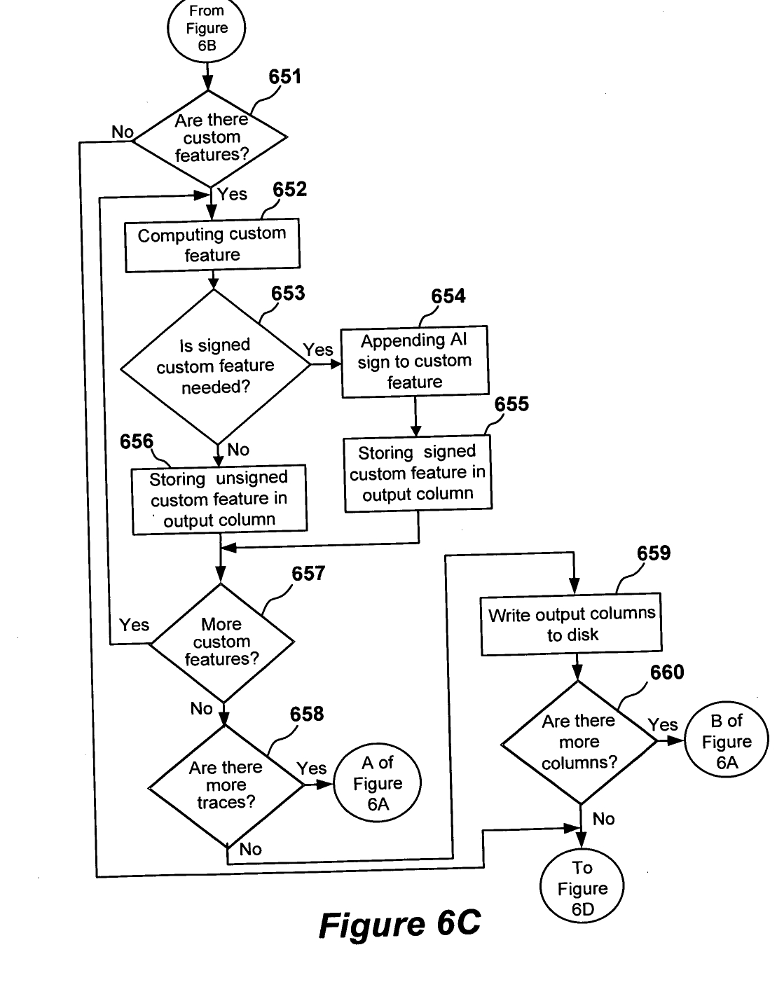

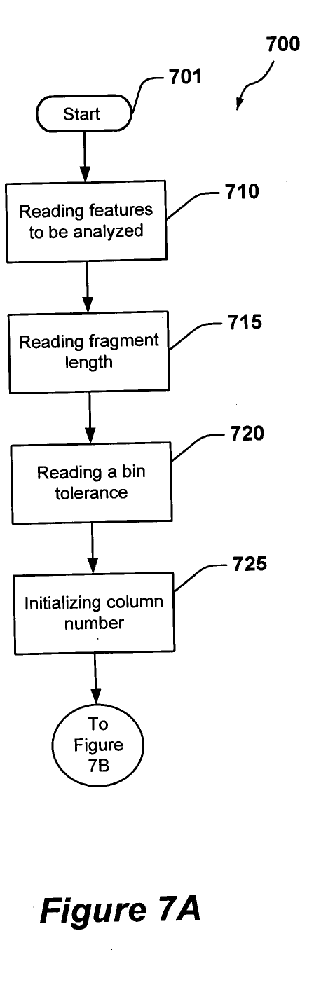

FIG. 4a illustrates an example of an embodiment of the method of the present disclosure for performing a pattern analysis of seismic data. The method starts generally at step 402. In step 405, the system operator performs method 450 in order to prepare the seismic data for pattern analysis. In step 410, the operator checks to determine if this method was already performed at least once in the past and a template has been created. If yes, the method 400 proceeds to step 448; otherwise, the method 400 proceeds to step 415. In step 415, the system operator uses a pattern analysis application that is described in method 500, as illustrated in FIG. 5, in order to add features to the PDB. In step 420, the system operator performs a quality control analysis of the features that were created in step 415 by performing method 900 shown in FIG. 9. In step 425, the system operator uses a pattern analysis application that is described in method 500, shown in FIGS. 5a and 5b, to add patterns to the PDB. In step 430, the system operator performs a quality control analysis of the patterns that were created in step 425, by performing method 1100 that is shown in FIG. 11. In step 435, the system operator uses a visualization application to select a set of voxels by painting or any other selection method. The painted portion of the data identifies an example of the geological feature the geoscientists is searching for. The application displays the ranges of data values in the selected area. These data ranges are stored in a template signature file. The template signature contains the PDB signature that locates geological geobodies and other objects of interest. In step 440, the system operator uses a pattern analysis application with method 500 that is described in FIGS. 5a and 5b, to add a scene to the PDB using the template signature that was built in step 435. In step 445, the system operator uses a connected body autotracker, usually in a visualization application, to separate out all of the connected geobodies in the data set. This is accomplished either manually or automatically in that the autotrack process is repeated iteratively using as a seed point all voxels that have not been included in a previously autotracked body until all of the voxels have been processed. This step is better facilitated when all of the data is in RAM to perform the search and thus, it is preferable not to perform this step in a batch mode that streams the data to and from disk. When this step is completed, method 400 proceeds to step 449 and ends. In step 448, the system operator uses a pattern analysis application of method 500, as described in FIG. 5, in order to build a complete PDB and scene. When step 448 is completed, method 400 proceeds to step 449 and the method 400 ends generally.

Method of Preparing Seismic Data for Pattern Analysis

An additional embodiment of the present disclosure is a system for and method of preparing seismic data for pattern analysis. FIG. 4b illustrates an exemplary embodiment of the method for preparing seismic data for pattern analysis. In step 451, the operator checks to determine if the seismic has already been acquired and is already in the form of band-limited acoustical impedance or of broadband acoustical impedance. If yes, the method 450 proceeds to step 466; otherwise, the method 450 proceeds to step 452. In step 452, seismic data is collected by, retrieving it from a data library, purchasing it from a data acquisition company, or acquiring it for example, from rolling vehicles using a geophone if the sound source is land-based, or by ships using a hydrophone if the sound source is marine-based. After collection, the seismic data is stored locally on magnetic tape or other mass storage media. The seismic data is then processed using standard techniques. In step 454, the RFC data is preferably stored in SEG-Y format in the database 262. An alternate source for seismic data is data that has been previously acquired and stored. The data is read, for example, from a magnetic tape by inserting the tape into the 8 mm tape drive 290 (see FIG. 2), or by transmitting the data over a network, e.g., the Internet, to network card 240. The seismic data is stored on disk as RFC data in the SEG-Y industry standard format. In step 455, the system operator uses an industry standard data processing application such as ProMax from Landmark Graphics of Houston, Tex., to perform some types of standard seismic data processing, if required, to reduce noise and improve the data quality. The amount of tune-up processing varies depending on the quality of the data that was received. In step 456, the operator checks to determine if wells have been drilled and if the merged, edited, and processed well log data is available in LAS format. If yes, then method 450 proceeds to step 462; otherwise, the method 450 proceeds to step 458. In step 458, the system operator uses an industry standard data processing application, such as ProMax from Landmark Graphics to integrate the seismic data, thereby turning the output value of a sample into a running sum of the previous sample plus the input value of the current sample. The resulting data is called band-limited acoustic impedance or RAI that has the same bandwidth as the seismic data, as well as some very low frequency artifacts. Since many applications do not have this function, an application plug-in is usually written to provide this capability. In step 460, the system operator uses an industry standard data processing application, such as ProMax from Landmark Graphics, to remove the lowest frequencies from the seismic data. Low-frequency data artifacts are caused by the fact that a digital signal of finite length and having discrete samples cannot be free of direct current (“DC”). Several standard methods can be used to subtract the low-frequency seismic data, including a polynomial fit that is then subtracted, band-pass filters, or recursive band-pass filters. The result of this step is AI with the same bandwidth as the seismic data and is called band-limited AI. In step 462, the operator gathers the well logs in LAS format and stores them in the database 262. In step 463, the operator gathers seismic velocities or prepares a structural model and stores them in the database 262. In step 464, the operator uses a commercially available seismic processing application, to perform a seismic inversion using industry standard techniques. The result is called acoustical impedance. In step 466, the operator checks to determine if the seismic was previously placed directly into a PDB. If yes, then method 450 proceeds to step 469 and ends; otherwise, the method 450 proceeds to step 468. In step 468, the system operator uses an industry standard data processing application, such as ProMax from Landmark Graphics, to reformat the AI result of step 460 or step 464 and store it on the hard drive 260 in the PDB format. Since the PDB format is not an industry standard format, an application plug-in is written to provide this capability. The PDB 264 now contains RFC data and either band-limited AI or broadband AI, and the method ends generally at step 469.

Method of Constructing a Pattern Data Base for 3D Band-Limited Acoustical Impedance

An additional embodiment of the present disclosure is a system for and method of constructing a pattern database. This method will now be illustrated via a preparing 3D seismic for pattern analysis example method that is illustrated in FIGS. 5a and 5b by method 500.

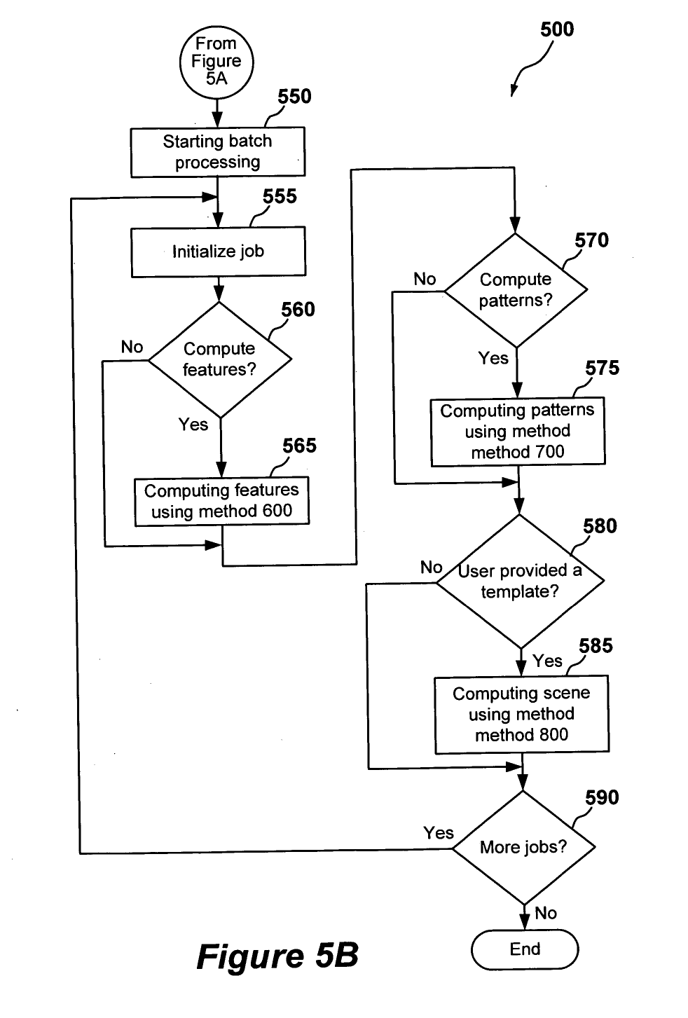

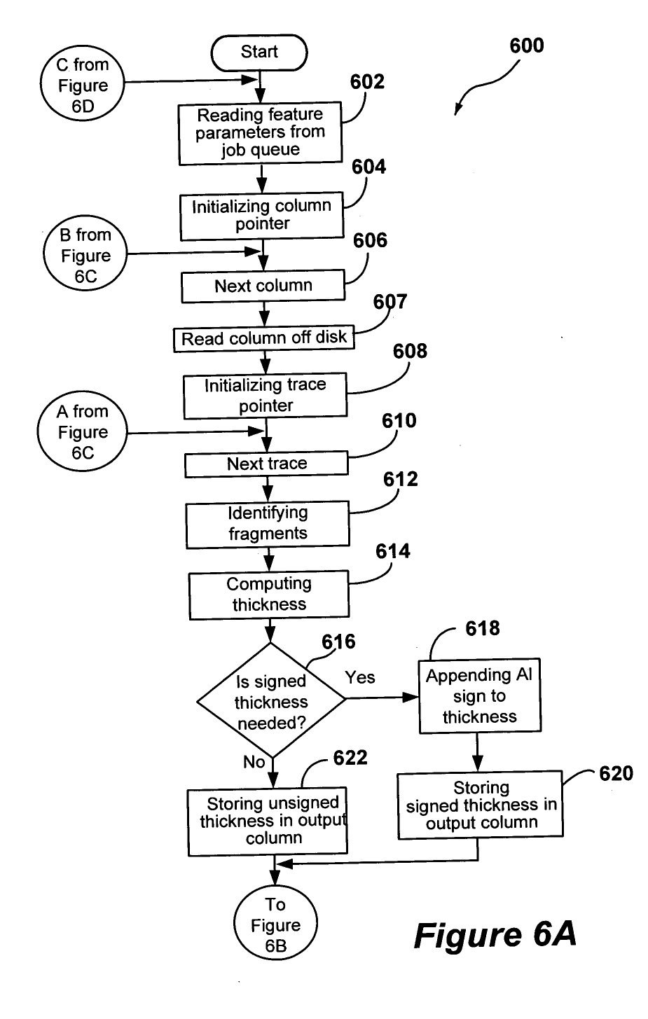

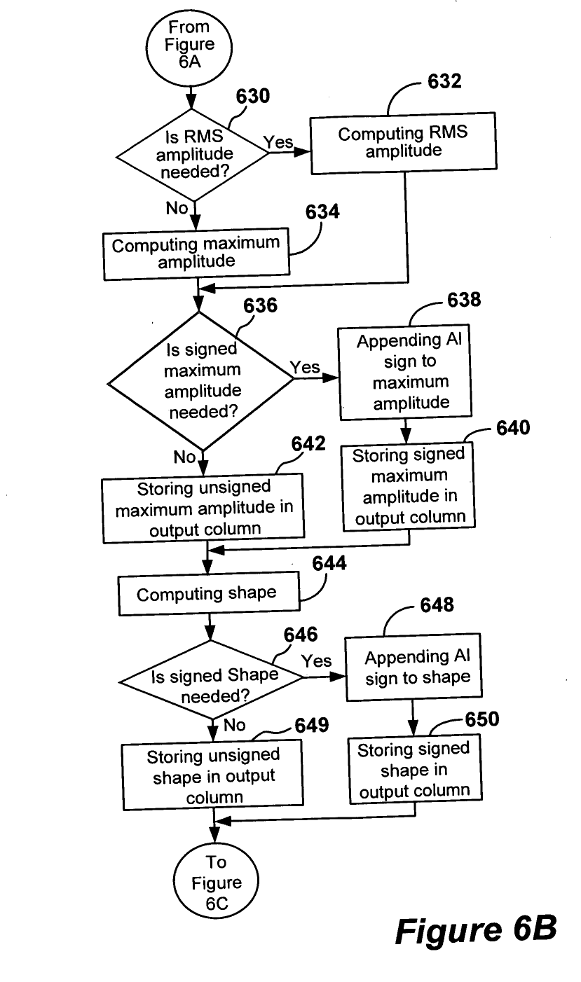

Note that this alternate embodiment of the present disclosure is practiced after completing the method described in FIGS. 4a and 4b. Further, this additional embodiment of the present disclosure assumes the prior creation of a PDB 264 that contains either band-limited or broadband acoustical impedance. Note also that this method uses sub-method 600 (illustrated in FIGS. 6a, 6b, 6c, and 6d) plus sub-method 700 (illustrated in FIGS. 7a, 7b, and 7c) plus sub-method 800, as illustrated in FIG. 8. This method is preferably implemented as a single computer application. The application has two modes of operation. The first part of the method is described in steps 518 through 536, where an interactive session allows the operator to build a list of work to be accomplished in a job. In addition, multiple jobs are placed in a job queue. The second part of the method is described in steps 550 to 590, where the application runs in a batch mode, without user intervention. While running in batch mode, the application displays a progress indicator with elapsed time and remaining time. In addition, pause, resume, and stop buttons are displayed which perform the indicated functions if invoked by the system operator. Referring to FIG. 5, In step 518, the application displays a user interface that the system operator uses to define a job. A job is a list of output volumes and associated parameters that are created from a single input AI volume. In this step 520, the application checks to determine if there is an operator-provided template that was created during a previous execution of this method. If yes, the method 500 proceeds to step 522; otherwise, the method 500 proceeds to step 524. In this step 524, the application is instructed by the operator to use the default parameters. If yes, the method 500 proceeds to step 526; otherwise, the method 500 proceeds to step 528. In this step 526, the application creates a list of default output volumes and associated parameters to define a job. After step 526, the method 500 proceeds to step 530. In this step 528, the application displays a user interface that allows the user to add output volumes to the list until the list is complete. Each added volume is added to the list with default parameters that the user is allowed to change. In this step 530, the application displays the list of output volumes and associated parameters for the system operator to review and determine if the list is correct. If yes, the method 500 proceeds to step 534; otherwise, the method 500 proceeds to step 532. In this step 532, the application displays a user interface that allows the user to add output volumes to the list, remove output volumes from the list, and modify the associated parameters until the list and the parameters are correct. In this step 534, the application appends the operator-defined jobs to the bottom of a processing queue. It displays a user interface that allows the operator to alter the order of the jobs that are in the queue. In this step 536, the application allows the user to add more jobs to the processing queue. If more jobs are to be added, then the method 500 proceeds to step 518; otherwise, the method 500 proceeds to step 550. In this step 550, the application displays a run button. When the operator is ready, the batch-processing mode is invoked by, for example, pressing the run button. This usually occurs at the end of the workday when the operator is ready to leave the office. This allows the computer to run at night, thereby performing productive work while unattended. In this step 555, the batch application initializes the first unprocessed job in the queue. This step includes the reading of the output volume list and parameters and the preparation for processing. In this step 560, the batch application determines if the output volume list includes features. If yes, the method 500 proceeds to step 565; otherwise, the method 500 proceeds to step 570. In this step 565, the batch application performs method 600 that is illustrated in FIGS. 6a, 6b, 6c, and 6d. In this step 570, the batch application determines if the output volume list includes patterns. If yes, the method 500 proceeds to step 575; otherwise, the method 500 proceeds to step 580. In this step 575, the batch application performs method 700 that is illustrated in FIGS. 7a, 7b, and 7c. In this step 580, the batch application determines if the user provided a template to define the current job. If yes, the method 500 proceeds to step 585; otherwise, the method 500 proceeds to step 590. In this step 585, the batch application performs method 800, illustrated in FIG. 8. In this step 590, the batch application determines if the queue contains more jobs. If yes, the method 500 proceeds to step 555; otherwise, the method 500 ends.

Fragment Cutting and Feature Attribute and Statistic Computation

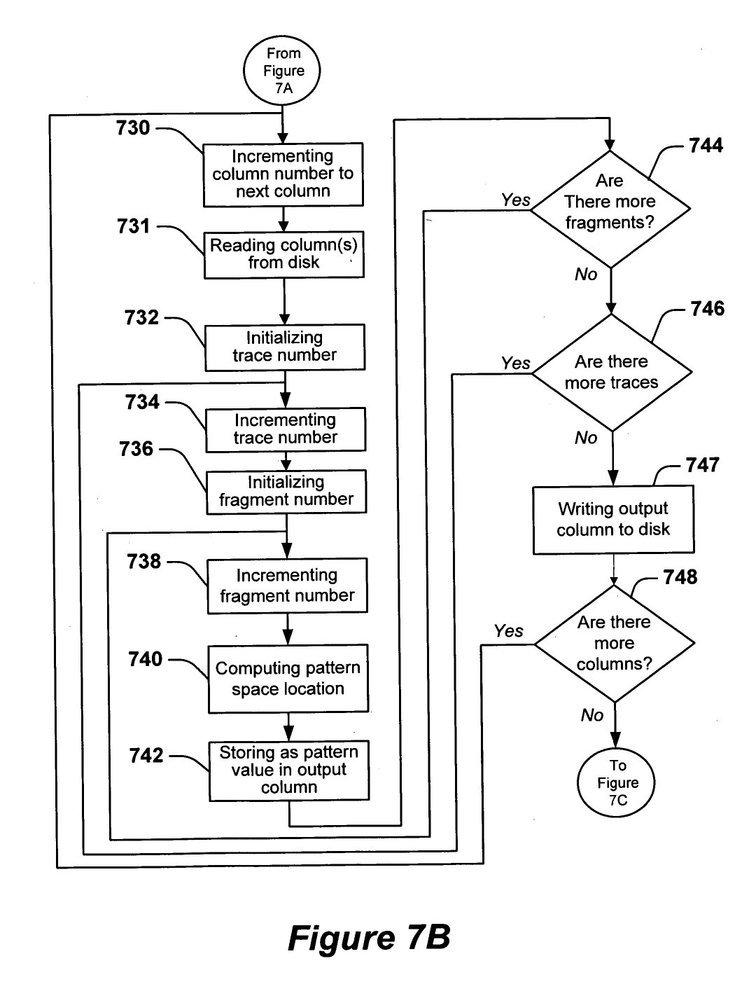

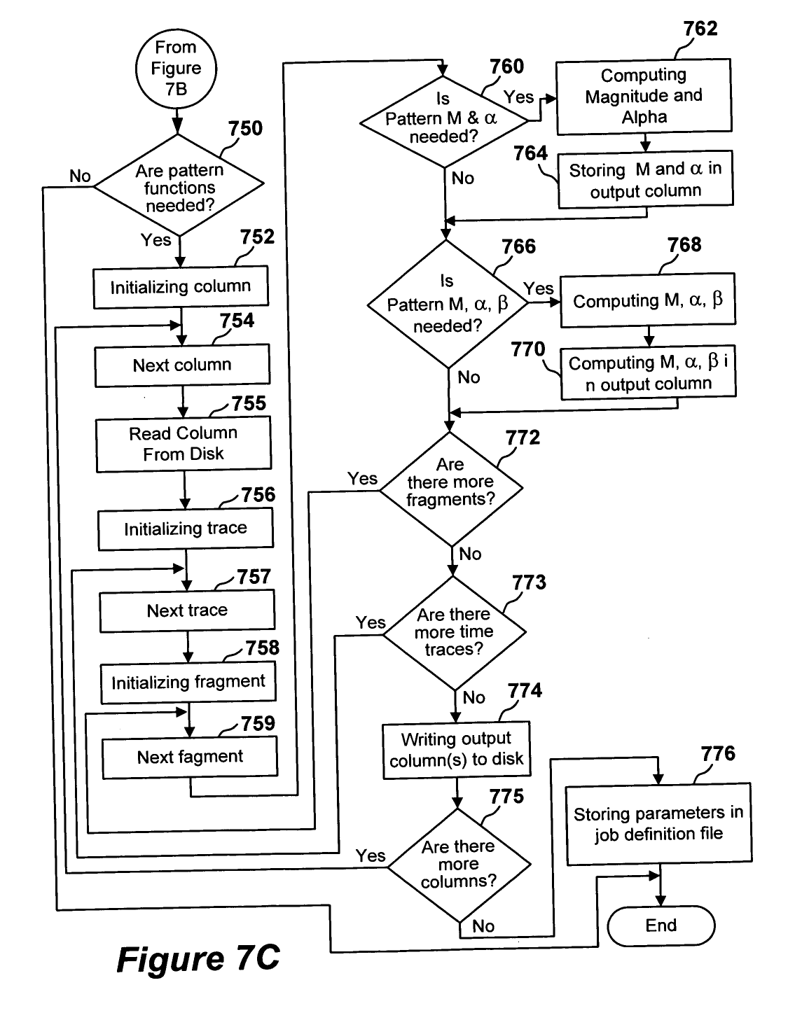

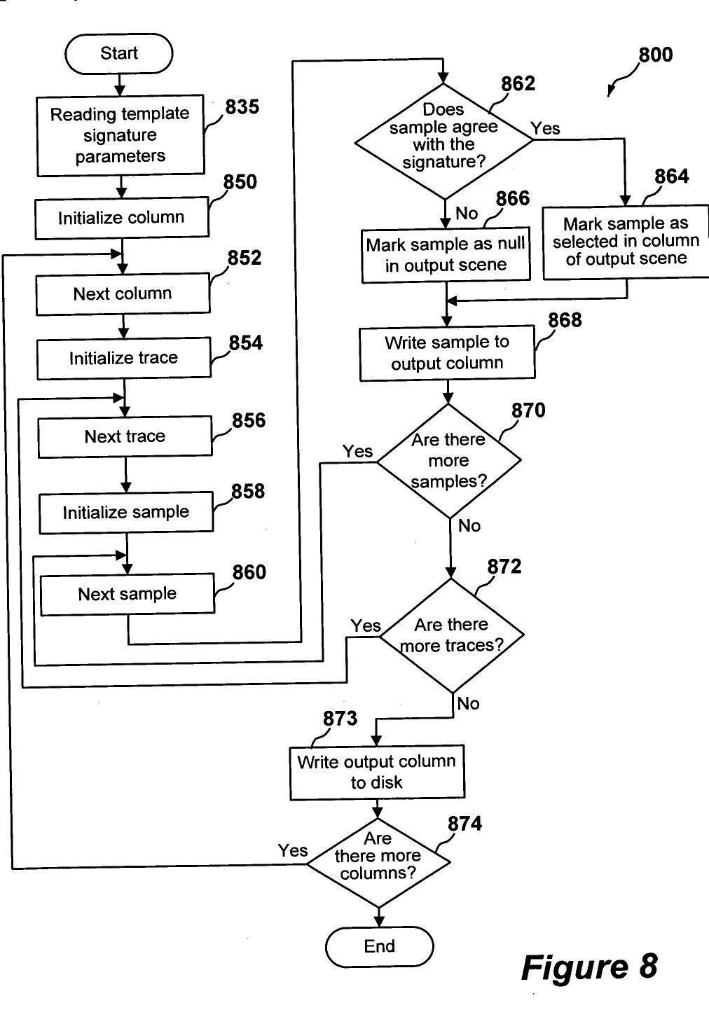

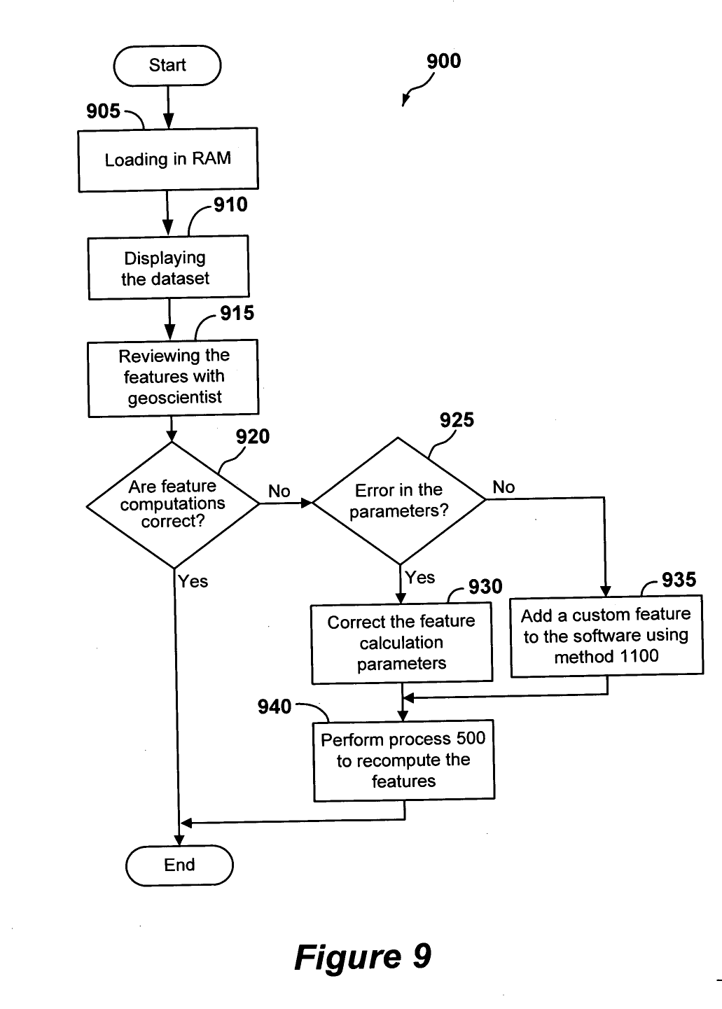

An additional embodiment of the present disclosure is a system for, and method of, selecting fragments and extracting features from the prepared data. FIG. 6a illustrates an example method of identifying selected features and extracting features from the prepared data. Note that this alternate embodiment of the present disclosure is practiced as step 565 of method 500. Further, the present disclosure assumes that a PDB 264 that contains either band-limited or broadband acoustical impedance has been created at some prior point. The input data is broken up into pieces called fragments according to the method of FIG. 6. The pieces have varying lengths in that they do not all contain the same number of samples. The rules for breaking up the data into fragments are called the cutting criteria. The cutting criteria depend upon the specific nature of the data being analyzed. FIG. 12a illustrates the cutting criteria for band limited acoustical impedance where a fragment is the portion between zero crossings 1205 and 1220. FIG. 12b corresponds to broadband acoustical impedance that does not have zero crossings. Here the fragment occurs between peaks of the first derivative 1260 which are at 1262 and 1266.

Features are measurements on the input data. As a collection, features describe the data as fully as necessary to perform the desired data classification. Mathematically, features are represented as a vector state space where each vector represents a state of the image. The axes of the state space represent the degrees of freedom of the problem, in this case, the image features. To represent the data as fully as possible and as efficiently as possible, the state space axes, and thus the features, should span the space and be linearly independent.

For this application, the features have an added requirement. Because features will be visualized along with the data and interpreted as a visual image, they need to represent simple visual properties of the seismic data that are familiar to geoscientists. In step 602, the batch application reads the feature parameters from the job queue. In step 604, the batch application initializes the column pointer so that, when incremented, the column pointer points to the location of the first column on the hard drive 260. In step 606, the batch application increments the column pointer to the location of the next column on the hard drive 260, reads the input column from disk, and places the input column in RAM. In step 607, the batch application identifies the location of the PDB on the hard drive 220 and reads the PDB in one of two ways:
In the first method, the application performs batch processing of a series of pattern recognition operations that are stored in a job queue. The application processes chunks of the data in streams. During streaming, the data is read, transferred to RAM, and processed in individual portions called columns, which are columnar subsets of the data cube, or in individual portions called slabs, which are horizontal slab subsets of the data cube. The data set is divided into subsets called bricks. A stack of bricks that extend from the top of the data set to the bottom is a column. A horizontal swath of bricks that extends across the data set is a slab. The choice of column addressing or slab addressing depends on the type of pattern analysis operation being performed.
In the second method, all of the data in the data cube is processed at once in high-speed memory 230 with the system operator viewing the data interactively on, for example, a high-resolution display 270, with the data being then stored directly to the PDB 264.

Processing the entire data cube in memory all at once allows the system operator to visualize the data cube and modify parameters during processing. Modification of parameters is accomplished to select and tune the parameters on a relatively small subset of the entire data set. Streaming enables brick-by-brick processing of large sets of data that exceed the size of memory. The available high-speed memory 230, and the size of the data cube, dictate which storage method is used.

The following description describes the batch operation with data streaming. However, the same pattern computations can be used for the case where the data is all in memory. All of the steps in method 400 (illustrated in FIGS. 4a to 4c) are represented as if performed by the batch application. In step 608, the batch application initializes the trace pointer so that, when incremented, the trace pointer points to the location of the first trace in the current column on the hard drive 260. In step 610, the batch application increments the trace pointer to the location of the next trace in the current column on the hard drive 260. In step 612, the batch application breaks up the seismic trace into fragments. The specific breaking technique depends on whether the AI was created by steps 458 and 460 or by step 464. For seismic traces created by steps 458 and 460, the application runs through the band-limited AI trace and identifies zero crossings in order to identify each fragment. FIG. 12a illustrates a plot of band limited acoustical impedance 1200 as a function of time or depth, axes 1230 that more clearly defines a fragment 1215, shown as starting at zero crossing 1205 and ending at zero crossing 1220, in this context. For broadband AI created by step 464, the application computes the first derivative of the broadband AI trace and identifies the peaks of the first derivative to identify each fragment as shown in FIG. 12b. To be used as a fragment boundary the peaks must be higher than a threshold 1257, which was specified by the user and stored as a parameter in the queued job. FIG. 12b illustrates a plot of broadband acoustical impedance 1260 as a function of time or depth, axes 1256 that more clearly defines a fragment 1264. The fragment starts at the first derivative peak 1262 and ends at peak 1266 of the first derivative of the broadband AI 1250 in this context. In step 614, the thickness 182 of the band-limited AI is measured by the batch application, relative to the X-axis 160 between the top of fragment 164 and the bottom of fragment 172. For broadband AI, the thickness 182 is measured relative to the X-axes 160 between the top of the fragment 175 and bottom 172. In decision step 616, the application checks a parameter previously selected by the system operator that is stored in the job queue to decide whether or not to append a positive or a negative sign to the thickness measurement. There are several reasons that signed thicknesses are needed, e.g., if the complexity of the data is to be measured in horizontal gates. Complexity is a texture measure that can be used to refine the visual depiction of the seismic data. Restricting the complexity measurements to include only values with the same sign prevents data from geology that is from different rock layers (younger or older) from being included in the calculation when the rock layers dip. Another reason to use signed thickness is for those situations where the seismic data is to be visualized in a way that distinguishes between regions of the seismic data that are acoustically hard relative to its neighbors vertically and regions that are acoustically soft relative to its neighbors vertically. Acoustically soft regions have lower AI values, and acoustically hard regions have higher AI values. Since in some depositional settings and geographical locations hydrocarbon deposits tend to correspond to acoustically soft regions, some geoscientists choose to identify regions that are acoustically soft and mask areas that are acoustically hard. Given an example thickness measurement of 36 milliseconds, the thickness of acoustically hard seismic data is labeled +36, while the thickness of acoustically soft seismic data is labeled −36. If the result of this step 616 is yes, the method 600 proceeds to step 618; otherwise, the method 600 proceeds to step 622. In step 618, the batch application appends the sign to thickness. The AI sign, either positive or negative, is appended to the thickness measurement to indicate if it has relatively hard or soft acoustical impedance when compared to its neighbors vertically. In some geographical areas acoustically softer seismic data corresponds to more porous rock, which is necessary for the accumulation of hydrocarbons. In step 620, the signed thickness is stored in the output column by the batch application. In step 622, the unsigned thickness is stored in the output column by the batch application. In step 630, the batch application checks parameters that were previously selected by the system operator and stored in the job queue to determine whether RMS amplitude or maximum amplitude should be computed. When seismic data contains high amplitude noise spikes, the noise contaminates some of the maximum amplitude measurements so RMS amplitude is used. If the noise spikes were successfully removed during previous data processing steps, the operator can optionally use maximum amplitude. During analysis, the operator might want to compare amplitude measurements to measurements that were made on other data such as well data. To make comparison easier, the operator might wish to use the same measurement, RMS amplitude, or maximum amplitude, as the standard to which the comparison is being made. If the result of this step 630 is yes, the method 600 proceeds to step 632; otherwise, the method 600 proceeds to step 634. In step 632, the square root of the average of the sum of the squares of the amplitudes of all of the amplitude values within the fragment is computed using a standard measurement that is commonly used in the industry, given by the equation:

$${A}_{RMS} = \frac{1}{b - a} {\sum }_{i = a}^{b} {A}_{i}^{2}$$

Where
A_{RMS} is the RMS amplitude of the sample
a is the data sample index for the start of the fragment
b is the data sample index of the end of the fragment
Aᵢ is the ith data sample value

In step 634, the batch application computes the maximum amplitude feature. The maximum amplitude measurement (see FIGS. 12a and 12b) for AI is the same for band limited AI, and broadband AI. For band limited AI, the maximum amplitude 1225 of AI fragment 1210 is measured relative to the zero line of X-axis 1230 by determining the peak of the curve, as illustrated in FIG. 12a. For broadband AI, the maximum amplitude 1254 of the AI fragment 1252 is measured relative to the zero line of the X-axes 1258 by determining the peak of the curve, as illustrated in FIG. 12b.

In step 636, the batch application checks parameters that were previously selected by the system operator and were stored in the job queue in order to determine whether to use the signed maximum amplitude or the unsigned maximum amplitude. The operators' selection was based on the same criteria as used in step 616. If yes, the method 600 proceeds to step 638; otherwise, the method 600 proceeds to step 642. In step 638, the AI sign, either positive or negative, is appended to the maximum amplitude measurement by the batch application to indicate hard or soft acoustical texture, respectively. In some depositional settings, acoustically softer seismic data corresponds to more porous rock, which is necessary for the accumulation of hydrocarbons. In step 640, the signed maximum amplitude is stored in the output column by the batch application. The PDB 264 now contains RFC data, band-limited AI, the signed or the unsigned thickness and the signed maximum amplitude. In step 642, the unsigned maximum amplitude is stored in the output column by the batch application.

In step 644, the curve of AI fragment 162 is determined by the batch application. Although the curve depicted in FIG. 1d is symmetrical, actual seismic data is not always symmetrical but can be top-loaded, bottom-loaded, have multiple curves, or include many other variations in the appearance of the function. The shape of the function is determined using one of several statistical tools, according to the specific parameters of the seismic data. One example of an algorithm used to determine shape is a normalized statistical moment, often the first moment, given by the standard mathematical expressions:

Given:

a=start of the fragment

b=end of the fragment

i=statistical moment arm from 0 to 4
then the statistical moments are given by:

$${M}_{i} = {\int }_{a}^{b} {X}^{i} f ( x ) ⅆ x$$

Breaking the moments out gives:

$${M}_{0} = {\int }_{a}^{b} f ( x ) ⅆ x$$

The first statistical moment (called “shape”) is:

$${M}_{1} = \frac{1}{{M}_{0}} {\int }_{a}^{b} x f ( x ) ⅆ x$$

Variance (the second statistical moment) is:

$${M}_{2} = \frac{1}{{M}_{0}} {\int }_{a}^{b} {x}^{2} f ( x ) ⅆ x$$

Skewness (the third statistical moment) is:

$${M}_{3} = \frac{1}{{M}_{0}} {\int }_{a}^{b} {x}^{3} f ( x ) ⅆ x$$

Kurtosis (the fourth statistical moment) is:

$${M}_{4} = \frac{1}{{M}_{0}} {\int }_{a}^{b} {x}^{4} f ( x ) ⅆ x$$

Notice that the only difference between the three is the length of the moment arm (1, x, x², x³, x⁴) that changes.

In step 646, the batch application checks parameters previously selected by the system operator and stored in the job queue to determine if signed shape will be used. If the signed shape is to be used, it is (i.e., answers “yes” to this question), then the method 600 proceeds to step 668; otherwise, the method 600 proceeds to step 672. In step 648, the AI sign, either positive or negative, is appended to the shape description by the batch application to indicate hard or soft acoustical texture, respectively. Acoustically softer seismic data corresponds to more porous rock, which is necessary for the accumulation of hydrocarbons. In step 650, the signed shape is stored in the output column by the batch application. In step 649, the unsigned shape is stored in the output column by the batch application.

In step 651 (see FIG. 6c), the batch application checks the parameters that were selected previously by the system operator and stored in the job queue to determine whether to compute custom features. If custom features are to be computed (i.e., the answer to the question is ‘yes’), then the method 600 proceeds to step 652; otherwise, the method 600 proceeds to step 661 (see FIG. 6d). In step 652, the batch application executes the proper functions in a library, such as a dynamically linked library (“DLL”), to compute the custom feature. In step 653, the batch application checks parameters that were selected previously by the system operator and stored in the job queue to decide whether to use a signed custom feature. Generally, the operator's selection would have been based on the same criteria as used in step 330. If the operator decides to use a signed custom feature (i.e., the answer to the question is ‘yes’), then the method 600 proceeds to step 654; otherwise, the method 600 proceeds to step 656 (see FIG. 6c). In step 654, the AI sign, either positive or negative, is appended to the shape description by the batch application to indicate specific custom feature attributes in a similar way that AI sign differences are used to indicate hard or soft rock properties. In step 655, the signed custom feature is stored in the output column by the batch application. In step 656, the unsigned custom feature is stored in the output column by the batch application. In step 657, the batch application determines if there are more custom features to be computed. If there are more custom features to be computed, then method 600 proceeds to step 652; otherwise, the method 600 proceeds to step 658. In step 658, the batch application determines if there are more traces to be processed. If there are more traces to be processed, then method 600 proceeds to step 610; otherwise, the method 600 proceeds to step 659. In step 659, the output columns that were created in steps 620, 622, 642, 640, 652, 650, 656 and 655 are written to disk by the batch application. Writing to disk in a column-by-column fashion improves application performance by reducing disk write times. In step 660, the application determines if there are more columns to be processed. If there are more columns to be processed, then the method 600 proceeds to step 606; otherwise, the method 600 proceeds to step 660.

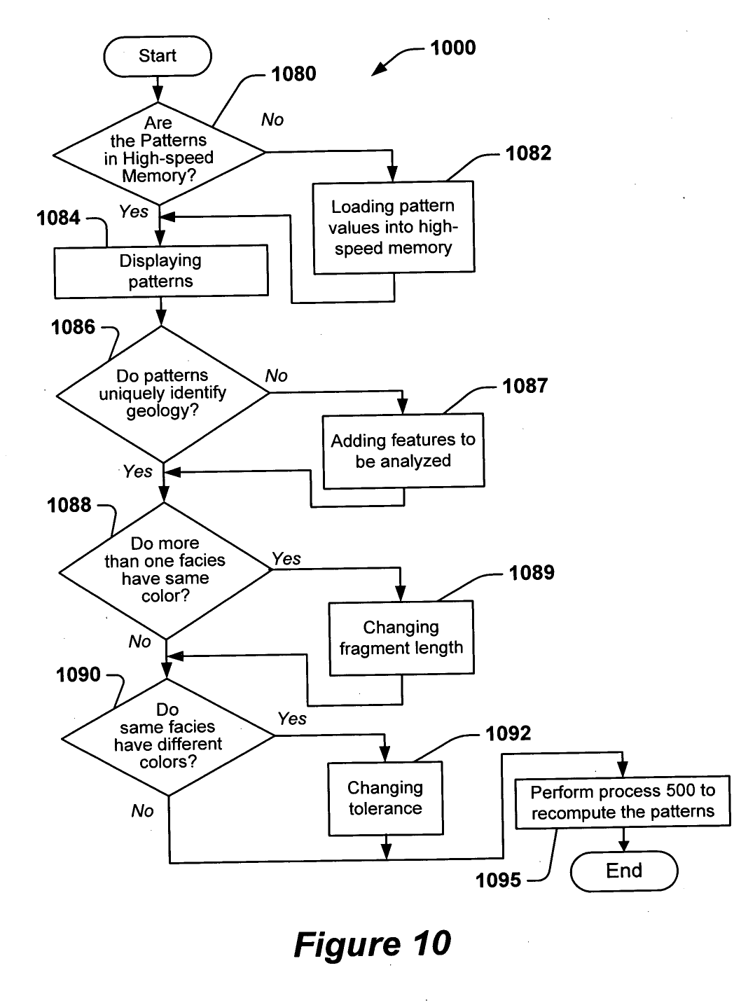

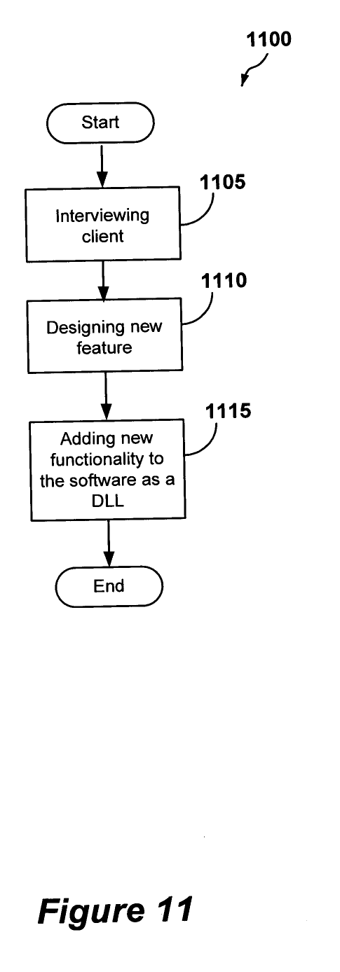

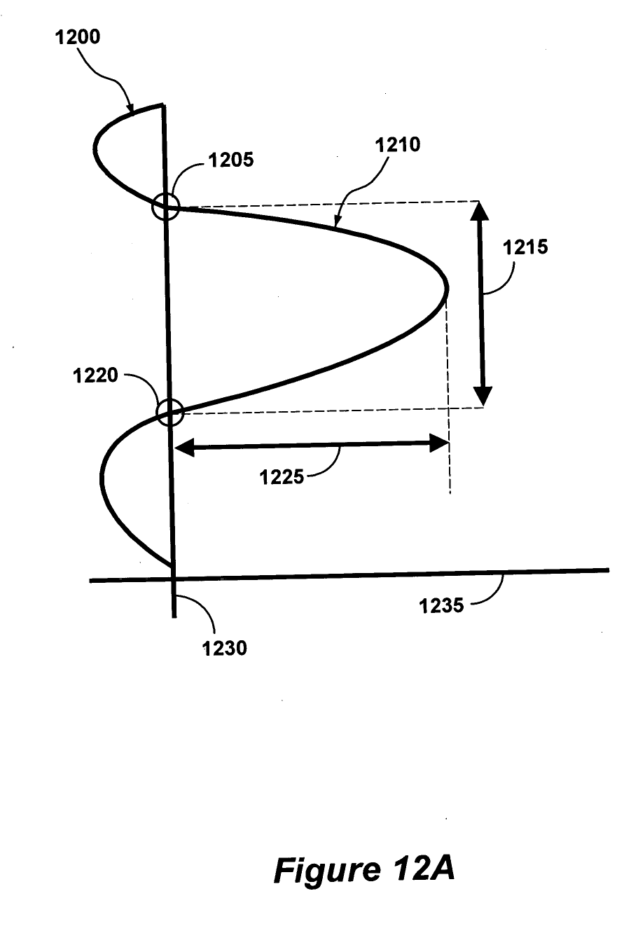

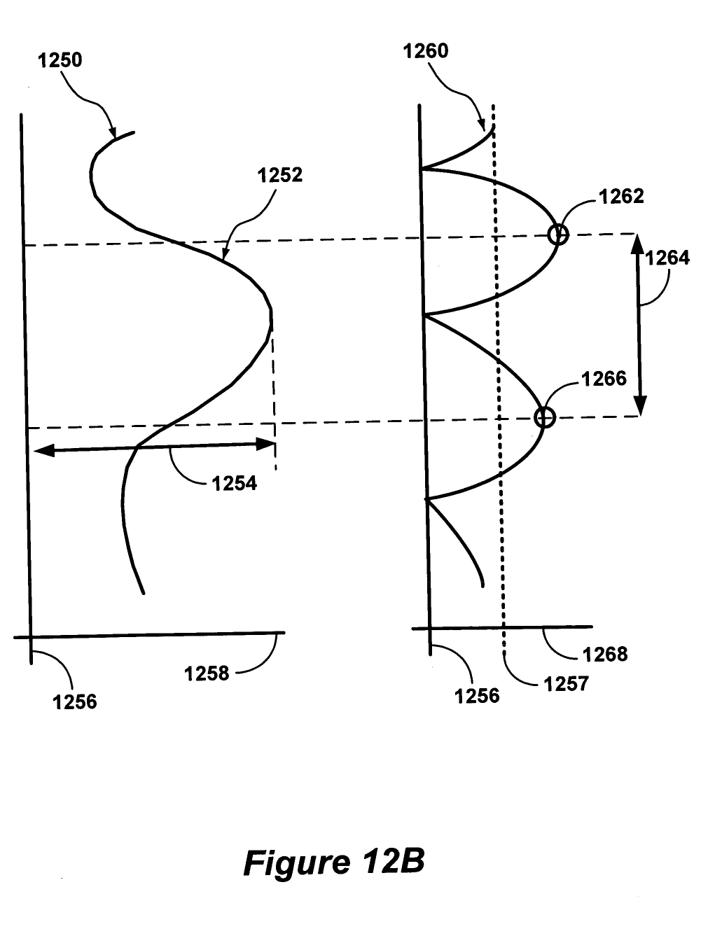

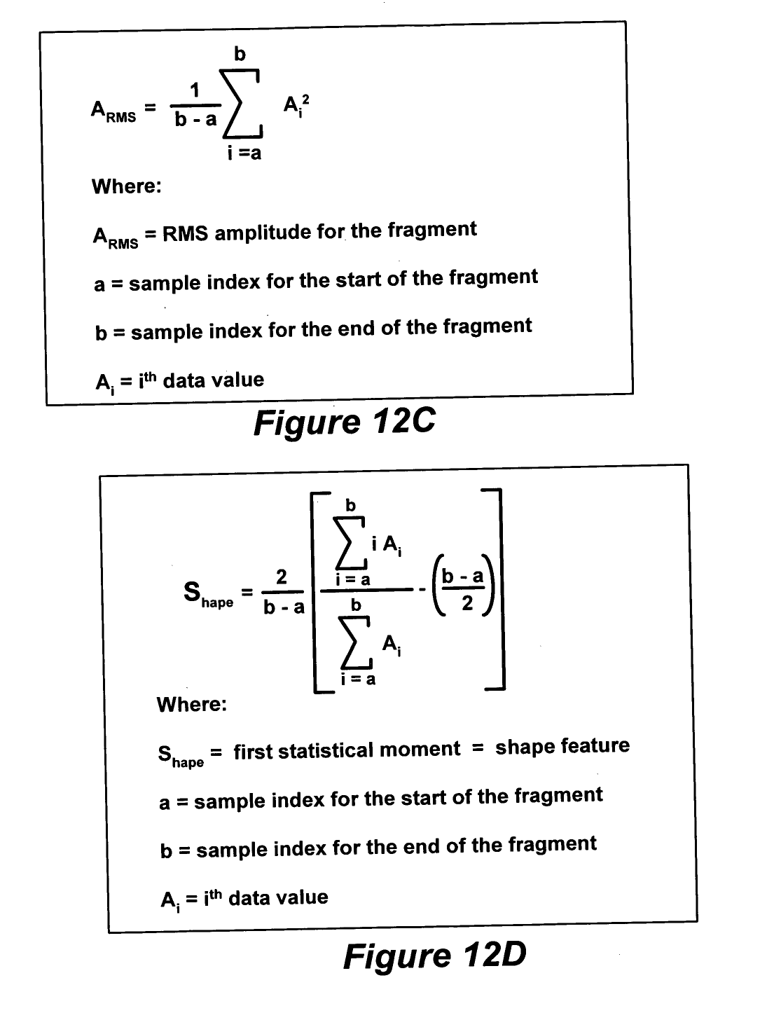

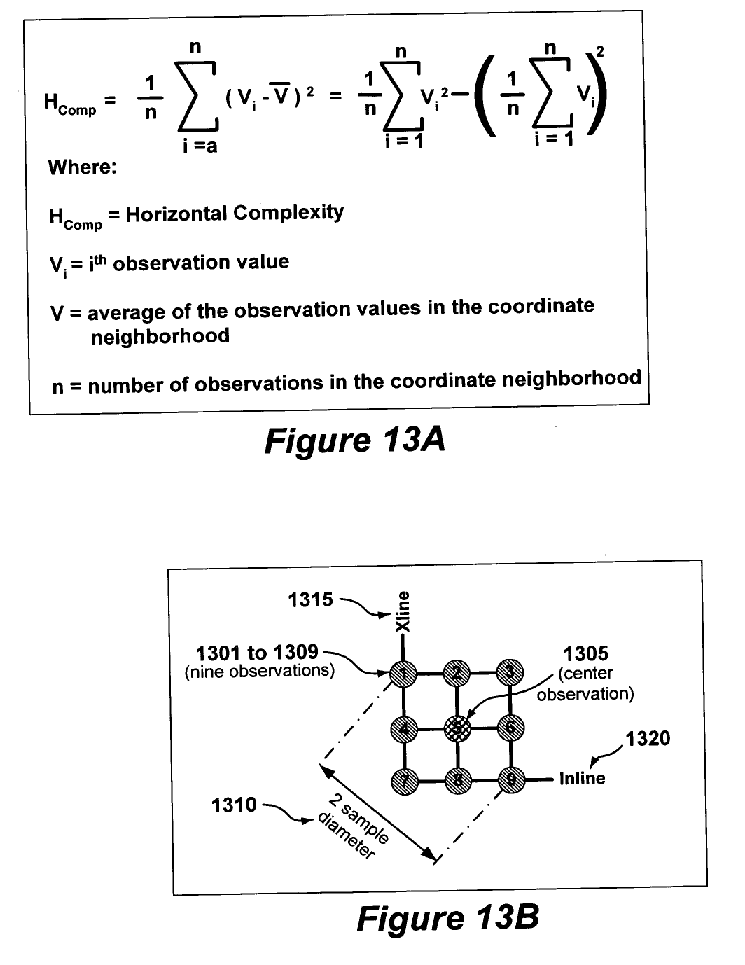

In step 660 (see FIG. 6d), the batch application checks parameters that were selected previously by the system operator and stored in the job queue to determine if feature statistics are needed to solve the problem. Generally, the operator's decision would have been based on the types of patterns and textures in the data, the quality of solution that is required, and the amount of time available. Some problems do not require a rigorous pattern analysis but can be solved by estimating some pattern and texture properties using feature statistics. The benefit is that the amount of time and amount of computer power required computing the feature statistics is less than to that required to do a full pattern analysis. If the operator instructed the batch application to use feature statistics (i.e., answers “yes” to step 660), then method 600 proceeds to step 662; otherwise, the method 600 ends. In step 662, the batch application initializes the slab pointer so that, when incremented, the slab pointer identifies the location of the first slab on the hard drive 260. In step 664, the batch application increments the slab pointer to the location of the next slab on the hard drive 260 and copies the input data slab into RAM. In step 666, the batch application initializes the time slice pointer so that, when incremented, the time slice pointer points to the location of the first time slice in the current slab on the hard drive 260. In step 667, the batch application increments the time slice pointer to the location of the next time slice in the current slab on the hard drive 260. In step 668, the batch application initializes the sample pointer so that, when incremented, the sample pointer points to the location of the first sample in the current time slice on the hard drive 260. In step 669, the batch application increments the sample pointer to the location of the next sample in the current time slices on the hard drive 260. In step 670, the batch application checks parameters that were selected previously by the system operator and stored in the job queue to determine if horizontal complexity is needed to solve the problem. If the operator instructed the batch application to compute horizontal complexity functions (i.e., the answer to this step is yes), then the method 600 proceeds to step 672; otherwise, the method 600 proceeds to step 676. In step 672, the batch application computes the horizontal complexity value at the current sample. Horizontal complexity is computed by evaluating the equation shown in FIG. 13a. In step 674, the horizontal complexity is stored in the output slab by the batch application. The PDB 264 now contains RFC data, band-limited AI, the signed or the unsigned thickness, the signed or the unsigned maximum amplitude, signed or unsigned shape, and horizontal complexity. In step 676, the batch application checks parameters that were selected previously by the system operator and stored in the job queue to determine if feature or feature function anisotropy is needed to solve the problem. If the operator instructed the batch application to compute feature or feature function anisotropy (i.e., the answer to this step is yes), then the method 600 proceeds to step 678; otherwise, the method 600 proceeds to step 681. In step 678, the batch application computes the feature or feature function anisotropy value at the current sample. Feature or feature function anisotropy (“FFA”) is computed using the expression given in FIG. 14d. In step 680, the feature or the feature function anisotropy is stored in the output slab by the batch application. In step 681, the batch application determines if there are more samples to be processed. If there are more samples to be processed, then the method 600 proceeds to step 669; otherwise, the method 600 proceeds to step 682. In step 682, the batch application determines if there are more time slices to be processed. If there are more time slices to be processed, then the method 600 proceeds to step 667; otherwise, the method 600 proceeds to step 683. In step 683, the output slab(s) created in steps 674, and 680 are written to disk by the batch application. Writing to disk in a slab-by-slab fashion improves application performance by reducing disk write times. In step 684, the batch application determines if there are more slabs to be processed. If there are more slabs to be processed, then the method 600 proceeds to step 664; otherwise the method 600 proceeds to step 686. In step 686, the parameters that could be used to recreate the features and feature statistics, which have been identified in the above steps, are stored in a job definition file in the PDB folder on hard drive 260 by the batch application.

Pattern Attribute and Statistic Calculation

An additional embodiment of the present disclosure is a system for and method of generating pattern attributes from feature attributes in a pattern abstraction database. An example of a method for accomplishing this is to do it by computing for each voxel in physical space the pattern space location into which the data associated with the voxel would transform if it were transformed into pattern space. This is equivalent to a fiber view. The pattern space is assigned pattern attribute, usually cluster or bin numbers, which are assigned to the appropriate voxel in physical space.

Pattern space is represented mathematically as a vector state space representing the patterns formed by the features associated with neighboring fragments measured from the data set. The vector space has one axis for each feature being analyzed. The features may be multiple features at the same spatial location, the same feature from neighboring locations, or a combination of both. The pattern is labeled by its location in the pattern space that is given by the values of the associated features that make up the pattern.

The entire pattern space is then visualized in order to facilitate the analysis of the underlying geology from which the geological features were extracted, and thereby determine the location of, for example, hydrocarbon deposits.

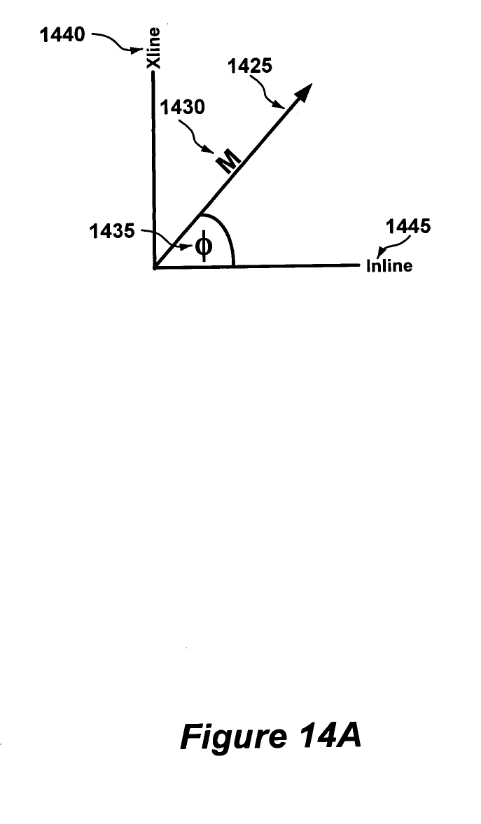

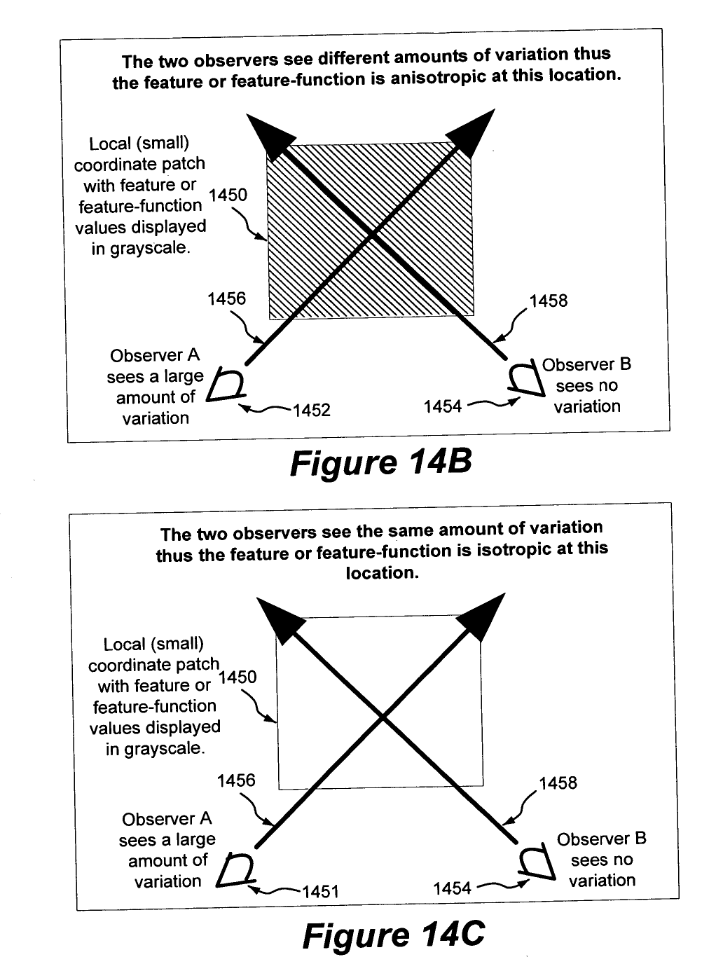

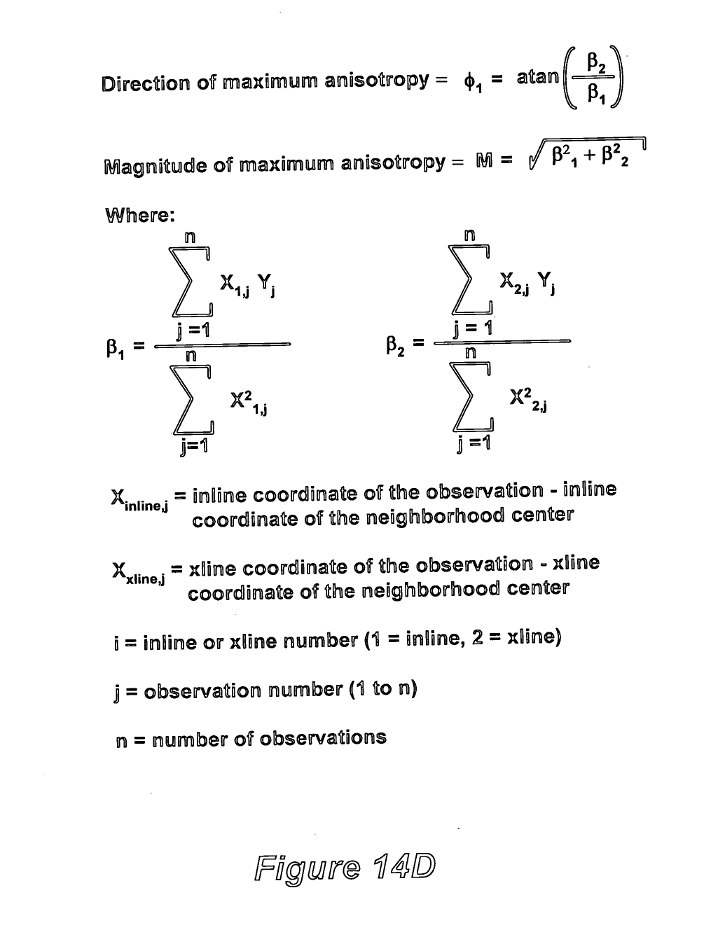

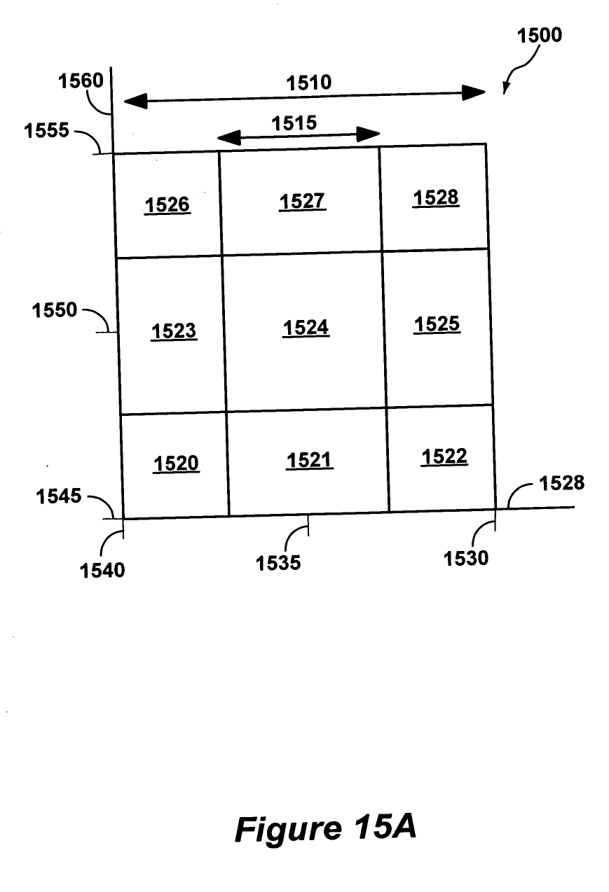

FIGS. 7a, 7b, and 7c illustrate a method of generating patterns from features in a pattern abstraction database as described herein. Note that this alternate embodiment of the present disclosure is practiced after completing the method described in FIGS. 6a, 6b, 6c, and 6d. Further, the present disclosure assumes that a PDB 264 that contains the extracted features for the geology of interest has been created at some prior point. Referring to FIG. 7, in step 710, the batch application reads the list of features to be analyzed from the job in the processing queue. The geoscientist generates the list of features to be analyzed. These geological features were chosen to measure geological aspects that are pertinent to analyzing the geoscientist's play concept. In step 715, the batch application reads the fragment length to be analyzed from the job in the processing queue. The fragment length to be analyzed was selected by the geoscientist. The fragment length is chosen to measure a geological pattern which is pertinent to analyzing the geoscientist's play concept. In step 720, the batch application reads the bin tolerance from the job in the processing queue. The geoscientist selects the bin-tolerance by changing the ratio of the length of the central bins (see FIG. 15a) as represented by central bin length 1515, to the length of pattern space 1500, as represented by pattern space length 1510, until the different cases of information for pattern space analysis are sufficiently segregated into the appropriate bins. More common combinations fall into the central bin and anomalous, less common, combinations fall into the outer bins. The different combinations are separated out depending on which bins they fall into and can be assigned different display and geological properties.

There is a concept called a “fiber view” that is created to go with pattern space 1500. The entire data set is transformed into the pattern space and put into bins, as represented by bins (see FIG. 15a). The bins are numbered and then the bin numbers are transformed back to physical space and placed in a data cube in their physical space locations. The numbers that have been transformed back to physical space is what topologists call a fiber view of transform space.

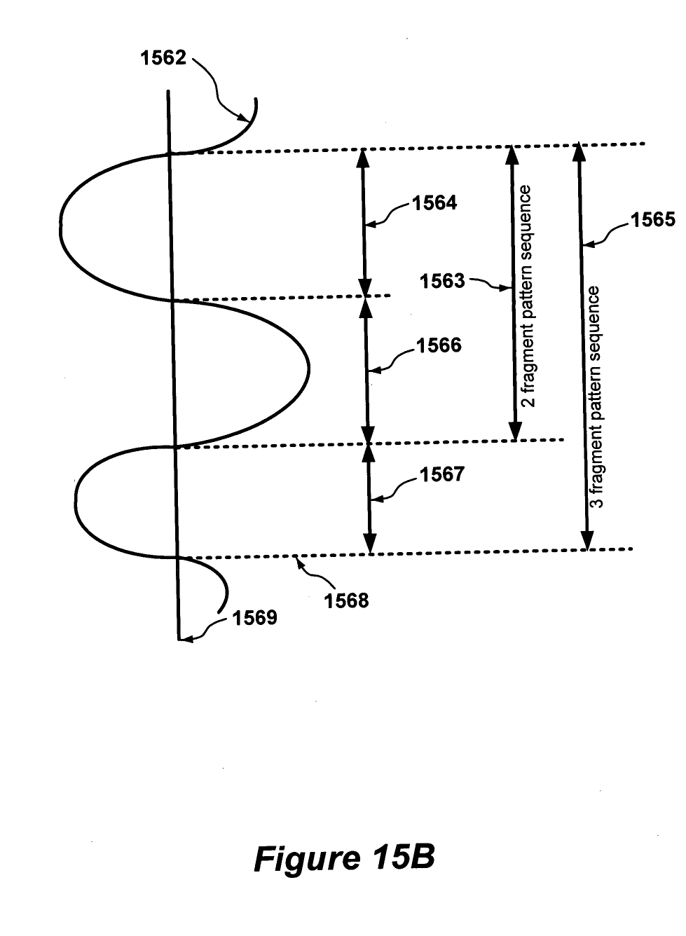

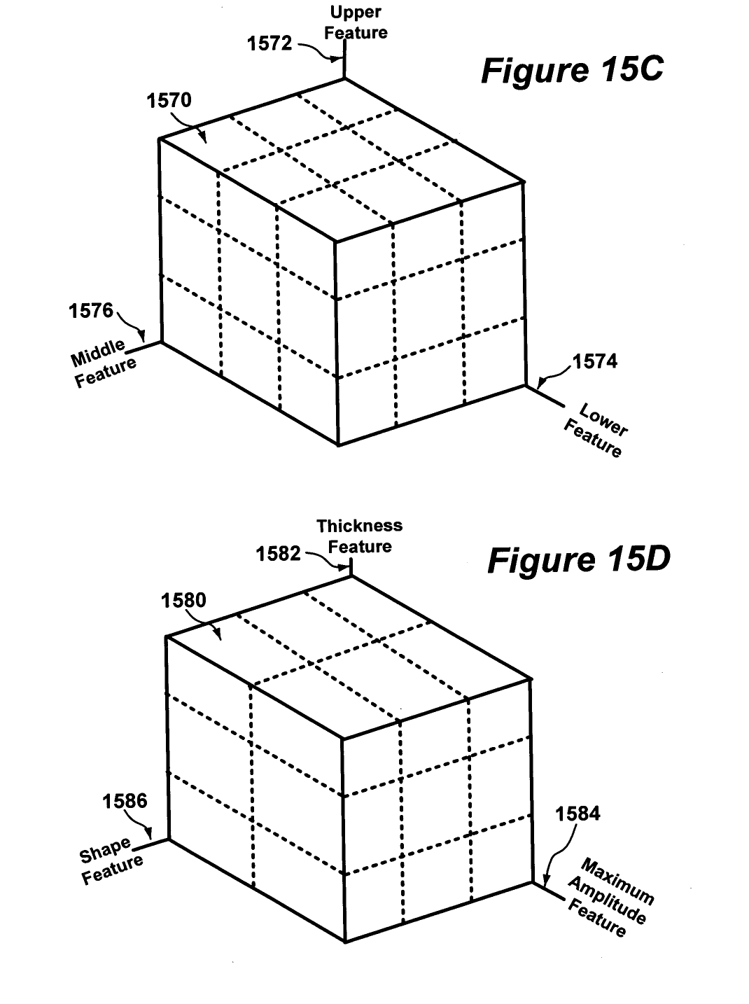

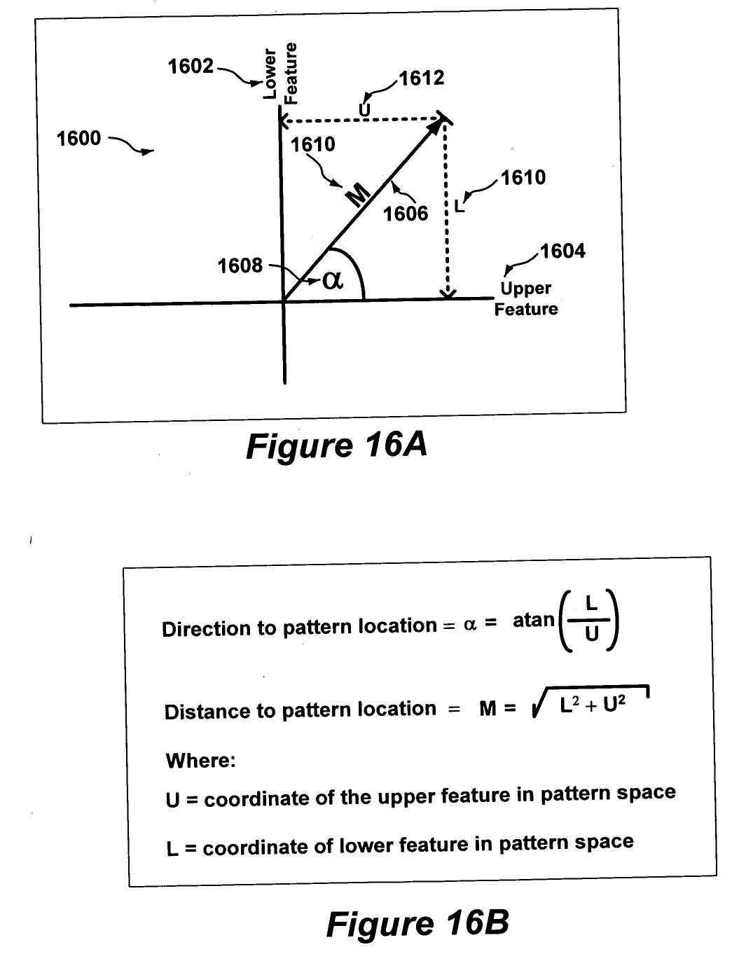

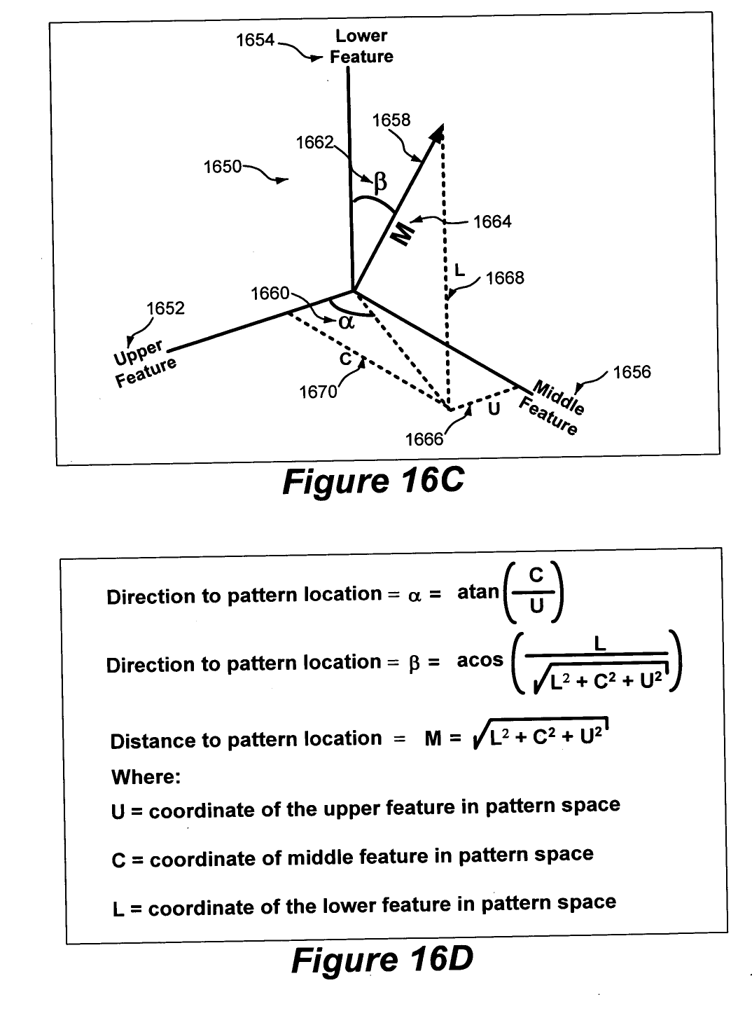

In step 725, the batch application initializes the pointer for a column, which is a vertical column of voxels, so that when incremented it points to the location of the first column on the hard drive 260. Step 725 is the beginning of the process that will assign pattern values (also referred to as bin values) to every fragment within the data cube. In step 730, the batch application increments the column pointer to the location of the next column on the hard drive 260 and reads the input column from disk, placing it in RAM. In step 731, the batch application reads the input feature column(s) from the hard drive 260, placing it in RAM. In step 732, the batch application initializes the pointer for a trace so that, when incremented, it points to the location of the first trace in the current column on the hard drive 260. In step 734, the batch application increments the trace pointer to the location of the next trace in the current column on the hard drive 260. In step 736, the batch application initializes the pointer for a fragment so that, when incremented, it points to the location of the first fragment in the current trace on the hard drive 260. In step 738, the next fragment in the first column is identified by the batch application. In step 740, the pattern space location, i.e., the bin, is computed for every fragment in every column by the batch application. In this step, the pattern space location from step 740 is stored as a pattern value by the batch application. The pattern value corresponds to the bin number, wherein bins 1301 to 1309 have pattern values of 0 to 8 (see FIG. 15a). This process is accomplished for every fragment in each column in the data cube. In this decision step 744, the batch application determines if there are more fragments to be assigned a pattern value. If yes, the method 700 returns to step 738; otherwise, the method 700 proceeds to step 746. In this decision step 746, the batch application determines if there are more traces to be processed. If yes, the method 700 returns to step 734; otherwise, the method 700 proceeds to step 748. In step 747, the batch application writes the output column created in steps 742 to disk. Writing to disk in a column-by-column fashion improves application performance by reducing disk write times. In this decision step 748, the batch application determines if there are more columns to be processed. If yes, the method 700 returns to step 730; otherwise, the method 700 proceeds to step 750. In this decision step, the system operator and geoscientist determine if pattern statistics are needed. If the pattern statistics are needed, the method 700 continues to step 752; otherwise, the method 700 ends. In step 752, the batch application initializes the pointer for a column, which is a vertical column of voxels, so that, when incremented, the pointer points to the location of the first column on the hard drive 260. Step 752 is the beginning of the process that will assign pattern values (also referred to as bin values) to every fragment within the data cube. In step 754, the batch application increments the column pointer to the location of the next column on the hard drive 260. In step 755, the batch application reads the input column from disk places it in RAM. In step 756, the batch application initializes the pointer for a trace so that, when incremented, the pointer points to the location of the first trace in the current column on the hard drive 260. In step 757, the batch application increments the trace pointer to the location of the next trace in the current column on the hard drive 260. In step 758, the batch application initializes the pointer for a fragment so that, when incremented, the pointer points to the location of the first fragment in the current trace on the hard drive 260. In step 759, the next fragment in the current trace is identified. In this decision step 760, the system operator and/or geoscientist determine if pattern magnitude and alpha is needed. The pattern magnitude and alpha give the location of the specific pattern in pattern space using cylindrical coordinates. If the pattern magnitude and alpha is needed, the method magnitude and alpha 700 continues to step 762; otherwise, the method 700 continues to step 766. This method assigns unique locations to each pattern rather than classifying them. When the results are visualized, the data is classified by assigning the same color to patterns that are assigned to the same class. In step 762, the batch application computes magnitude and alpha by performing the mathematical computation shown in FIGS. 16a and 16b. In step 764, magnitude and alpha from step 762 are placed in output columns. In this decision step 766, the system operator and geoscientist determine if pattern magnitude, alpha and beta is needed. If magnitude, alpha and beta pattern is needed, then the method 700 continues to step 768; otherwise, the method 700 continues to step 772. In step 768, the batch application computes magnitude, alpha, and beta by performing the mathematical computation shown in FIGS. 16c and 16d. In step 770, magnitude, alpha and beta from step 762 are placed in output columns. In this decision step 772, the batch application determines if there are more fragments to be assigned a pattern value. If there are more fragments to be assigned a pattern value, then the method 700 returns to step 759; otherwise, the method 700 proceeds to step 773. In this decision step 773, the system determines if there are more traces to be processed. If more traces are to be processed, then the method 700 returns to step 757; otherwise, the method 700 proceeds to step 774. In decision step 775, the system determines if there are more columns to be processed. If more columns are to be processed, then the method 700 returns to step 754; otherwise, the method 700 proceeds to step 776. In step 776, the parameters of the pattern statistics, which have been identified in the above steps, are stored in a job definition file in the PDB on hard drive 260.

Data Mining Using a Template

An additional embodiment of the present disclosure is a system for and method of performing data mining using a previously created template.

FIG. 8 illustrates an example method of performing data mining using a previously created template. Note that this alternate embodiment of the present disclosure is practiced after completing the methods described in FIGS. 3 to 9, plus determination of the pattern signature of the target geology that is performed in another application. Further, this additional embodiment of the present disclosure assumes that a PDB 264 that contains either band limited or broadband acoustical impedance has been created at some prior point. Referring to FIG. 8, in step 805, the application reads the PDB construction commands from the template. In step 835, the batch application reads the pattern signature information from the template. In step 850, the batch application initializes the column pointer so that, when incremented, the column pointer points to the location of the first column in the input volume on the hard drive 260. In step 852, the batch application increments the column pointer to the location of the next column on the hard drive 260 and places the input data in RAM. In step 854, the batch application initializes the trace pointer so that, when incremented, the trace pointer points to the location of the first trace in the current column on the hard drive 260. In step 856, the batch application increments the trace pointer to the location of the next trace in the current column on the hard drive 260. In this step, the batch application initializes the sample pointer so that when incremented it points to the location of the first sample in the current trace on the hard drive 260. In step 860, the batch application increments the sample pointer to the location of the next sample in the current trace on the hard drive 260. In step 862, the application compares the signature feature, feature function, and pattern function value ranges to the sample values. The ranges represent a tolerance within which the features, feature statistics, and pattern statistics need to match. It also compares the signature pattern to the sample pattern to determine if they match. If sample matches the template signature, then process 800 proceeds to step 864; otherwise, the process 800 proceeds to step 866. In step 864, the sample is selected in an output scene. A scene is an index volume each sample is capable of having a value of 0 to 255. The values 0 to 254 represent objects to which the sample can be assigned. The number 255 indicates that the sample is not assigned to an object or is null. This step assigns the number 0, or the meaning of being included in the object with index number 0, to the sample in the output scene. In step 866, the sample is marked for an output scene, e.g. assigns the number 255, or the meaning of null, to the sample in the output scene. In step 868, the scene created in step 864 or 866 is stored in the same way as described in step 420. The PDB 264 now contains the input acoustical impedance, the feature attributes, feature statistics, pattern attributes, pattern statistics, texture attributes, and texture statistics computed in steps 820 to 830 and the scene computed in step 864 or 866. In step 870, the application determines if there are more samples in the current trace to be processed. If there are more samples, then process 800 proceeds to step 860; otherwise, the method 800 proceeds to step 872. In step 872, the application determines if there are more traces in the current column to be processed. If there are more traces, then the method 800 proceeds to step 856; otherwise, the method 800 proceeds to step 873, where (optionally) the output column is written to persistent storage, and the method continues at step 874. In step 874, the application determines if there are more columns in the input data volume to be processed. If there are more columns, then the method 800 proceeds to step 852; otherwise, the batch application cleans up and terminates and the method 800 ends.

Quality Control Analysis of Feature Attributes

An additional embodiment of the present disclosure is a system for and method of performing quality control of features computed by method 500.

FIG. 9 illustrates an example method of performing quality control of features. Note that this alternate embodiment of the present disclosure is practiced after completing the method 500 described in FIGS. 5a and 5b. Referring to FIG. 9, when method 500 is performed using a batch application as shown in FIGS. 5a and 5b, then all of the data is on disk but not in RAM when the batch job is completed. In this case when the geoscientist and/or system operator starts an interactive visualization application, it moves the data or a selected subset of the data to RAM in step 905. If the steps were performed in an interactive visualization application that contains the pattern analysis tools application, then all of the data is already in RAM and this step is skipped. If the data were not put into high-speed memory 90 before this point, the data are now in order to fully visualize the data set. In step 910, the geoscientist displays the data set. The visualization is accomplished with suitable software on the apparatus of the present disclosure. In step 915, the visualized seismic data set from step 910 is reviewed by the geo-scientist in order to determine if the specifications for the project have been met. In this decision step 920, the geoscientist determines whether the feature definition has been adequately determined according to the geo-scientific specifications. If the geology of interest is clearly identified at the feature level to the geo-scientist's satisfaction, the method ends. If the geology of interest has not been adequately identified according to the geo-scientific specifications, the method proceeds to step 925. In this decision step 925, the geoscientist and/or system operator review the feature computation parameters and determine if they were correct. If the parameters were correct, then the method 900 proceeds to step 930; otherwise, the parameters were not correct, and the method 900 proceeds to step 935. In step 930, the system operator corrects the feature calculation parameters, and the execution of the method continues to step 940. In step 935, the system operator requests a custom feature from the programmer and sub-method 1100 are executed. In step 940, the system operator executes the pattern analysis computer application that performs sub-method 500 to compute the custom features.

Quality Control Analysis of Pattern Attributes

An additional embodiment of the present disclosure is a system for and method of performing quality control of patterns computed by method 1000.

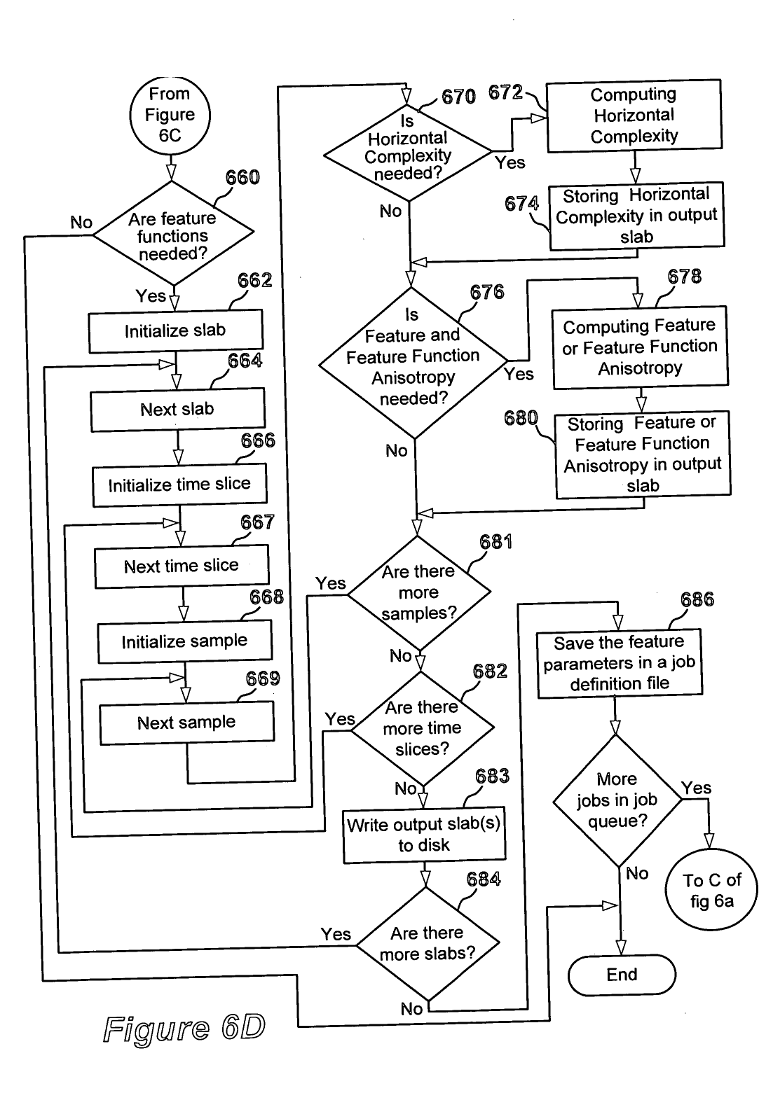

FIG. 10 illustrates an example method of performing quality control of patterns. Note that this alternate embodiment of the present disclosure is practiced after completing the method 500, described in FIG. 5. In this decision step 1080, the system determines if the pattern values were stored in high-speed memory 230 during the execution of sub-method 500. When sub-method 500 is performed using a batch application, then all of the data is on disk but not in RAM when the job is completed. If the steps were performed in an interactive visualization application that contains the pattern analysis tools application, then all of the data is already in RAM and this step 1080 is skipped. If the pattern values are in high-speed memory, the method 1000 proceeds to step 1084; otherwise, the pattern values were stored in the PDB 264 on hard drive 260, and the method 1000 proceeds to step 1082. In step 1082, pattern values are loaded into high-speed memory 230 using suitable visualization software. In step 1084, the pattern space is displayed on high-resolution display 270 using suitable visualization software. In this decision step 1086, the system operator and/or the geoscientist who are preferably looking at the patterns displayed on high-resolution 270, determine if the patterns uniquely identify the geology of interest established in step 330. If the result of step 1086 is yes (positive), then the method 1000 proceeds to step 1088; otherwise, the method 1000 proceeds to step 1087. In this decision step 1088, the system operator and the geoscientist determine if more than one facies, which is an observable attribute of rocks, has been identified with the same color. If two or more facies have the same color, then the method 1000 proceeds to step 1089; otherwise, the method 1000 proceeds to step 1090. In this decision step 1090, the system operator and the geoscientist determine if different instances of the same facies have been identified with different colors. If the same facies have different colors, then the method 1000 proceeds to step 1092; otherwise, the method 1000 proceeds to step 1095. In step 1095, the parameters of the pattern space, which have been identified in the above steps, are stored as a template in a template library 268 on hard drive 260. In step 1092, the system operator adds new features to the pattern space to identify geologic areas of interest more distinctly from each other. In step 1089, the system operator changes the fragment length to better isolate the facies of interest. In step 1092, the system operator changes the tolerance in order to widen the bin and allow different instances of a single facies to be identified with one color.

Method of Adding Cutting, Attribute, or Statistic Algorithms to the Pattern Data Base Building Application

An additional embodiment of the present disclosure is a system for and method of adding additional functionality such as additional cutting algorithms, feature attributes, feature statistics, pattern attributes, pattern statistics, texture attributes, and texture statistics to the pattern database building software. An example method is shown in FIG. 11.

Note that this alternate embodiment of the present disclosure is practiced as a part of method 1100 described in FIG. 11, however, this alternate embodiment can also be practiced independently during the routine maintenance and addition of functionality of the software of the present disclosure. In step 1105, the system operator interviews the geo-scientist to determine the parameters of the custom feature or new functionality that is required to adequately define the geology of interest. Although, at the feature scale, most geology of interest is often adequately defined by the standard set of features embodied by thickness, amplitude and shape, for complex problems, a custom feature can be defined. The feature is determined by asking the geo-scientists to describe what visual aspect of the data he is interested in and how does the aspect change as the rock composition of the rock layer in the subsurface changes when moving along the layer. As an example, the geophysicist might say the acoustical impedance in the fragment has two peaks in one location that change to one peak in another location along the layer as the types of rocks change. In this case, a feature of peak count might be added in step 1110.

Similarly, new cutting algorithms, feature attributes, feature statistics, pattern attributes, pattern statistics, texture attributes, and texture statistics might be needed to solve the geological problem. The present disclosure facilitates satisfaction of the need to add features and functions. In step 1115, definitions are developed for the custom features or other functionality needed according to geo-scientist specifications from step 1105. These definitions are used to modify the source code in the pattern abstraction software program that embodies and implements the methods of the present disclosure. These modifications are implemented using standard practices and commercially available object-oriented analysis and design language, such as that from the Object Management Group (“OMG”), which uses the Unified Modeling Language (“UML”) diagramming methodology. The modification is constructed as source code for an application plug-in. The plug-in is compiled to create a static or dynamically linked library (“DLL”) that is placed in the software directory containing the application. When executed, the application recognizes and executes the plug-in according to standard software techniques. It should be noted that while it is preferred to utilize object-oriented programming techniques, non-object oriented implementations may also be used to generate the software and/or hardware needed to implement the methods of the present disclosure. Moreover, virtually any programming language may be used to implement the methods the present disclosure.

Although the method described in FIGS. 3-11 were discussed with respect to seismic data, it is also applicable to other types of geophysical and geological data. Moreover, the method illustrated in FIGS. 3-11 may be applied to other problems, such as well log analysis or rock, electrical, magnetic, and gravitational property analysis.

FIG. 12a illustrates a plot of band limited acoustical impedance 1200 as a function of time or depth that is typical of seismic data. FIG. 12a includes a band limited AI fragment 1210 having a top of fragment 1205, a thickness 1215, a bottom of fragment 1220, a Y-axis 1235, an X-axis 1230, and maximum amplitude 1225.

FIG. 12b illustrates a plot of broadband acoustical impedance 1250 as a function of time or depth that is typical of seismic data on the left and its first derivative 1260 on the right. FIG. 12b includes a broadband AI fragment 1252 having a top of fragment 1262, a thickness 1264, a bottom of fragment 1266, an X-axis 1256, a acoustical impedance function Y-axis 1258, a first derivative Y-axis 1268, and max amplitude 1254. The top of fragment 1262 and bottom of fragment 1266 are also peaks of the first derivative 560.

Fragments are a function of acoustical impedance related to time or depth. The seismic data is frequently measured as a function of the two way travel time of the sound (down to the reflector and back up), although the data can be converted to a measurement of depth, which is the preferred measurement for seismic data analysis. Either time or depth measurement can be used in all of the seismic data processing, but because it is costly to convert the seismic data to depth, data is frequently acquired and processed in terms of time.

The length of each fragment is measured in a different manner for band limited AI and broadband AI. For band limited AI, it is the distance between zero crossings, as shown by top of fragment 1205 and bottom of fragment 1220 in AI fragment 1210 that is a portion of the band limited AI function 1200. Thickness 1215 is measured along X-axis 1230, and is the distance between top of fragment 1205 and bottom of fragment 1220, in time or depth. Top of fragment 1205 is the zero crossing at the minimum depth or initial time. Bottom of fragment 1220 is the zero crossing at the maximum depth or maximum time. Max amplitude 1225 is the top point of the function of band limited AI 1200 within fragment 1210 as measured on Y-axis 1235. The band limited AI fragment 1210 represents a portion of one trace in one column of information in a data cube. Fragments may be determined by zero crossings, non-zero crossings, or a mix of zero and non-zero crossings (meaning one end of the fragment is at a zero crossing and the opposite end is at a non-zero crossing).

For broadband AI 1250 in FIG. 12b, the length of a fragment is determined from the first derivative of the broadband AI function 1260. It is the distance between peaks of the first derivative, as shown by top of fragment 1262 and bottom of fragment 1266 in first derivative 1260 of the broadband AI fragment 1252 that is a portion of the broadband AI function 1250. Thickness 1264 is measured along X-axis 1256, and is the distance between top of fragment 1262 and bottom of fragment 1266, in time or depth. Top of fragment 1262 is the first derivative peak at the minimum depth or initial time. The bottom of fragment 1266 is the first derivative peak at the maximum depth or maximum time. The Maximum (“Max”) amplitude 1254 is the top point of the function of broadband AI 1250 within fragment 1252 as measured on Y-axis 1258. The broadband AI fragment 1252 represents a portion of one trace in one column of information in a data cube.

FIG. 13a provides the mathematical expression for calculating horizontal complexity. FIG. 13a includes definitions of the terms in the expression. The complexity value is computed for the central observation in a coordinate neighborhood as shown in FIG. 13b. The number of observations in the coordinate neighborhood is determined by the diameter of the coordinate neighborhood. In the example illustrated in FIG. 13b, the diameter is 2 and the number of samples is 9. This equation is implemented as a method of one or more than one software objects in the computer software portion of the implementation of the present disclosure.

FIG. 13b shows the coordinate neighborhood for observation #5 1305. The coordinate neighborhood has an Xline axes 1315 and an Inline axes 1320. The neighborhood has a diameter of 2 samples 1310. It contains 9 observations #1 to #9 shown as dots 1301 to 1309. Larger diameters may be used thereby increasing the number of samples in the coordinate neighborhood.

FIGS. 14a, 14b, 14c, and 14d define feature and feature function anisotropy. FIG. 14a shows the magnitude “M” and angle φ for feature and feature function anisotropy. FIG. 14a consists of a coordinate patch that contains observations as defined in FIG. 13b and has an Xline axis 1440 and a Inline axes 1445. A vector 1425 that is defined by its magnitude M and angle φ gives the direction of maximum complexity. FIG. 14b gives an example of feature and feature function anisotropy where a local variation occurs. It includes a coordinate patch 1450 as seen by observer “A” 1452 looking along the vector 1456 and observer “B” 1454 looking along vector 1458. The observations vary from white to black as shown. Observer A sees a significant variation from one corner of the coordinate patch to the other. Observer B sees no variation. Because the variation seen by the two observers are different, the coordinate patch is anisotropic. The vector of maximum anisotropy is 1456 in this example. FIG. 14c shows another coordinate patch 1450. In this example, the observers see the same amount of variation, thus the coordinate patch is isotropic. FIG. 14d gives the mathematical expression for the magnitude “M” and angle φ of anisotropy as shown in FIG. 14b. These equations are implemented as a method of one software object, or multiple software objects in the computer software portion of the implementation of the present disclosure.

FIGS. 16a and 16b define the M and α pattern space measures. FIG. 16a shows a two dimensional pattern space 1600 created by a 2-feature analysis with an upper feature and a lower feature. The space has two axes, one for the lower feature 1602 and one for the upper feature 1604. The pattern that is created by the two features is plotted as pattern space at the location designated by the upper feature value U 1612 and lower feature value L 1610. A vector 1606 extends from the origin to the plotted pattern location. The vector is defined by its magnitude M 1610 and direction given by the angle α 1608. FIG. 16b gives geometric expression for computing M and α as functions of L 1610 and U 1612. These equations are implemented as a method of one or more than one software objects in the computer software portion of the implementation of the present disclosure.

FIGS. 16c and 16d extend the concept to three dimensions giving M, α, and β pattern space measures. FIG. 16c shows a three-dimensional pattern space 1650 created by a three-feature analysis with an upper feature, a middle feature, and a lower feature. The space has three axes, one for the lower feature 1654, one for the middle feature 1656, and one for the upper feature 1652. The pattern created by the two features are plotted in pattern space at the location designated by the upper feature value U 1666, the middle feature value C 1670, and the lower feature value L 1668. A vector 1658 extends from the origin to the plotted pattern location. The vector 1658 is defined by its magnitude M 1664 and direction given by the two angles α 1660 and β 1662. FIG. 16d gives geometric expressions for computing M, α, and β as functions of L 1668, C 1670, and U 1666. These equations are implemented as a method of one or more than one software objects in the computer software portion of the implementation of the present disclosure.

FIG. 15a illustrates a diagram of pattern space 1500 for the shape feature for a fragment length of two, including pattern space length 1510, central bin length 1515, bins 1520 to 1528, fragment #2 axis 1528. The fragment #2 axis 1528 extends from a top loaded shape 1530 through a symmetric shape 1535 to a bottom loaded shape 1540. The fragment #1 axis 1560 extends from top loaded shape 1555 through symmetric shape 1550 to bottom loaded shape 1545.

Pattern space 1500 shows eight separate bins, represented by bins 1520 to 1528, that are used to organize feature fragment sequences (for example, shape) as shown in Figure 15a. Each bin corresponds to the relationship between two fragments 1564 and 1566, of a two-fragment pattern sequence 1563 as defined in FIG. 15b. Each fragment has an associated feature value as described above. Fragments vary in length, and the range of feature values measures the total length of pattern space 1500. This pattern space diagram is for categorizing the shape feature, although all other types of features may be used. FIG. 15b shows symmetric fragments, but the seismic data can also be distributed in a top-loaded or bottom-loaded manner. These three different distributions are indicated as bottom 1330, symmetric 1335, and top 1340 along horizontal axis 1325, and as top 1345, symmetric 1350, and bottom 1355 along vertical axis 1360.

Fragment sequences are considered as they are analyzed, in this example, with respect to their shape. Since the fragment length is two, two fragment sequences must be categorized. If both the first and second fragments are bottom-loaded, the fragment sequence falls into bin 1528. Similarly, each of the other bins is filled with a particular fragment sequence. The bin tolerance is defined as the ratio of the central bin length 1515 to the pattern space length 1510. The tolerance determines how the bin sizes vary. The less common values are on the outside of FIG. 15a. These outer, less common, bins represent anomalies that have a high correlation to the successful location and exploitation of hydrocarbon deposits. The length of the two fragment sequences illustrated in FIG. 15a is two, making the figure two-dimensional. When there are lengths of three fragment pattern sequences 1565 present, as shown in FIG. 15b, the illustration is three-dimensional, as shown in FIG. 15b, with a lower feature axes 1574, middle feature axes 1576, and upper feature axes 1572. Lengths greater than three are used, but they make illustration impossible.

In a similar fashion, FIG. 15a only considers the feature of shape. Every additional feature adds a dimension to the pattern space as shown in FIG. 15c. The maximum amplitude 1584 and thickness features 1582 have a single threshold line, rather than two for shape 1586. Any combination of the features described herein can be used.

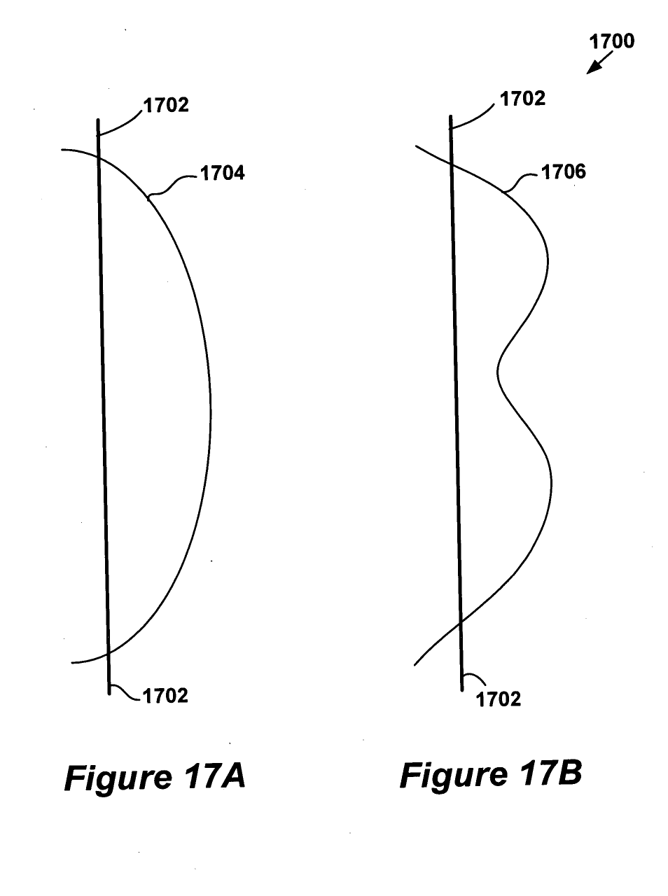

In another embodiment, an additional feature can be added, namely “string length.” The string length is another mechanism for providing additional discrimination of seismic waveform character in addition to (or in lieu of) other shape features. FIGS. 17a and 17b illustrates two waveforms 1700 that can represent seismic data. Each waveform is measured about an axis 1702. Waveform 1704 of FIG. 17a is a simple symmetric waveform. Waveform 1706 of FIG. 17b is also symmetric, but has two distinct local maximums. Using previous analysis, both waveforms 1704 and 1706 would be considered symmetric. However, the additional oscillations of waveform 1706 may convey some useful geologic information. Identifying and describing such oscillations may be useful in interpreting the geologic formation. To distinguish between the two waveforms 1704 and 1706, a distinction is made between the symmetric and simple waveform 1704 and the symmetric and complex waveform 1706.

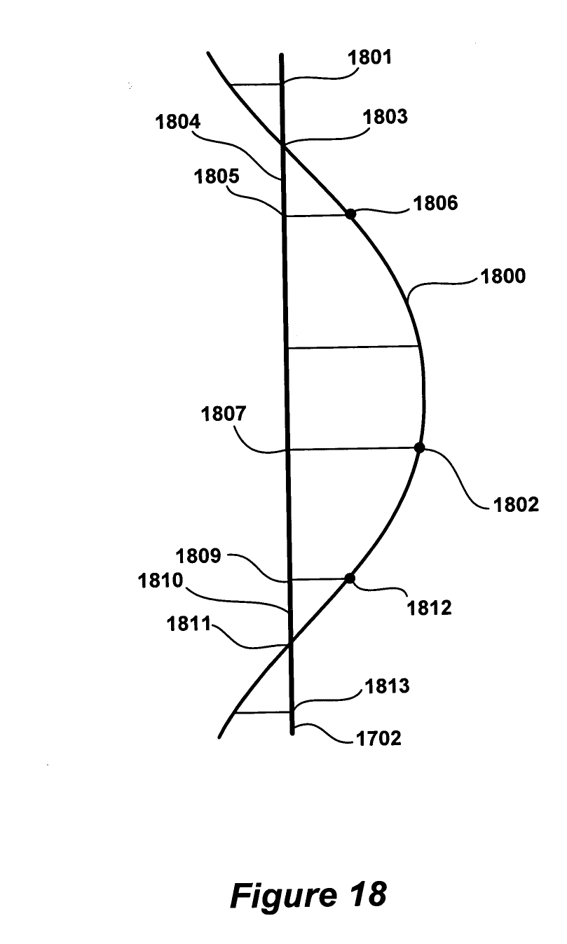

In one embodiment of the disclosure, the shape of the waveform is used indicate whether a fragment is symmetric, bottom-loaded or top-loaded. String length is typically the arc length, i.e., the length of the seismic trace between two points over a fragment, with the length of the fragment being defined by crossing the reference axis at two inflection points. Referring to FIG. 18, the arc 1800 crosses the reference axis 1702 at beginning inflection point 1803 and end inflection point 1811. At various points (defined by index value “i”) are amplitudes Aᵢ, such as the point 1802 at position 1807 on the reference axis 1702. The amplitude A is a measure of the distance between the reference axis 1702 and the arc 1800 at point “i”, where i is the sample number of the input trace. Typically, seismic traces are represented digitally by a series of numbers (the amplitudes) which are taken at even increments of time, such as 2 or 4 milliseconds, although other time increments are of course possible. The thickness of the fragment is defined as the distance along the reference axis 1702 between the beginning inflection point 1803 and the end inflection point 1811. Two other values are useful to determine the thickness. Specifically, a padstart length 1804 is the distance between the beginning inflection point 1803 and point 1805. Similarly, a padend length 1810 is equivalent to the distance between the end inflection point 1811 and point 1809 as illustrated in FIG. 18. Between the padstart 1804 and padend 1810 are n subsegments (having width i). Thus the thickness can be calculated as:
Thickness=padstart+padend+n

The length of the padstart 1804 along the reference axis 1702 is defined as:
padstart=A_{FS}/(A_{FS}−A_{FS-1})

The length of the padend 1810 along the reference axis 1702 is defined as:
padend=A_{FE}/(A_{FE}−A_{FE+1})

When determining the string length (“SL”), the string length for the two partial segments nearest the zero crossings (padstart 1804 and padend 1810) are used along with the sample interval (“DIGI”) which is typically measured in a unit of time, such as seconds. The sample index of the first sample in the fragment (“FS”) has amplitude A_{FS} 1806, and the sample index of the last sample in the fragment (“FE”) has amplitude A_{FE} 1812. Both amplitudes AFS 1806 and A_{FE} 1812 are used to calculate the string length. Specifically:
SL=((A_{FS}²+(padstart*DIGI)²)^{0.5})+((A_{FE}²+(padend*DIGI)²)^{0.5})

For each fragment, one loops through the sample values for each fragment. In pseudocode, we could write:

For K=FS to FE
If K<FE, then SL=SL+{(A_{K+1})−A_{K})²)+(DIGI²)}^{0.5}

Next K

At the end of the loop, the lengths of all of the segments of the fragments have been accumulated. In one embodiment of the invention, the string length is always positive at this point. Alternate embodiments of the invention may have the string length as always negative at this point.

The absolute string length is equivalent to SL above. In some embodiments, it may be useful to remove the contribution of thickness in the string length to generate the value SL_{L}, which may be calculated by the following equation:
SL_{L}=SL−Thickness
In other embodiments, it may be useful to use a signed string length SL_{S}, which is calculated by multiplying the string length by the fragment's sign.
SL_{S}=Sgn(A₀)*SL
Because fragments are defined by zero-crossings, each value A₀ within a fragment has the same sign, so any fragment A₀ may be used to determine the fragment's sign.

In yet another embodiment, the string length ratio is used. To calculate the string length, a reference string length (SL_{ref}). For data types with zero crossings, the reference string length for each fragment is determined by:
SL_{ref}=2*{Aₘₐₓ²+DIGI²)^{0.5}}
where Aₘₐₓ is the maximum amplitude for the fragment in question. Incidentally, because the maximum amplitude is squared, it may be the absolute Aₘₐₓ, or the signed Aₘₐₓ. In one embodiment, SL_{ref} will always be positive. However, alternate embodiments may have SL_{ref} always be negative.

Two other values may be useful to the exploration of hydrocarbons, namely absolute string length ration (SL_{AB}) and signed string length ration (SL_{S}). Where:
SL_{AB}=SL/SL_{ref}
and
SL_{S}=Sgn(A₀)*SL_{AB}

While the string length may be viewed as a straightforward calculation, string length is particularly meaningful when compared to something else. For example, comparing string length with other measurements referenced above, particularly in conjunction with vertical patterns and horizontal measures. Moreover, useful information can be obtained by comparing the string length result to a reference string length for a given fragment to generate a string length ratio. The reference quantity is calculated differently for input data that has zero crossings (such as RFC or RAI data) and input data that have no zero crossings, such as broadband inversions. For each of the characterizations, a “plug-in” may be created for use with software that is used for the PDB. For example, three different plug-ins may be implemented for string length, string length ratio for zero crossing data, and string length ration for non-zero crossing data. Alternatively, a single plug-in could be used to calculate two or more of the above-identified string characteristics for output as a pattern database (PDB). A user could be given the option of selecting one or more of the string length characterizations for his/her input data type.

The functionality for string length, string length ratio, zero crossing data, and/or string length ratio for non-zero crossing data may be implemented directly into a software application, or as a plug-in, or directly in hardware, such as the system illustrated in FIG. 2. Moreover, the software instructions may be placed permanently on a persistent storage medium, such as a compact disk (CD), which may be read by a computer system, such as the one illustrated in FIG. 2. In alternate embodiments, a single plug-in may have two or more of the aforementioned outputs for the pattern database, such as string length and the appropriate string length ratio. The operator could have the option of selecting the appropriate string length ratio for the input data type, or the desired characteristics sought. Those skilled in the art will perceive other implementations when they are given the benefit of this disclosure.

Alternate Cutting Criteria

The method, previously presented in this disclosure, for cutting a seismic volume into fragments is based on having an input volume that has zero crossing across a reference axis. While the previously identified cutting method has great utility in general, there are types of input volumes that lend themselves cutting into fragments that do not have zero crossings. Example input volumes suitable for non-zero crossing cutting include broad band inversion and/or amplitude envelope. This section sets out several alternative cutting methods for use with input data that don't have zero crossings.

In particular, it is desirable to have the capability of applying the cuts on the reference volume itself (which may or may not have zero crossings) or to apply those cuts to another volume (which may or may not have zero crossings). For example, the operator may wish to derive cuts from an amplitude envelope volume and apply those cuts to the RFC seismic. In this example, the fragment (defined from the amplitude envelope) would have more than one loop per fragment on the fragmented RFC output. This would mean that some of the features viewable by the operator may not make sense or produce error causing output. This potentially troubling aspect will be dealt with below. For the meantime, we will consider the cutting criteria that the operator might like to implement.

Sample-to-Sample Relationships

Perhaps the simplest and the most useful cutting criteria are based on sample-to-sample differences. In pseudo code, the cutting rule would be of the form;
If [Sample(N)−Sample(N−1)]>Threshold, then cut (1)
There are several variations on the above equation. One is for Threshold to refer to a PERCENT Difference.
If ([Sample(N)−Sample(N−1)]/[Sample(N)+Sample(N−1)]/2}>Threshold, then cut (2)

Another would be for Threshold to refer to the actual difference as in equation (1) above. Using a percent change technique relieves the user from having to know the actual sample values and thus may be easier to use. However, providing a histogram of either the sample-to-sample percentage change or the sample-to-sample actual differences may help the user to pick a suitable parameter for the problem in question. For example, a 5% threshold may work well on Broadband Impedance cases. Such a “rule of thumb” may be much harder to establish using the actual difference.

In an alternate embodiment, the user may wish to cut only on positive, or only on negative or on absolute difference, or on percent difference. The above set of alternates results in 6 potential cutting rules for data without zero crossings, all based on the concept of sample-to-sample difference.

Local Extrema

Another family of cutting criteria that can be employed is to cut at the local minimum or the local maximum. The user would have to supply a window length L over which to look for the local minimum or the local maximum. The cutting rule could be written several ways, for example:
If Sample(N)=MINIMUM [Sample(N−L/2) to Sample(N+L/2)], then cut (3)
Where L would have to be an even number, in the example illustrated above. It will be apparent to those skilled in the art who have access to this disclosure that alternate formulations are possible. For example, to cut the fragment on the local maximum could, in pseudocode, be written as:
If Sample(N)=MAXIMUM [Sample(N−L/2) to Sample(N+L/2)], then cut (4)
The above set of six criteria, plus their individual variations as outlined above, would allow the operator to cut several types of seismic attribute volumes in a novel fashion.

Features and Patterns

As mentioned above, cutting the data in the way described immediately above, and particularly if those cuts are applied to a different volume, could cause problems with some of the features. For example, if the cutting process results in a fragment that has multiple loops, Shape will not have the meaning to which the users were accustomed. String Length Ratio also would be less useful but String Length itself could be quite useful. Thickness would still be useful and would have the same meaning—the thickness of the fragment. However, the fragment are determined by compensating criteria, so the amplitude features and patterns should be acceptable.

In another embodiment, a different approach is taken. The new cutting criteria is implemented, but the user will have be aware of what type of volume s/he is cutting and what type of volume s/he is applying those cuts to. The user would have to choose the features and the patterns appropriately. The user can utilize the flexibility presented herein to good effect, but may pare down the flexibility, depending upon the problem in question.

In the alternate embodiments described above, new features and patterns may need to be generated or revised. In the case of cutting an RFC volume using a broadband impedance, the user would have fragments with multiple loops. New features (or quantities of interest) may include the range of amplitude in the fragment (Largest Positive minus Largest Negative), the number of positive loops, the number of negative loops and so on. Other variations will be apparent to those skilled in the art with the aid of this disclosure.

Another embodiment uses subfragmentation. In one case, the user computes a fragment using percent difference threshold on a broadband inversion, applies those cuts to RFC or some other volume with zero crossings, and hence the multiple loops in the fragment. Then, within that fragment, the user performs subfragmentation based on zero crossings and then report the distribution of the traditional features based on the subfragments as a “feature” or quantity of interest for the overall fragment.

Calculations for Horizontal Complexity (“HComp”)

What are needed are horizontal continuous pattern HComp statistic calculations (see FIG. 13a) on a PDB that was previously flattened using a horizon and where horizontal continuous pattern attribute(s) have already been computed. The goal is to capture statistics on the way in which the horizontal continuous pattern attributes vary in the inline and xline directions.

Input

A pattern database containing at least band-limited AI and one or more horizontal continuous pattern attributes where the PDB was previously flattened. In the case where the PDB contains more than one horizontal pattern attributes, the user selects the one to be used from a list of previously computed horizontal continuous pattern attributes.

Output

The outputs are inline and xline pattern statistics that are appended to the input pattern pyramid by storing them in the inline and xline sides of the pattern pyramid as inline and xline pattern statistics. When inline pattern attributes are entered, the output is inline pattern statistics. When xline pattern attributes are input, the output is xline pattern attributes.

The output horizontal pattern statistic is standard deviations or horizontal complexity as defined below.

Horizontal Complexity Computations

Horizontal complexity is a normalized measurement of lateral variances. It is currently computed in the vertical direction by the expression illustrated in FIG. 13a.

The input data for the HComp determination are the user-selected horizontal attribute that were calculated previously. The coordinate neighborhood has a user-defined diameter and is defined in the diagram of FIG. 13b.

The implementation is the same as the current HComp implementation (see FIG. 13a), with the exception that the input are horizontal attributes. As a default the method of this embodiment should ignore observations where the AI in the PDB has a different sign in comparison to the central observation. The user should be able to optionally disable leave the observations with a sign flip in the calculation.

Feature and Feature Function Anistotropy (“FFA”) Statistical Analysis

In some cases, horizontal feature and feature function anisotropy (“FFA”) statistic calculations are desirable on a PDB that may have been flattened earlier using a horizon measurement, and where the one or more horizontal feature attribute(s) have already been computed. The goal in this embodiment is to capture statistics describing the way in which the horizontal feature attribute(s) vary in the inline and xline directions. They should be mathematically as similar to the vertical statistic calculations as possible.

Input

A pattern database containing at least band-limited AI, and one or more horizontal feature attributes where the PDB was previously flattened. In the case where the PDB contains more than one horizontal feature attribute, the user selects the one to be used from a list of previously computed horizontal feature attributes.

Output

The outputs are inline and xline feature statistics that are appended to the input pattern pyramid by storing them in the inline and xline sides of the pattern pyramid as inline and xline feature statistics. When inline feature attributes are entered, the output is inline feature statistics. When xline feature attributes are input, the output is xline feature statistics. The output horizontal feature statistic is FFA as described below.

Feature & Feature Function Anisotropy

Feature and Feature Function Anisotropy is defined as illustrated in FIGS. 14b and 14c. Feature and Feature Function Anisotropy should be computed using the same algorithm as is currently applied to vertical features but with the change that the observations, given below by the Y values, are now horizontal feature attribute values rather than vertical feature attribute values. The algorithms currently in use are given by the expressions illustrated in FIG. 14d. The coordinate system in which the magnitude (M) and angle (φ) results are given is defined in FIG. 14a.

It may be preferable that, as a default for the operator, the method should ignore observations where the AI in the PDB has a different sign in comparison to the central observation. The user should be able to optionally disable this feature to leave the observations with a sign flip in the calculation.

Horizontal Pattern Attribute Method

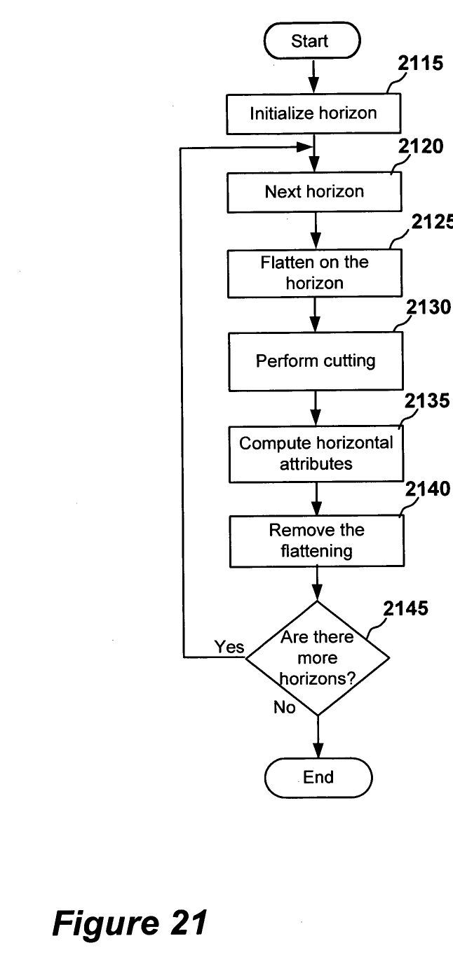

In another embodiment, it is desirable to obtain pattern attribute calculations on a PDB in directions other than vertically. The goal is to capture the way in which the vertical pattern attributes and hyperdimensional fragment vary as one follows rock layers along structural dip and strike. Because seismic surveys are aligned approximately along dip and strike at the depth of interest when acquired, it is sometimes possible to estimate the attributes by computing them along inlines and xlines. One example of the method is to use previously created horizons to flatten the data where vertical continuous pattern attribute(s) have already been computed. The method is illustrated in FIG. 21. In step 2115, the horizon number is initialized so that the first time step 2120 is executed the first horizon is selected. In step 2125, the data is adjusted up or down so that the horizon becomes flat. If no horizon was supplied this step is skipped. In step 2130, fragment cutting is performed. In step 2135, the attributes including length, maxamp, and shape are computed. In step 2140, the adjustments performed in step 2135 are removed. In step 2145, the procedure proceeds to step 2120 and iterates until all of the horizons have been used at which time the method ends.

Other methods include aligning fragments in directions other than inline and xline by a rotation. They also include aligning fragments along crooked lines which are searched by following the maximum dip of the horizon. Additionally, a horizon, which is already picked, is not used, but the dip direction of the rock layers is determined by tracking from vertical trace to vertical trace by identifying the adjacent fragments which has the most similar hyperdimensional fragment.

Input

A pattern database containing at least band-limited AI and one or more vertical continuous pattern attributes where the PDB was previously flattened. In the case where the PDB contains more than one vertical continuous pattern attribute, the user selects one to be used.

Output

The outputs are inline or xline pattern attributes which are appended to the input pattern pyramid by storing them in the inline and xline sides of the pattern pyramid as inline and xline pattern attributes. The output horizontal pattern attributes include:

Length, which is the horizontal distance between feature cuts in world units

MaxAmp, which is the maximum value of the input data, and

Shape, which is computed as one or more of the statistical moments.

All three are computed in the same manner as they are for trace aligned fragments.

Cutting

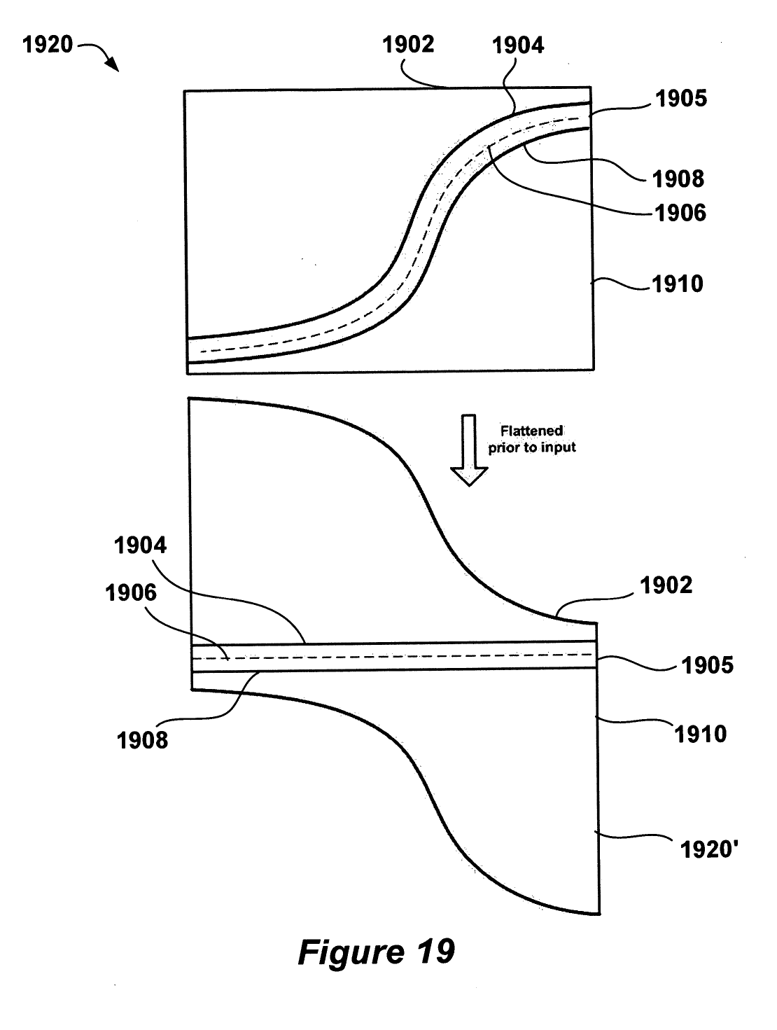

The cutting is performed after the data is flattened, as shown in FIG. 19. Prior to flattening the data is within a cube with a top 1902 and a side 1910. A rock layer 1905 with a top 1904 and a bottom 1908 is represented by a horizon 1906 which might correspond to the top 1904, bottom, 1908, or a line anywhere between depending on how the horizon was created After the horizon is flattened diagram 1920′, the horizon 1906 is flat, the top of the data 1902 is distorted, and the side 1910 remains unchanged.

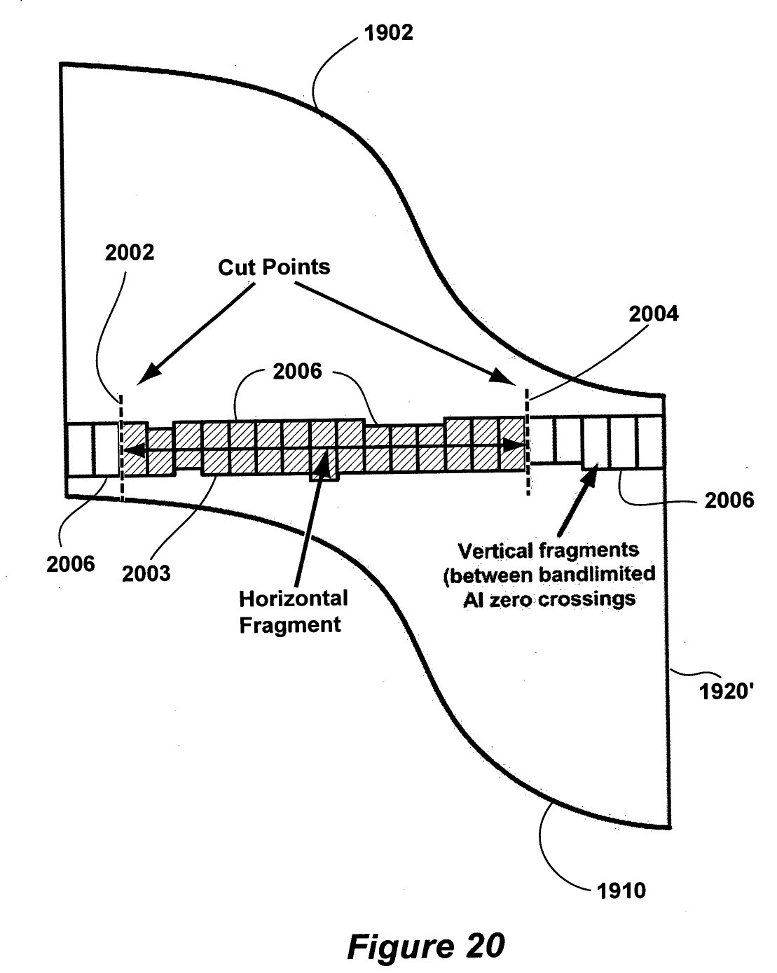

The horizontal cutting identifies cut points selecting an inline or xline range of vertical fragments to be analyzed as shown in FIG. 20. In general, the method of this embodiment entails a search in the inline or xline direction from a given location to find the points at which the derivative of the input data exceeds a user-specified threshold, which defines the cut points 2002, 2004 and thus the horizontal fragment 2003 within which an attribute is determined. The output horizontal attribute is stored within all voxels within all vertical fragments 2006 intersected by the horizontal fragment. As a default, the algorithm should place the horizontal pattern cuts as shown in the above diagram or where the AI in the PDB has a different sign in comparison to the central observation in the horizontal fragment, whichever occurs. The user should be able to optionally disable the AI sign flip check. A cut is also made when the end of the data is reached. This calculation is performed repeatedly until all of the voxels have a horizontal fragment value.

Horizontal Pattern Statistic Method (Feature and Feature Anisotropy)

In another embodiment, it is desirable to obtain horizontal continuous pattern FFA statistic calculations on a PDB which was previously flattened using a horizon and where horizontal continuous pattern attribute(s) have already been computed. The goal is to capture statistics describing the way in which the horizontal continuous pattern attributes vary in the inline and xline directions. While not always necessary, the horizontal calculation method should be as similar, mathematically, as the vertical statistic calculations.

Input

A pattern database containing at least band-limited AI and one or more horizontal continuous pattern attributes where the PDB was previously flattened. In the case where the PDB contains more than one horizontal continuous pattern attribute, the user selects the one to be used from a list of previously computed horizontal continuous pattern attributes.

Output

The outputs are inline and xline continuous pattern statistics which are appended to the input pattern pyramid by storing them in the Inline and Xline sides of the pattern pyramid as inline and xline continuous pattern statistics. When inline continuous pattern attributes are entered, the output is inline continuous pattern statistics. When Xline continuous pattern attributes are input, the output is xline continuous pattern statistics. The output horizontal continuous pattern statistic is FFA as described below.

Feature & Feature Function Anisotropy

Feature and Feature Function Anisotropy is defined in FIGS. 14b and 14c. Feature and Feature Function Anisotropy should be computed using the same algorithm as is currently applied to vertical continuous patterns but with the change that the observations, given below by the Y values, are now horizontal continuous pattern attribute values rather than vertical continuous pattern attribute values. A typical method for that operation is given by the expressions in FIG. 14a. The coordinate system in which the magnitude (M) and angle (φ) results are given is defined in FIG. 14a.

The implementation is the same as the current FFA implementation with the exception that the input is horizontal continuous pattern attribute values. It may be useful for the operator to use a default method that ignores observations where the AI in the PDB has a different sign in comparison to the central observation. The user should be able to optionally disable this feature in order to leave the observations with a sign flip in the calculation.

Horizontal Pattern Statistic Methods

In this embodiment, it is desirable to obtain horizontal continuous pattern statistic calculations on a PDB which was previously flattened using a horizon and where vertical continuous pattern attribute(s) have already been computed. The goal is to capture the way in which the vertical continuous pattern attributes vary in the inline and xline directions.

Input

A pattern database containing at least band-limited AI and one or more horizontal continuous pattern attributes where the PDB was previously flattened. In the case where the PDB contains more than one horizontal pattern attribute, the user selects one to be used.

Output

The outputs are inline and xline pattern statistics that are appended to the input pattern pyramid by storing them in the inline and xline sides of the pattern pyramid as inline and xline pattern statistics. When inline pattern attributes are entered, the output is inline pattern statistics. When xline pattern attributes are input, the output is xline pattern attributes. The output horizontal pattern statistic is standard deviations or horizontal complexity as defined below.

Horizontal Complexity Methods

Horizontal complexity is a normalized measurement of lateral variances. It is currently computed in the vertical direction by the expression illustrated in FIG. 13a. The input data is a user selected previously computed horizontal attribute. The coordinate neighborhood has a user-defined diameter and is defined in FIG. 13b. The implementation is the same as the current HComp implementation with the exception that the input is horizontal attributes.

Horizontal Feature Statistic Methods

In this embodiment, it is desirable to obtain horizontal feature statistic calculations on a PDB that was previously flattened using a horizon and where vertical feature(s) have already been computed. The goal is to capture the way in which the vertical feature attributes vary in the inline and xline directions. While not always necessary, the method used in this embodiment should be as similar as possible, mathematically, to the vertical statistic calculations.

Input

A pattern database containing at least band-limited AI and one or more horizontal feature attributes where the PDB was previously flattened. In the case where the PDB contains more than one horizontal feature attribute, the user selects one to be used.

Output

The outputs are inline and xline feature statistics which are appended to the input pattern pyramid by storing them in the Inline and Xline sides of the pattern pyramid as inline and xline feature statistics. When inline feature attributes are entered the output is inline feature statistics. When Xline feature attributes are input the output is xline feature statistics. The output horizontal feature statistic is standard deviation or HComp as described below.

Horizontal Complexity Methods

Horizontal complexity is a normalized measurement of lateral variances. It can be determined in the vertical direction by the expression in FIG. 13a. The input data is a user selected previously determined horizontal attribute. The coordinate neighborhood has a user-defined diameter and is defined in FIG. 13b. The implementation is the same as the current HComp implementation with the exception that the input is horizontal attributes.

The present invention, therefore, is well adapted to carry out the objects and to attain the ends and advantages mentioned, as well as others inherent therein. While the present invention has been depicted, described, and is defined by reference to particular preferred embodiments of the present invention, such references do not imply a limitation on the present invention, and no such limitation is to be inferred. The present invention is capable of considerable modification, alteration, and equivalents in form and function, as will occur to those of ordinary skill in the art. The depicted and described preferred embodiments of the present invention are exemplary only, and are not exhaustive of the scope of the present invention. Consequently, the present invention is intended to be limited only by the spirit and scope of the appended claims, giving full cognizance to equivalents in all respects.

What is claimed is:

1. A method for generating patterns from raw data, comprising:
generating one or more trace aligned patterns from the raw data;
generating a non-trace aligned analysis of the one or more trace aligned patterns.

2. The method of claim 1, wherein the one or more patterns have been flattened using a horizon.

3. The method of claim 2, wherein the one or more horizontal continuous pattern attributes have been computed.

4. The method of claim 1, wherein the pattern has an inline and an xline.

5. The method of claim 3, wherein the patterns contain band-limited acoustic impedance information.

6. The method of claim 1, further comprising:
computing horizontal attributes in an inline direction and an xline direction.

7. The method of claim 1, further comprising:
computing horizontal attributes within an inline plane and an xline plane where the fragments are rotated relative to the inline direction and the xline direction.

8. The method of claim 1, further comprising:
computing horizontal attributes after the data has been flattened using a horizon.

9. The method of claim 1, further comprising:
computing horizontal attributes along crooked lines which follow maximum dip along a horizon.

10. The method of claim 1, further comprising:
computing horizontal attributes along a line determined by tracking along one or more vertical fragments for which one or more hyperdimensional fragments are most similar.
